(19) United States
(12) Patent Application Publication
(10) Pub. No.: US 2016/0376421 A1
(43) Pub. Date: Dec. 29, 2016

(54) PHENOL-CONTAINING HYDROGENATED NITRILE RUBBER

(71) Applicant: ARLANXEO DEUTSCHLAND GMBH, Dormagen (DE)

(72) Inventor: WERNER OBRECHT, MOERS (DE)

(21) Appl. No.: 15/108,947

(22) PCT Filed: Dec. 29, 2014
(86) PCT No.: PCT/EP2014/079370

§ 371 Date: Jun. 29, 2016

(30) Foreign Application Priority Data
Dec. 30, 2013 (EP) 13199834.6

(51) Int. Cl. C08K 5/13; C08C 19/02; C08K 5/00

(52) U.S. Cl. CPC C08K 5/13; C08K 5/0025; C08C 19/02

(57) ABSTRACT

Novel hydrogenated nitrile rubbers having a specific phenol content are provided, as are a process for production thereof, vulcanizable mixtures based thereon and vulcanizates thus obtained. The vulcanizates feature particularly good moduli and compression set values, and very good storage stabilities.

The invention relates to novel hydrogenated nitrile rubbers having a specific phenol content, to a process for production thereof, to vulcanizable mixtures based on the hydrogenated nitrile rubbers and to vulcanizates obtained therefrom.

Nitrile rubbers are co- and terpolymers of at least one unsaturated nitrile monomer, at least one conjugated diene and optionally one or more further copolymerizable monomers. Processes for producing nitrile rubber (Ullmann's Encyclopedia of Industrial Chemistry, VCH Verlagsgesellachaft, Weinheim, 1993, p. 255-261) and processes for hydrogenating nitrile rubber in suitable organic solvents are known (Ullmann's Encyclopedia of Industrial Chemistry, VCH Verlagsgesellschaft, Weinheim, 1993, p. 320-324).

Hydrogenated nitrile rubber, also abbreviated to “HNBR”, is understood to mean rubbers which are obtained using nitrile rubbers, also abbreviated to “NBR”, by hydrogenation. Correspondingly, in HNBR, the C═C double bonds of the copolymerized diene units are fully or partly hydrogenated. The hydrogenation level of the copolymerized diene units is typically within a range from 50 to 100%. However, those skilled in the art refer to “fully hydrogenated types” even when the residual double bond content is not more than about 0.9%. The HNBR types commercially available on the market typically have a Mooney viscosity (ML 1+4 at 100° C.) in the range from 10 to 120 Mooney units.

HNBR is a specialty rubber having a very good heat resistance, excellent resistance to ozone and chemicals and excellent oil resistance. The aforementioned physical and chemical properties of HNBR are combined with very good mechanical properties, especially a high abrasion resistance.

Because of this profile of properties, HNBR has found wide use in a wide variety of different areas of application. HNBR is used, for example, for seals, hoses, drive belts, cable sheaths, roller coverings and damping elements in the automotive sector, and also for stators, well seals and valve seals in the oil production sector, and also for numerous parts in the aviation industry, the electrical industry, in mechanical engineering and in shipbuilding.

A major role is played by vulcanizates of HNBR having a high modulus level and low compression set, especially after long storage periods at high temperatures. This combination of properties is important for fields of use in which high resilience forces are required to ensure that the rubber articles will function both under static and dynamic stress, especially after long periods and possibly high temperatures. This applies particularly to different seals such as O-rings, flange seals, shaft sealing rings, stators in rotor/stator pumps, valve shaft seals, gasket sleeves such as axle boots, hose seals, engine bearings, bridge bearings and well seals (blowout preventers). In addition, vulcanizates having a high modulus are important for articles under dynamic stress, especially for belts such as drive belts and control belts, especially toothed belts, and for roller coverings.

The level obtained to date in the mechanical properties of HNBR-based vulcanizates, especially in relation to the modulus level and compression set, is still unsatisfactory.

DE-A-3 921 264 describes the production of HNBR which, after peroxidic crosslinking, gives vulcanizates having low compression set. In the hydrogenation, ruthenium catalysts of very different chemical constitution are used, with use of a solvent mixture of a C₃-C₆ ketone and a secondary or tertiary C₃-C₆ alcohol. The proportion of the secondary or tertiary alcohol in the solvent mixture is said to be 2 to 60% by weight. It is stated that, during the hydrogenation or in the course of cooling of the solution after hydrogenation, two phases may be formed. As a consequence, the desired hydrogenation levels are not attained and/or hydrogenated nitrile rubber gelates during the hydrogenation. The process described in DE-A-3 921 264 is not broadly applicable, since the phase separation which takes place in the course of hydrogenation and the gelation depends on a number of parameters in an unpredictable manner. These include the acrylonitrile content and the molar mass of the nitrile rubber feedstock, the composition of the solvent mixture, the solids content of the polymer solution in the hydrogenation, the hydrogenation level and the temperature in the hydrogenation. In the course of cooling of the polymer solution after the hydrogenation or in the course of storage of the polymer solution too, there may be unwanted phase separation and contamination of the corresponding plant components or vessels. DE-A-3 921 264 does not give any teaching relating to improvement of the modulus level and of the compression set via the ageing stabilizer used in the production of the nitrile rubber feedstock and the amount thereof.

According to the teaching of EP-A-0 319 320, vulcanizates obtained on the basis of HNBR, given good processability (low mixture viscosity), have both high modulus values and low compression set values and are suitable for the production of toothed belts. This combination of properties is achieved by adding metal salts of unsaturated methacrylic acids in the course of mixture production. EP-A-319 320 does not give any teaching relating to improvement of the modulus level and of the compression set via the ageing stabilizer used in the production of the nitrile rubber feedstock and the amount thereof.

U.S. Pat. No. 2,281,613 describes the addition, in portions or continuously, of aliphatic mercaptans having a carbon number >6, preferably 6-12, in the copolymerization of butadiene with other monomers such as acrylonitrile in emulsion for the purpose of molecular weight control. The formation of gel in the polymerization can thus be avoided. The use of ageing stabilizers is not mentioned. Measures for improving the modulus level and the compression set of vulcanizates of HNBR are not disclosed.

According to U.S. Pat. No. 2,434,536 too, in the course of the copolymerization of butadiene and acrylonitrile, which is conducted as an emulsion polymerization, mercaptans having 8 to 16 carbon atoms are added in portions or continuously, with metered addition of mercaptans having high molar mass at the start of the polymerization and of mercaptans having lower molar mass with increasing monomer conversion. In this way, “plasticity” and “masticizability”, and hence processability on a roller and a Banbury mixer, of rubbers which are obtained at high polymerization conversions are improved. U.S. Pat. No. 2,434,536 does not mention the use of ageing stabilizers.

GB 888040 discloses a process for coagulating nitrile rubber and polychloroprene latices which are produced with oleate-based emulsifiers. For the purpose of coagulation, an aqueous solution of ammonium salt is added to the alkaline latex and then heated. As a result of the reduction in pH which takes place in the course of this, coagulation of the latex sets in. It is apparent from the examples section that 1.5 parts of 2,2′-dihydroxy-3,3′-dicyclohexyl-5,5′-dimethyldiphenylmethane are added to the nitrile rubber latex before the coagulation. On the basis of GB 888040, no further conclusions can be drawn as to the influence of ageing stabilizers on the properties, especially the modulus level and compression sets, of NBR- or HNBR-based vulcanizates.

DD 154 702 discloses a process for free-radical copolymerization of butadiene and acrylonitrile in emulsions, which is controlled via a specific metering programme for the monomers and the molecular weight regulator, for example tert-dodecyl mercaptan, and in which the latices obtained are worked up by coagulation in an acidic medium to give the solid rubber. A significant advantage of the process is stated to be that the resin soaps and/or fatty acid soaps used as emulsifiers remain within the rubber through the use of acids in the coagulation, and thus are not washed out as in other processes. This is claimed not just to have the advantage of good properties of the NBR but particularly also to improve the economics of the process and to avoid wastewater pollution by washed-out emulsifier. For the butadiene-acrylonitrile copolymers obtained with 10-30% by weight of acrylonitrile, it is stated that they feature good elasticity and low-temperature properties combined with elevated swell resistance and advantageous processability. There are no details as to the use of ageing stabilizers or as to the storage stability of the nitrile rubbers, or as to the influence of these ageing stabilizers on the properties of hydrogenated nitrile rubber produced therefrom and vulcanizates thereof.

DE-A 23 32 096 discloses that rubbers can be precipitated from their aqueous dispersions with the aid of methyl cellulose and a water-soluble alkali metal, alkaline earth metal, aluminium or zinc salt. It is described as an advantage of this process that a coagulate almost completely free of extraneous constituents, such as emulsifiers, catalyst residues and the like, is obtained, since these extraneous substances are removed together with the water on removal of the coagulate and any remaining residues are washed out completely with further water. DE-A 24 25 441 uses, in the electrolyte coagulation of rubber latices, as an assistant instead of methyl cellulose, 0.1-10% by weight (based on the rubber) of water-soluble C₂-C₄ alkyl celluloses or hydroxyalkyl celluloses in combination with 0.02 to 10% by weight (based on the rubber) of a water-soluble alkali metal, alkaline earth metal, aluminium or zinc salt, preferably sodium chloride. The coagulate is removed mechanically and optionally washed with water, and the rest of the water is removed. Here too, it is stated that the extraneous substances are in fact completely removed together with the water in the removal of the coagulate and any residues still remaining are washed out completely by the washing with further water. No information is given as to the residual amounts of the impurities in these nitrile rubbers. Furthermore, neither DE-A 23 32 096 nor DE-A 24 25 441 gives any information as to the type and amount of ageing stabilizers that are added to the nitrile rubber latex before the workup, nor as to the influence thereof on the properties of hydrogenated nitrile rubber produced therefrom and vulcanizates thereof.

DE-A 27 51 786 states that the precipitation and isolation of rubbers from aqueous dispersions thereof can be performed with a smaller amount of (hydroxy)alkyl cellulose when 0.02 to 0.25% by weight of a water-soluble calcium salt is used. It is again described as an advantage that this process affords an extremely pure coagulate which is in fact completely free of extraneous constituents, such as emulsifiers, catalyst residues and the like. These extraneous substances are removed together with the water in the course of removal of the coagulate, and any residues still remaining can be washed out with water. It is further stated that the properties of the isolated rubbers are not adversely affected by coagulation with a calcium salt. It is said that, instead, a rubber in which the vulcanizate properties are not impaired and are entirely satisfactory is obtained. This is described as surprising because impairment of the rubber properties was frequently observed when polymers were precipitated from dispersions with the aid of polyvalent metal ions such as calcium or aluminium ions. The rubbers of DE-A 27 51 786 had no retardation or deterioration whatsoever, for example on scorch and/or full vulcanization. There is no information as to the type and amount of ageing stabilizers that are added to the nitrile rubber latex before the workup, nor as to the influence thereof on the properties of hydrogenated nitrile rubber produced therefrom and vulcanizates thereof.

As in the above-described patents, it is also the aim of DE-A 30 43 688 to reduce the amounts of electrolyte needed for latex coagulation to a minimum level. For this purpose, in the electrolyte coagulation of latices, as well as the inorganic coagulant, either plant-based protein-containing materials or polysaccharides, for example starch and water-soluble or -insoluble polyamine compounds, are used as an assistant. Preferred inorganic coagulants described are alkali metal or alkaline earth metal salts. By means of the specific additives, it is possible to reduce the amounts of salt needed for a quantitative latex coagulation. There is no information as to the type and amount of ageing stabilizers that are added to the nitrile rubber latex before the workup, nor as to the influence of these ageing stabilizers on the properties of hydrogenated nitrile rubber produced therefrom and vulcanizates thereof.

According to U.S. Pat. No. 2,487,263, the latex coagulation of styrene/butadiene rubbers is conducted not with use of metal salts but with the aid of a combination of sulphuric acid with gelatin (“glue”). The amount and concentration of the sulphuric acid should be chosen such that the pH of the aqueous medium is set to a value<6. The latex coagulation forms discrete, non-coherent rubber crumbs having good filterability and washability. The styrene/butadiene rubber thus obtained has a lower water absorption capacity, a lower ash content and a higher electrical resistance than rubbers which are coagulated with the aid of salts without addition of gelatin. There is no disclosure as to what effects, if any, the coagulation with sulphuric acid with addition of gelatin has on storage stability, vulcanization rate and vulcanizate properties, and more particularly on the modulus level of rubbers. Use of ageing stabilizers is likewise not addressed.

U.S. Pat. No. 4,383,108 describes the use of a nitrile rubber by emulsion polymerization using sodium laurylsulphate as emulsifier. The latex obtained here is coagulated by means of an aqueous solution of magnesium sulphate and aluminium sulphate in a molar magnesium/aluminium ratio of 0.3/l to 2/l. In this case, the nitrile rubber is obtained as a powder having particle diameters in the range of 0.3 to 4 mm, which is optionally admixed with zinc soaps as antiagglomerants prior to drying. It can be inferred from the examples of U.S. Pat. No. 4,383,108 that the latex is stabilized prior to the coagulation by addition of 1.5 parts by weight of a “phosphite of polyalkylphenol”. There is no information as to the storage stability of the nitrile rubber or to the amounts of the phosphate-based ageing stabilizer needed for that purpose.

U.S. Pat. No. 5,708,132 describes the production of storage-stable and rapidly vulcanizing nitrile rubbers, wherein the nitrile rubber latex is admixed prior to coagulation with a mixture of a hydrolysis-susceptible and a hydrolysis-resistant ageing stabilizer. The former ageing stabilizers are alkylated aryl phosphites, especially tris(nonylphenyl) phosphite. Hydrolysis-resistant ageing stabilizers mentioned are sterically hindered phenols, especially octadecyl 3-(3,5-di-t-butyl-4-hydroxyphenyl)propionate (Ultranox@ 276), and a chemical compound having an incomprehensible structure “thiodiethylene bis(3,5-di-t-butyl-4-hydroxy)hydrocinnamate”. The combination of two ageing stabilizers reduces the hydrolysis rate of the phosphite-based ageing stabilizer. The sum total of the ageing stabilizers is 0.25 to 3 parts by weight based on 100 parts by weight of rubber. There is no clarity as to the ratio in which the two ageing stabilizers are to be used, or as to whether good storage stability of the NBR can be achieved through the sole use of octadecyl 3-(3,5-di-t-butyl-4-hydroxyphenyl)propionate. Furthermore, there is no disclosure of whether it is possible solely with sterically hindered phenols (without phosphite additions) to produce nitrile rubbers having good storage stability which give an HNBR that gives rise to vulcanizates having high modulus values and a low compression set.

U.S. Pat. No. 4,920,176 discloses that coagulation of a nitrile rubber latex according to the prior art using inorganic salts such as NaCl or CaCl₂ causes very high sodium and calcium contents and also distinct amounts of emulsifier to remain in the nitrile rubber. For the purpose of obtaining a nitrile rubber of maximum purity, according to U.S. Pat. No. 4,920,176, water-soluble cationic polymers are used in place of the inorganic salts in the coagulation of nitrile rubber latices. These are, for example, those based on epichlorohydrin and dimethylamine. The vulcanizates obtained therefrom have lower swelling on contact with water and higher electrical resistance. These improvements in properties are attributed purely qualitatively to the minimal cation contents remaining in the product. U.S. Pat. No. 4,920,176 further describes the addition of ageing stabilizers to the latex before the coagulation. Various ageing stabilizer types, for example phenolic ageing stabilizers, and also explicitly 2,6-di-tert-butyl-p-cresol, are specified explicitly. However, there is a lack of information as to the dependence of the storage stability of the nitrile rubber on the type and amount of ageing stabilizers. Furthermore, U.S. Pat. No. 4,920,176 does not contain any disclosure as to the influence of the ageing stabilizers used for stabilization of nitrile rubbers on the properties of vulcanizates of the hydrogenated nitrile rubbers obtained after the hydrogenation.

The aim of EP-A-1 369 436 was to provide nitrile rubbers having high purity. The emulsion polymerization is conducted in the presence of fatty acid salts and/or resin acid salts as emulsifiers, and then the latex coagulation is undertaken by addition of mineral or organic acids at pH values less than or equal to 6, optionally with addition of precipitants. As additional precipitants, it is possible to use alkali metal salts of inorganic acids. It is also possible to add precipitation aids such as gelatin, polyvinyl alcohol, cellulose, carboxylated cellulose and cationic and anionic polyelectrolytes, or mixtures thereof. Subsequently, the fatty acids and resin acids formed are washed out with aqueous alkali metal hydroxide solutions and the polymer is subjected to shear until a residual moisture content of less than or equal to 20% is established. Nitrile rubbers having low residual emulsifier contents and cation contents are obtained. There is a lack of pointers for controlled production of nitrile rubbers having particular technological properties. There is no study of the influence of ageing stabilizers on the product properties, for example storage stability.

In U.S. Pat. No. 4,965,323, the compression set of HNBR-based vulcanizates which are obtained by peroxidic vulcanization or by sulphur vulcanization is improved by contacting the nitrile rubber after the polymerization or after the hydrogenation with an aqueous alkali solution or the aqueous solution of an amine. In example 1, rubber crumbs that are obtained after removal of the solvent are washed in a separate process step with aqueous sodium carbonate solutions of different concentration. The pH of an aqueous THF solution obtained by dissolving 3 g of the rubber in 100 ml of THF and adding 1 ml of water while stirring is used as a measure of the alkali content. The pH is determined by means of a glass electrode at 20° C. For the production of vulcanizates of the hydrogenated nitrile rubber having low compression set, the pH of aqueous THF solution should be >5, preferably >5.5, more preferably >6. U.S. Pat. No. 4,965,323 does not give any pointers as to whether the modulus level and compression set can be improved by the ageing stabilizers of the NBR feedstock.

EP-A-0 692 496, EP-A-0 779 301 and EP-A-0 779 300 each describe nitrile rubbers based on an unsaturated nitrile and a conjugated diene, having 10-60% by weight of unsaturated nitrile and a Mooney viscosity (ML 1+4 @ 100° C.) in the range of 15-150 or, according to EP-A-0 692 496, of 15-65 Mooney units, and all of them having at least 0.03 mol of a C₁₂-C₁₆-alkylthio group per 100 mol of monomer units, said alkylthio group including at least three tertiary carbon atoms and a sulphur atom bonded directly to at least one of the tertiary carbon atoms. Each of the nitrile rubbers is prepared in the presence of a C₁₂-C₁₆-alkyl thiol of appropriate structure as molecular weight regulator, which functions as a “chain transfer agent” and is thus incorporated into the polymer chains as an end group.

With regard to latex coagulation, it is stated in each case that any desired coagulants can be used. Inorganic coagulants mentioned and used are calcium chloride and aluminium chloride. According to EP-A-0 779 301 and EP-A-0 779 300, a preferred embodiment consists in a nitrile rubber which is essentially halogen-free and is obtained by conducting the latex coagulation in the presence of a nonionic surface-active assistant and using halogen-free metal salts such as aluminium sulphate, magnesium sulphate and sodium sulphate. Coagulation using aluminium sulphate or magnesium sulphate is specified as preferable for obtaining the essentially halogen-free nitrile rubber. The nitrile rubber produced in this way in the examples has a halogen content of not more than 3 ppm. For the production of the nitrile rubbers, it is essential that the molecular weight regulators used are alkyl thiols in the form of the compounds 2,2,4,6,6-pentamethylheptane-4-thiol and 2,2,4,6,6,8,8-heptamethylnonane-4-thiol. It is pointed out that, when conventional tert-dodecyl mercaptan is used as chain transfer agent, nitrite rubbers having poorer properties are obtained.

For the nitrile rubbers produced in EP-A-0 692 496, EP-A-0 779 300 and EP-A-0 779 301, an advantageous profile of properties is asserted, which enables good processability of the rubber mixtures and low mould soiling in the course of processing. The vulcanizates obtained are said to have a good combination of low-temperature stability and oil resistance and possess good mechanical properties. It is additionally asserted that the nitrite rubbers have a short scorch time and, a high crosslinking density and a high vulcanization rate is attainable, especially in the case of NBR types for processing by injection moulding.

Nothing is said with regard to the use of ageing stabilizers in the descriptions of EP-A-0 692 496, EP-A-0 779 301 and EP-A-0 779 300. It is apparent from the examples that an alkylated phenol not defined any further in terms of chemical structure is used as an ageing stabilizer. It can also be inferred from the examples that 2 parts of the alkylated phenol are used. It is suspected that this means parts by weight. The reference parameter remains unclear (based on monomer or polymer). No conclusions can be drawn as to the influence of the alkylated phenol on the properties of nitrile rubber and hydrogenated nitrile rubber from EP-A-0 692 496, EP-A-0 779 301 and EP-A-0 779 300.

DE 102007024011 A describes a rapidly vulcanizing nitrile rubber having good mechanical properties, especially a high modulus 300 level, which possesses an ion index (“II”) of the general formula (I) in the range of 7-26 ppm×mol/g.

$$Ion Index = \frac{3 c ( {Ca}^{2 +} )}{40 g \text{/} mol} - [ \frac{c ( {Na}^{+} )}{23 g \text{/} mol} + \frac{c ( {K}^{+} )}{39 g \text{/} mol} ] \qquad ( I )$$

where c(Ca²⁺), c(Na⁺) and c(K⁺) indicate the concentration of the calcium, sodium and potassium ions in the nitrile rubber in ppm. In order to obtain such a rapidly vulcanizing nitrile rubber, the coagulation is conducted in the presence of a salt of a monovalent metal and optionally of not more than 5% by weight of a salt of a divalent metal, and the temperature in the course of coagulation and subsequent washing is at least 50° C. In the general part of DE 102007024011, some ageing stabilizers that are added to the nitrile rubber latex prior to coagulation are enumerated, although no amounts are stated. It is apparent from the examples section that the studies have been conducted with a constant amount of di-tert-butyl-p-cresol of 1.25% by weight based on rubber solids. No conclusions can be drawn as to the influence of di-tert-butyl-p-cresol on the properties of NBR or HNBR from DE 102007024011.

DE 102007024008 A describes a particularly storage-stable nitrile rubber containing specific isomeric C₁₆ thiol groups and having a calcium ion content of at least 150 ppm and a chlorine content of at least 40 ppm, based in each case on the nitrile rubber. The calcium ion contents of the nitrile rubbers produced in the inventive examples are 171-1930 ppm; the magnesium contents are 2-265 ppm. The calcium ion contents of the noninventive comparative examples are 2-25 ppm; the magnesium ion contents are 225-350 ppm. A storage-stable nitrile rubber of this kind is obtained when the latex coagulation is conducted in the presence of at least one salt based on aluminium, calcium, magnesium, potassium, sodium or lithium, coagulation or washing conducted in the presence of a calcium salt or washing water containing calcium ions and in the presence of a chlorine-containing salt. The chlorine contents of the inventive examples are in the range of 49 to 970 ppm, and those of the noninventive comparative examples in the range of 25 to 39 ppm. However, the relatively low chlorine contents at 25 to 30 ppm are obtained only when coagulation is effected with chloride-free precipitants such as magnesium sulphate, aluminium sulphate or potassium aluminium sulphate and is followed by washing with deionized water. In the general part of DE 102007024008 A, a number of ageing stabilizers that are added to the nitrile rubber latex prior to coagulation are enumerated, although no amounts are stated in the general part. It is apparent from the examples of DE 102007024008 that the NBR latices used in the studies were each stabilized with 1.25% by weight of 2,6-di-tert-butyl-p-cresol based on rubber solids, and this was not varied in the studies. It is therefore not possible to draw any other conclusions from DE 102007024008 A as to the influence of 2,6-di-tert-butyl-p-cresol on the properties of nitrile rubber or of hydrogenated nitrile rubber.

DE 102007024010 A describes a further, rapidly vulcanizing nitrile rubber having an ion index (“II”) of the general formula (I) in the range of 060, preferably 10-25, ppm×mol/g

$$II = 3 [ \frac{c ( {Ca}^{2 +} )}{40 g \text{/} mol} + \frac{c ( {Mg}^{2 +} )}{24 g \text{/} mol} ] - [ \frac{c ( {Na}^{+} )}{23 g \text{/} mol} + \frac{c ( {K}^{+} )}{39 g \text{/} mol} ] \qquad ( I )$$

where c(Ca⁺), c(Mg²⁺), c(Na⁺) and c(K⁺⁾ indicates the concentration of the calcium, magnesium, sodium and potassium ions in the nitrile rubber in ppm, and the magnesium ion content is 50-250 ppm based on the nitrile rubber. In the examples for the nitrile rubbers produced in accordance with the invention, the calcium ion content c(Ca²⁺) is in the range of 163-575 ppm, and the magnesium ion content c(Mg²⁺) in the range of 57-64 ppm. In the examples for noninventive nitrile rubbers, the calcium ion content c(Ca²⁺) is in the range of 345-1290 ppm, and the magnesium ion content c(Mg²⁺) in the range of 2-440 ppm. These nitrile rubbers are obtained when the latex coagulation is conducted while observing particular measures, and the latex is adjusted to a temperature of less than 45° C. with a magnesium salt prior to coagulation. In the general part of DE 102007024010, a number of ageing stabilizers that are added to the nitrile rubber latex prior to coagulation are enumerated, although no amounts are stated. It is apparent from the examples that the studies have been conducted with a constant amount of di-tert-butyl-p-cresol (1.25% by weight based on rubber solids). No further conclusions can be drawn as to the influence of di-tert-butyl-p-cresol on the properties of nitrile rubber and of hydrogenated nitrile rubber from DE 102007024010.

EP 2 238 177 describes the production of nitrile rubber having high storage stability, by conducting the latex coagulation with alkaline earth metal salts in combination with gelatin. The nitrile rubbers have an exceptional ion index with regard to the contents of sodium, potassium, magnesium and calcium ions present in the nitrile rubber. In the general part of EP 2 238 177 A, some ageing stabilizers that are added to the nitrile rubber latex prior to coagulation are enumerated, although no amounts are stated. It is apparent from the examples that 2,2-methylenebis(4-methyl-6-tert-butylphenol) was used, the amount of which varied within a range from 0.1 to 0.8% by weight based on rubber solids. It is shown that the storage stability of the nitrile rubber does not depend on the amount of 2,2-methylenebis(4-methyl-6-tert-butylphenol) and, even when the smallest amount (0.1% by weight) of 2,2-methylenebis(4-methyl-6-tert-butylphenol) is used, adequate storage stabilities are achieved. It can be concluded from this that the amount of 2,2-methylenebis(4-methyl-6-tert-butylphenol) has only a minor influence (if any) on the properties of the nitrile rubber. No further conclusions with regard to the influence of 2,2-methylenebis(4-methyl-6-tert-butylphenol) on the properties of hydrogenated nitrile rubber are possible.

EP 2 238 175 A describes nitrile rubbers having high storage stability, which are obtained by latex coagulation with alkali metal salts in combination with gelatin, and by means of specific conditions in the latex coagulation and the subsequent crumb washing. The nitrile rubbers have exceptional ion indices with regard to the amounts of sodium, potassium, magnesium and calcium ions remaining in the nitrile rubber. In the general part, some ageing stabilizers that are added to the nitrile rubber latex prior to coagulation are enumerated, although no amounts are stated in detail. In the examples, a constant amount of 2,6-di-tert-butyl-p-cresol (1.0% by weight based on rubber solids) is used. No further conclusions can thus be drawn from EP 2 238 175 A as to the influence thereof on the properties of the nitrile rubber and hydrogenated nitrile rubbers produced therefrom and vulcanizates thereof.

EP 2 238 176 A describes further nitrile rubbers having high storage stability, which are obtained by latex coagulation with alkaline earth metal salts in combination with polyvinyl alcohol. The nitrile rubbers likewise have exceptional levels with regard to the sodium, potassium, magnesium and calcium ions remaining in the nitrile rubber. In the general part, some ageing stabilizers that are added to the nitrile rubber latex prior to coagulation are enumerated, although no amounts are stated. It is apparent from the examples section that the studies have been conducted with a constant amount of 2,6-di-tert-butyl-p-cresol (1.0% by weight based on rubber solids). No further conclusions can be drawn from EP 2 238 176 A as to the influence of 2,6-di-tert-butyl-p-cresol on the properties of the nitrile rubber and hydrogenated nitrile rubbers produced therefrom and vulcanizates thereof.

DE 40 32 598 A describes a process for dry isolation of polymers from organic solutions using twin-roll dryers with a vacuum housing, with the aid of which solvents are removed from polymer solutions by evaporation, also with employment of reduced pressure. The polymers or rubbers are not specified in detail even in the examples. The examples mention chlorobenzene and acetone as solvents. It is not possible to infer measures from this to improve the modulus and compression set levels of vulcanizates of hydrogenated nitrile rubbers.

EP 1 331 074 A describes the production of mixtures based on nitrile-containing rubbers having a reduced tendency to mould soiling in an injection moulding process. The problem is solved by nitrile rubber or hydrogenated nitrile rubber having a fatty acid content in the range of 0.1-0.5% by weight. The influence of various mixture constituents on the mould soiling characteristics is studied, including that of di-tert-butyl-p-cresol, which is varied in amounts of 0.1-0.5 parts by weight. There are no details as to the contents of di-ten-butyl-p-cresol present in the nitrile rubber or in the hydrogenated nitrile rubber, or as to the influence thereof on the vulcanizate properties of HNBR. Therefore, it is not possible to infer any further measures to improve the modulus level and compression set for vulcanizates of HNBR.

In summary, it can be stated that, in spite of extensive literature relating to nitrile rubber, there is no hydrogenated nitrile rubber known to date that, on the basis of the ageing stabilizer used in the production of the nitrile rubber feedstock and the amount thereof, after hydrogenation and workup, affords a hydrogenated nitrile rubber which, in the vulcanized state, has an improved modulus and compression set level.

### Problem Addressed by the Present Invention

The problem addressed by the present invention was thus that of providing a hydrogenated nitrile rubber which gives rise to vulcanizates having very good moduli and low compression set values, especially after storage at high temperatures. At the same time, the hydrogenated nitrile rubber is to have an excellent storage stability even after prolonged storage at high temperatures. The problem addressed was accordingly also that of providing a process for producing such hydrogenated nitrile rubbers by suitable hydrogenation of nitrile rubber and subsequent isolation from the solution.

### Solution

It has been found that, surprisingly, hydrogenated nitrile rubber having improved vulcanizate properties, especially having improved modulus and compression set values, is obtained when this hydrogenated nitrile rubber has a content of a defined substituted phenol within a range from 0.01% by weight to less than 0.45% by weight.

This applies in particular to inventive hydrogenated nitrile rubbers which possess a high hydrogenation degree, typically greater than 94.5 to 100%, preferably 95 to 100%, more preferably 96 to 100%, even more preferably 97 to 100% and especially 98 to 100%.

It has also been found that, surprisingly, this inventive hydrogenated nitrile rubber is obtainable by hydrogenation of a nitrile rubber containing the corresponding substituted phenol, preferably in amounts of 0.5 to 1% by weight, in solution, then the solvent is removed and the inventive hydrogenated nitrile rubber is isolated and dewatered by further methods familiar to those skilled in the art and, at the same time, the content of the substituted phenol is adjusted to the amount in the range from 0.01% by weight to less than 0.45% by weight.

The present invention thus provides a hydrogenated nitrile rubber containing at least one substituted phenol of the general formula (I) in an amount in the range from 0.01% by weight to less than 0.45% by weight, preferably in the range from 0.05% by weight to 0.43% by weight, more preferably in the range from 0.1% by weight to 0.41% by weight and especially in the range from 0.15% by weight to 0.4% by weight, based in each case on the hydrogenated nitrile rubber,

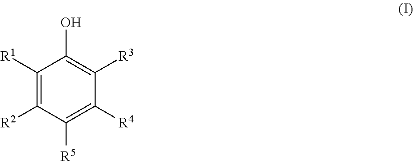

in which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, which are preferably oxygen, where at least one of the R¹, R², R³, R⁴ and R⁵ radicals is not hydrogen.

In an alternative embodiment the content of the at least one substituted phenol of the general formula (I) in the inventive hydrogenated nitrile rubber is in a range from 0.01% by weight to less than 0.3% by weight, preferably from 0.01% by weight to 0.25% by weight and more preferably from 0.1% by weight to 0.25% by weight, based in each case on the hydrogenated nitrile rubber.

The present invention further provides vulcanizable mixtures of these hydrogenated nitrile rubbers and processes for producing vulcanizates based thereon, and also the vulcanizates obtainable therefrom, especially in the form of shaped bodies.

The present invention further provides a process for producing these inventive hydrogenated nitrile rubbers containing at least one substituted phenol of the general formula (I) in an amount in the range from 0.01% by weight to less than 0.45% by weight, preferably from 0.05% by weight to 0.43% by weight, more preferably from 0.1% by weight to 0.41% by weight and especially from 0.15% by weight to 0.4% by weight, characterized in that nitrile rubbers containing at least one substituted phenol of the general formula (I) are subjected to a hydrogenation in solution, then the solvent is removed and the hydrogenated nitrile rubber is isolated and dewatered and, at the same time, the content of substituted phenol of the general formula (I) is adjusted to the amount in the range from 0.01% by weight to less than 0.45% by weight, preferably from 0.05% by weight to 0.43% by weight, more preferably from 0.1% by weight to 0.41% by weight and from 0.15% by weight to 0.4% by weight, based in each case on the hydrogenated nitrile rubber.

In an alternative embodiment the inventive process allows the preparation of hydrogenated nitrile rubbers comprising at least one substituted phenol of the general formula (I) in an amount in the range from 0.01% by weight to less than 0.3% by weight, preferably from 0.01% by weight to 0.25% by weight and more preferably from 0.1% by weight to 0.25% by weight, based in each case on the hydrogenated nitrile rubber.

The term “dewatering” in the context of the present application also covers a thermal drying operation. It is possible to use any processes by which said reduction in the content of the substituted phenol to the abovementioned amount is possible.

### Inventive Hydrogenated Nitrile Rubbers:

The inventive hydrogenated nitrile rubber contains at least one substituted phenol of the general formula (I)

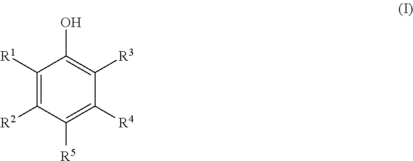

in which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, which are preferably oxygen, where at least one of the R¹, R², R³, R⁴ and R⁵ radicals is not hydrogen,
   in an amount in the range from 0.01% by weight to less than 0.45% by weight, preferably in the range from 0.05% by weight to 0.43% by weight, more preferably in the range from 0.1% by weight to 0.41% by weight and especially in the range from 0.15% by weight to 0.4% by weight, based in each case on the hydrogenated nitrile rubber,

In an alternative embodiment the content of the at least one substituted phenol of the general formula (I) is in an amount in the range from 0.01% by weight to less than 0.3% by weight, preferably from 0.01% by weight to 0.25% by weight and more preferably from 0.1% by weight to 0.25% by weight, based in each case on the hydrogenated nitrile rubber.

The inventive hydrogenated nitrile rubbers, as defined before, possess a hydrogenation degree which is preferably in the range from 94.5 to 100%, more preferably in the range from 95 to 100%, even more preferably in the range from 96 to 100%, especially in the range from 97 to 100% and especially preferred in the range from 98 to 100%.

Preferably, the inventive nitrile rubber is stabilized using substituted phenols of the general formula (I) in which
R¹, R², R³, R⁴ and R⁵ are the same or different and are each hydrogen, hydroxyl, a linear or branched C₁-C₈ alkyl radical, more preferably methyl, ethyl, propyl, n-butyl or t-butyl, a linear or branched C₁-C₈ alkoxy radical, more preferably methoxy, ethoxy or propoxy, a C₁-C₈ cycloalkyl radical, more preferably cyclopentyl or cyclohexyl, or a phenyl radical, where at least one of the R¹, R², R³, R⁴ and R⁵ radicals is not hydrogen.

Especially preferably, the inventive hydrogenated nitrile rubber is stabilized using substituted phenols of the general formula (I), in which two or three of the R¹, R², R³, R⁴ and R⁵ radicals are hydrogen and the other two or three of the R¹, R², R³, R⁴ and R⁵ radicals are the same or different and are each hydroxyl, a linear or branched C₁-C₈ alkyl radical, more preferably methyl, ethyl, propyl, n-butyl or t-butyl, a linear or branched C₁-C₈ alkoxy radical, more preferably methoxy, ethoxy or propoxy, a C₃-C₈ cycloalkyl radical, more preferably cyclopentyl or cyclohexyl, or a phenyl radical.

Most preferably, it is possible to use substituted phenols of the general formula (I) selected from the group consisting of the following compounds:

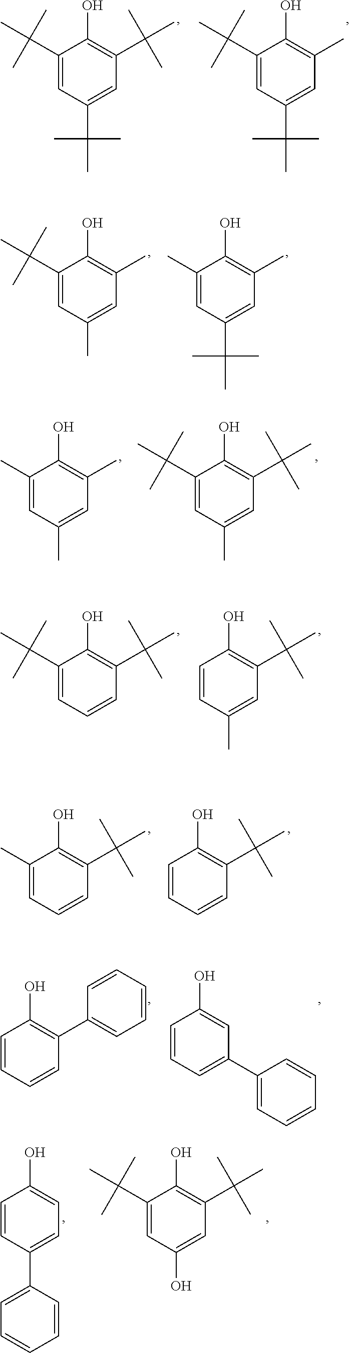

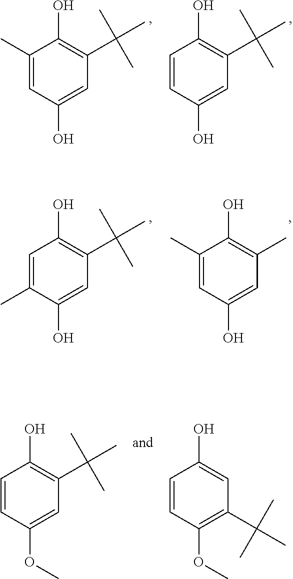

The substituted phenols present in the inventive hydrogenated nitrile rubbers are known, for example, from DE-A 2150639 and DE 3337567 A1 and are either commercially available or are preparable by methods familiar to those skilled in the art.

A feature that the compounds of the general formula (I) have in common is that they are volatile in a suitably conducted drying operation, preferably by means of fluidized bed drying, and their content can therefore be adjusted to the value in the range from 0.01% by weight to less than 0.45% by weight, preferably from 0.05% by weight to 0.43% by weight, more preferably from 0.1% by weight to 0.41% by weight and especially from 0.15% by weight to 0.4% by weight in the hydrogenated nitrile rubber. This adjustment is possible for the person skilled in the art by known methods. The same applies to the alternative embodiment in which the inventive hydrogenated nitrile rubbers comprise the at least one substituted phenol of general formula (I) in an amount in the range from 0.01% by weight to less than 0.3% by weight, preferably from 0.019% by weight to 0.25% by weight and more preferably from 0.1 to 0.25% by weight.

In addition to the phenols of the general formula (I) that are steam-volatile, it is also possible to use one or more further ageing stabilizers, especially including those that are not steam-volatile.

### Repeat Units of the Hydrogenated Nitrile Rubber:

The inventive hydrogenated nitrile rubbers have repeat units of at least one α,β-unsaturated nitrile monomer and at least one conjugated diene monomer. They may additionally have repeat units of one or more further copolymerizable monomers.

The inventive hydrogenated nitrile rubbers comprise fully or partly hydrogenated nitrile rubbers. The hydrogenation level may be within a range from 50 to 100% or from 80 to 100%. Often hydrogenated nitrile rubbers are used having a hydrogenation degree in the range from 90 to 100%. Preferred hydrogenated nitrile rubbers possess a hydrogenation degree in the range from greater than 94.5 to 100%, more preferably in the range from 95 to 100%, even more preferably in the range from 96 to 100%, especially in the range from 97 to 100% and especially preferred in the range from 98 to 100% are used.

Those skilled in the art refer to “fully hydrogenated types” even when the residual double bond content (also abbreviated to “RDB”) is not more than about 0.9%, meaning that the hydrogenation level is greater than or equal to 99.1%. In a preferred embodiment the inventive hydrogenated nitrile rubbers represent fully hydrogenated nitrile rubbers, which have a hydrogenation degree greater than or equal to 99.1%.

The repent units of the at least one conjugated diene are preferably based on (C₄-C₆) conjugated dienes or mixtures thereof. Particular preference is given to 1,2-butadiene, 1,3-butadiene, isoprene, 2,3-dimethylbutadiene, piperylene and mixtures thereof. Especially preferred are 1,3-butadiene, isoprene and mixtures thereof. Even more preferred is 1,3-butadiene.

The α,β-unsaturated nitrile used for production of the inventive nitrite rubbers may be any known α,β-unsaturated nitrile, preference being given to (C₃-C₅)-α,β-unsaturated nitriles such as acrylonitrile, methacrylonitrile, ethacrylonitrile or mixtures thereof. Particular preference is given to acrylonitrile.

If one or more further copolymerizable monomers are used, these may, for example, be aromatic vinyl monomers, preferably styrene, α-methylstyrene and vinylpyridine, fluorinated vinyl monomers, preferably fluoroethyl vinyl ether, fluoropropyl vinyl ether, o-fluoronmethylstyrene, vinyl pentafluorobenzoate, difluoroethylene and tetrafluoroethylene, or else copolymertzable antiageing monomers, preferably N-(4-anilinophenyl)acrylamide, N-(4-anilinophenyl)methacrylamide, N-(4-anilinophenyl)cinnamide, N-(4-anilinophenyl)crotonamide, N-phenyl-4-(3-vinylbenzyloxy)aniline and N-phenyl-4-(4-vinylbenzyloxy)aniline, and also noncoajugated dienes, such as 4-cyanocyclohexene and 4-vinylcyclohexene, or else alkynes such as 1- or 2-butyne.

In addition, the copolymerizable termonomers used may be monomers containing hydroxyl groups, preferably hydroxyalkyl (meth)acrylates. It is also possible to use correspondingly substituted (meth)acrylamides.

Examples of suitable hydroxyalkyl acrylate monomers are 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glyceryl mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl(meth)acrylamide, 2-hydroxypropyl (meth)acrylate, 3-hydroxypropyl(meth)acrylamide, di(ethylene glycol) itaconate, di(propylene glycol) itaconate, bis(2-hydroxypropyl) itaconate, bis(2-hydroxyethyl) itaconate, bis(2-hydroxyethyl) fumarate, bis(2-hydroxyethyl) maleate and hydroxymethyl vinyl ketone.

In addition, the copolymerizable termonomers used may be monomers containing epoxy groups, preferably glycidyl (meth)acrylates.

Preferred examples of monomers containing epoxy groups are diglycidyl itaconate, glycidyl p-styrenecarboxylate, 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidyl methacrylate, glycidylmethyl methacrylate, glycidyl acrylate, (3′,4′-epoxyheptyl)-2-ethyl acrylate, (3,4′-epoxyheptyl)-2-ethyl methacrylate, 6′,7′-epoxyheptyl acrylate, 6′,7-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Alternatively, further copolymerizable monomers used may be copolymerizable termonomers containing carboxyl groups, for example α,β-unsaturated monocarboxylic acids, esters thereof, α,β-unsaturated dicarboxylic acids, mono- or diesters thereof or the corresponding anhydrides or amides thereof.

The α,β-unsaturated monocarboxylic acids used may preferably be acrylic acid and methacrylic acid.

It is also possible to use esters of the α,β-unsaturated monocarboxylic acids, preferably the alkyl esters and alkoxyalkyl esters thereof. Preference is given to the alkyl esters, especially C₁-C₁₈ alkyl esters, of the α,β-unsaturated monocarboxylic acids, particular preference to alkyl esters, especially C₁-C₁₈ alkyl esters of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particular preference to alkoxyalkyl esters of acrylic acid or of methacrylic acid, especially C₂-C₁₂-alkoxyalkyl esters of acrylic acid or of methacrylic acid, even more preferably methoxymethyl acrylate, ethoxyethyl (meth)acrylate and methoxyethyl (meth)acrylate. It is also possible to use mixtures of alkyl esters, for example those mentioned above, with alkoxyalkyl esters, for example in the form of those mentioned above. It is also possible to use cyanoalkyl acrylates and cyanoalkyl methacrylates in which the number of carbon atoms in the cyanoalkyl group is 2-12, preferably α-cyanoethyl acrylate. β-cyanoethyl acrylate and cyanobutyl methacrylate. It is also possible to use hydroxyalkyl acrylates and hydroxyalkyl methacrylates in which the number of carbon atoms of the hydroxyalkyl groups is 1-12, preferably 2-hydroxyethyl acrylate, 2-hydroxyethyl methacrylate and 3-hydroxypropyl acrylate; it is also possible to use acrylates or methacrylates containing fluorine-substituted benzyl groups, preferably fluorobenzyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further monomers used may be α,β-unsaturated dicarboxylic acids, preferably maleic acid, fumaric acid, crotonic acid, itaconic acid, citraconic acid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic adds.

These α,β-unsaturated dicarboxylic mono- or diesters may, for example, be alkyl, preferably C₁-C₁₀-alkyl, especially ethyl, n-propyl, isopropyl, n-butyl, tert-butyl, n-pentyl or n-hexyl, alkoxyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₂-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, aryl, preferably C₆-C₁₄-aryl, mono- or diesters, where any diesters may also be mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxyethyl (meth)acrylate. In particular, methoxyethyl acrylate is used.

Other esters of the α,β-unsaturated monocarboxylic acids used are additionally, for example, polyethylene glycol (meth)acrylate, polypropylene glycol (meth)acrylate, N-(2-hydroxyethyl)acrylamide, N-(2-hydroxymethyl)acrylamide and urethane (meth)acrylate.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monocycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-unsaturated dicarboxylic diesters used may be the analogous diesters based on the aforementioned monoester groups, where the ester groups may also be chemically different groups.

Useful further copolymerizable monomers are additionally free-radically polymerizable compounds containing at least two olefinic double bonds per molecule. Examples of polyunsaturated compounds are acrylates, methacrylates or itaconates of polyols, for example ethylene glycol diacrylate, diethylene glycol dimethacrylate, triethylene glycol diacrylate, butanediol 1,4-diacrylate, propane-1,2-diol diacrylate, butane-1,3-diol dimethacrylate, neopentyl glycol diacrylate, trimethylolpropane di(meth)acrylate, trimethylolethane di(meth)acrylate, glyceryl di- and triacrylate, pentaerythrityl di-, tri- and tetraacrylate or -methacrylate, dipentaerythrityl tetra-, penta- and hexaacrylate or -methacrylate or -itaconate, sorbityl tetraacrylate, sorbityl hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes with terminal hydroxyl groups. The polyunsaturated monomers used may also be acrylamides, for example methylenebisacrylamide, hexamethylene-1,6-bisacrylamide, diethylenetriaminetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate or triallyl phosphate.

The proportions of conjugated diene and α,β-unsaturated nitrile in the nitrile rubbers for use in the process according to the invention or the inventive hydrogenated nitrile rubbers may vary within wide ranges. The proportion of, or the sum total of, the conjugated diene(s) is typically in the range from 20 to 95% by weight, preferably in the range from 45 to 90% by weight, more preferably in the range from 50 to 85% by weight, based on the overall polymer. The proportion of, or the sum total of, the α,β-unsaturated nitrile(s) is typically in the range from 5 to 80% by weight, preferably 10 to 55% by weight, more preferably 15 to 50% by weight, based on the overall polymer. The proportions of the repeat units of conjugated diene and α,β-unsaturated nitrile in the inventive nitrile rubbers or the inventive fully or partly hydrogenated nitrile rubbers add up to 100% by weight in each case.

The additional monomers may be present in amounts of 0 to 40% by weight, preferably 0 to 30% by weight, more preferably 0 to 26% by weight, based on the overall polymer. In this case, corresponding proportions of the repeat units of the conjugated diene(s) and/or of the repeat units of the α,β-unsaturated nitrile(s) are replaced by the proportions of these additional monomers, where the proportions of the repeat units of all the monomers must add up to 100% by weight in each case.

If esters of (meth)acrylic acid are used as additional monomers, this is typically done in amounts of 1 to 25% by weight. If α,β-unsaturated mono- or dicarboxylic acids are used as additional monomers, this is typically done in amounts of less than 10% by weight.

Preference is given to inventive nitrile rubbers having repeat units of acrylonitrile, and 1,3-butadiene. Preference is further given to nitrile rubbers having repeat units of acrylonitrile, 1,3-butadiene and one or more further copolymerizable monomers. Preference is likewise given to nitrile rubbers having repeat units of acrylonitrile, 1,3-butadiene and one or more α,β-unsaturated mono- or dicarboxylic acids or esters or amides thereof, and especially repeat units of an alkyl ester of an α,β-unsaturated carboxylic acid, most preferably of methyl (meth)acrylate, ethyl (meth)acrylate, propyl (meth)acrylate, n-butyl (meth)acrylate, t-butyl (meth)acrylate, hexyl (meth)acrylate, 2-ethythexyl (meth)acrylate, octyl (meth)acrylate or lauryl (meth)acrylate.

The inventive nitrile rubbers or the inventive fully or partly hydrogenated nitrile rubbers have excellent storage stability.

The nitrogen content is determined in the inventive nitrite rubbers or the inventive fully or partly hydrogenated nitrile rubbers to DIN 53 625 according to Kjeldahl. Due to the content of polar comonomers, the nitrile rubbers are typically ≧85% by weight soluble in methyl ethyl ketone at 20° C.

The glass transition temperatures of the inventive hydrogenated nitrile rubbers are within the range of −70° C. to +10° C., preferably within the range of −60° C. to 0° C.

The inventive hydrogenated nitrile rubbers have Mooney viscosities ML 1+4 at 100° C. of 10 to 150 Mooney units (MU), preferably of 20 to 100 MU. The Mooney viscosity of the nitrile rubbers or the hydrogenated nitrile rubbers is determined in a shearing disk viscometer to DIN 53523/3 or ASTM D 1646 at 100° C. This involves analysing each of the unvulcanized rubbers after drying and before ageing. The Mooney viscosities of the nitrile rubbers or of the hydrogenated nitrile rubbers after drying and before ageing are referred to as MV 0.

To determine the storage stability of the unvulcanized nitrite rubbers or of the unvulcanized hydrogenated nitrile rubbers, the Mooney viscosities are determined. The Mooney viscosity values determined after the storage of the nitrile rubber or hydrogenated nitrile rubber at 100° C. for 48 hours are referred to as MV 1. The Mooney viscosity values determined after storage at 100° C. for 72 hours are referred to as MV 2. The storage stabilities (SS) were determined as the difference between the Mooney values after and before storage at 100° C.:

SS 1(48 h/100° C.)=MV 1−MV 0

SS 2(72 h/100° C.)=MV 2−MV 0

The storage stability of hydrogenated nitrile rubber (SS 2) is good when the Mooney viscosity changes by not more than 5 Mooney units in the course of storage at 100° C. for 72 hours (SS 2=MV 2−MV 0). This is the case for the inventive hydrogenated nitrile rubbers.

The storage stability of nitrile rubber (SS 1) is good when the Mooney viscosity changes by not more than 5 Mooney units in the course of storage at 100° C. for 48 hours (SS 1=MV 1−MV 0).

For the production of the inventive hydrogenated nitrile rubbers, it has been found to be useful to use nitrile rubbers having a storage stability SS 1 of not more than 5 Mooney units; this is not obligatory, but contributes to broad applicability of the process.

To determine the Mooney viscosities, for the purpose of calculating the storage stability according to the above formulae, it has been found to be useful to produce milled sheets of the hydrogenated nitrile rubbers. Typically, these milled sheets are obtained by rolling out 100 g of the particular rubber at room temperature in a conventional roll mill (e.g. Schwabenthan Polymix 110) at a gap width of 0.8-1.0 mm. The rotation speeds are 25 min⁻¹/30 min⁻¹. Rectangular sections (40-50 g) are produced from the sheets and stored in an air circulation drying cabinet on aluminium dishes (10 cm/15 cm) with the base covered with Teflon film. The oxygen content in this air circulation drying cabinet is unchanged from normal air.

Process for Producing the Nitrile Rubbers which can be Used for Production of the Inventive Hydrogenated Nitrile Rubbers:

Nitrile rubbers containing at least one substituted phenol of the general formula (I) can be prepared by mixing a nitrile rubber with a substituted phenol of the general formula (I).

The amount of the substituted phenol of the general formula (I) which is added to the nitrile rubber can be varied within a wide range by the person skilled in the art. It should be taken into account here merely that the amount is selected such that the amount of the substituted phenol in the hydrogenated nitrile rubber which is obtained from the nitrile rubber by hydrogenation and subsequent workup is within the range of 0.01% by weight to less than 0.45% by weight, preferably from 0.05% by weight to 0.43% by weight, more preferably from 0.1% by weight to 0.41% by weight and especially from 0.15% by weight to 0.4% by weight, based in each case on the hydrogenated nitrile rubber. Since the degree of removal of the phenol from the hydrogenated nitrile rubber can differ according to the dewatering method, i.e. drying method, no fixed specifications are necessary here. The person skilled in the art knows how to adjust the conditions correspondingly. Useful nitrile rubbers have been found to be those which contain a substituted phenol of the general formula (I) within the range from 0.5 to 1% by weight based on the nitrile rubber.

The nitrile rubber is typically produced via an emulsion polymerization with formation of a nitrile rubber latex and a subsequent coagulation of the nitrile rubber. This is sufficiently well known to the person skilled in the art. Preferably, the latex coagulation of the nitrile rubber is effected by the process described in general terms in EP-A-1 369 436. The phenol of the general formula (I) is typically added to the nitrile rubber latex formed after the emulsion polymerization, prior to coagulation. It has been found to be useful to add the substituted phenol of the general formula (I) as an aqueous dispersion. The concentration of this aqueous dispersion is typically within a range from 2.50-70% by weight, preferably 5-60% by weight. It is also possible to add the substituted phenol to the monomer-containing latex at the end of the polymerization, either in a solvent or dissolved in monomer (butadiene, acrylonitrile or in a butadiene/acrylonitrile mixture) before the removal of monomers (monomer degassing). Preference is given to an addition in butadiene, acrylonitrile or a butadiene/acrylonitrile mixture, where the concentration of the substituted phenol in the monomer is 0.5-30% by weight, preferably 1-20% by weight. The addition of the substituted phenol is also possible in combination with a stopper and/or in combination with a further, non-steam-volatile ageing stabilizer.

Optionally, the nitrile rubber is degraded by means of metathesis prior to the hydrogenation. Should a readjustment of the amount of substituted phenol of the general formula (I) be desirable after the metathesis, further substituted phenol of the general formula (I) can be added to the nitrile rubber after the metathesis and before the hydrogenation.

### Process for Producing the Inventive Hydrogenated Nitrile Rubbers:

Hydrogenated nitrile rubbers containing at least one substituted phenol of the general formula (I) in an amount in the range from 0.01% by weight to less than 0.45% by weight, preferably from 0.05% by weight to 0.43% by weight, more preferably from 0.1% by weight to 0.41% by weight and especially from 0.15% by weight to 0.4% by weight, can be prepared by subjecting nitrile rubbers containing at least one phenol of the general formula (I), preferably in an amount in the range from 0.5 to 1% by weight, based on the nitrile rubber, to a hydrogenation in solution, then removing the solvent, preferably by a steam distillation, and isolating the hydrogenated nitrile rubber, preferably in the form of crumbs by sieving, and dewatering, which adjusts the content of substituted phenol of the general formula (I) to the amount in the range from 0.01% by weight to less than 0.45% by weight, preferably from 0.05% by weight to 0.43% by weight, more preferably from 0.1% by weight to 0.41% by weight and especially from 0.15% by weight to 0.4% by weight.

In a proven embodiment, the final dewatering of the hydrogenated nitrile rubber is undertaken by a fluidized bed drying operation at temperatures of 100° C. to 180° C., preferably at 110° C. to 150° C., wherein it is possible to remove 20-98% by weight of the substituted phenol of the general formula (I), based on the amount of the substituted phenol in the nitrile rubber used for hydrogenation.

In a particular embodiment, the inventive fully or partly hydrogenated nitrile rubber in the dried state contains volatile fractions <1.0% by weight, in which case the at least one substituted phenol of the general formula (I) is present in an amount within the range from 0.01% by weight to less than 0.45% by weight.

All the analytical methods for determining the corresponding contents of phenols of the general formula (I), the volatile fractions inter alia are disclosed in the general part of the examples.

### Hydrogenation:

The hydrogenation is typically conducted in the presence of at least one hydrogenation catalyst typically based on the noble metals rhodium, ruthenium, osmium, palladium, platinum or iridium, preference being given to rhodium, ruthenium and osmium.

It is possible to use rhodium complex catalysts of the general formula (A)

Rh(X)ₙ(L)ₘ (A)
where
X is the same or different and is hydrogen, halogen, pseudohalogen, SnCl₃ or carboxylate,
n is 1, 2 or 3, preferably 1 or 3,
L is the same or different and represents mono- or bidentate ligands based on phosphorus, arsenic or antimony,
m is 2, 3 or 4 if L represents monodentate ligands, or is 1 or 1.5 or 2 or 3 or 4 if L represents bidentate ligands.

In the general formula (A), X is the same or different and is preferably hydrogen or chlorine.

L in the general formula (A) is preferably a phosphine or diphosphine corresponding to the general formulae (I-a) and (I-b) shown above, including the general, preferred and particularly preferred definitions given there.

Particularly preferred catalysts of the general formula (A) are tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylphosphine) and the corresponding compounds in which triphenylphosphine has been replaced wholly or partly by tricyclohexylphosphine.

It is also possible to use ruthenium complex catalysts. These are described, for example, in DE-A 39 21 264 and EP-A-0 298 386. They typically have the general formula (B)

RuXₙ[(L¹)ₘ(L²)_{5-z}] (B)
in which
X is the same or different and is hydrogen, halogen, SnCl₃, CO, NO or R⁶—COO,
L¹ is the same or different and is hydrogen, halogen, R⁶—COO, NO, CO or a cyclopentadienyl ligand of the following general formula (2):

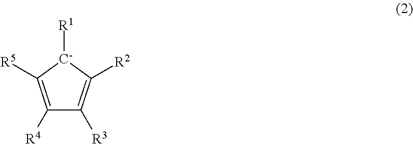

in which
R¹ to R⁵ are the same or different and are each hydrogen, methyl, ethyl, propyl, butyl, hexyl or phenyl or, alternatively, two adjacent radicals from R¹ to R⁵ are bridged, so as to result in an indenyl or fluorenyl system,
L² is a phosphine, diphosphine or arsine and
n is 0, 1 or 2,
m is 0, 1, 2 or 3,
z is 1, 2, 3 or 4, and
R⁶ is a radical which has 1 to 20 carbon atoms and may be branched or unbranched, bridged or unbridged and/for partly aromatic, and is preferably C₁-C₄ alkyl.

Examples of L¹ ligands in the general formula (B) of the cyclopentadienyl ligand type of the general formula (2) include cyclopentadienyl, pentamethylcyclopentadienyl, ethyletramethylcyclopentadienyl, pentaphenylcyclopentadienyl, dimethyltriphenylcyclopentadienyl, indenyl and fluorenyl. The benzene rings in the L¹ ligands of the indenyl and fluorenyl type may be substituted by C₁-C₆-alkyl radicals, especially methyl, ethyl and isopropyl, C₁-C₄-alkoxy radicals, especially methoxy and ethoxy, aryl radicals, especially phenyl, and halogens, especially fluorine and chlorine. Preferred L¹ ligands of the cyclopentadienyl type are the respectively unsubstituted cyclopentadienyl, indenyl and fluorenyl radicals.

In the L¹ ligand in the general formula (B) of the (R⁶—COO) type, R⁶ includes, for example, straight-chain or branched, saturated hydrocarbyl radicals having 1 to 20, preferably 1 to 12 and especially 1 to 6 carbon atoms, cyclic saturated hydrocarbyl radicals having 5 to 12 and preferably 5 to 7 carbon atoms, and also aromatic hydrocarbyl radicals having 6 to 18 and preferably 6 to 10 carbon atoms, or aryl-substituted alkyl radicals having preferably a straight-chain or branched C₁-C₆ alkyl radical and a C₆-C₁₈ aryl radical, preferably phenyl.

The above-elucidated R⁶ radicals in (R⁶—COO) in the ligand L¹ of the general formula (B) may optionally be substituted by hydroxyl, C₁-C₆-alkoxy, C₁-C₆-carbalkoxy, fluorine, chlorine or di-C₁-C₄-alkylamino, the cycloalkyl, aryl and aralkyl radicals additionally by C₁-C₆-alkyl; alkyl, cycloalkyl and aralkyl groups may contain keto groups. Examples of the R⁶ radical are methyl, ethyl, propyl, isopropyl, tert-butyl, cyclohexyl, phenyl, benzyl and trifluoromethyl. Preferred R⁶ radicals are methyl, ethyl and tert-butyl.

The L² ligand in the general formula (B) is preferably a phosphine or diphosphine according to the general formulae (1-a) and (1-b) shown above, including the general, preferred and particularly preferred definitions given there, or is an arsine of the general formula (3)

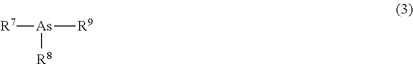

Preferred ligands L² of the general formula (3) are triphenylarsine, ditolylphenylarsine, tris(4-ethoxyphenyl)arsine, diphenylcyclohexylarsine, dibutylphenylarsine and diethylphenylarsine.

Preferred ruthenium catalysts of the general formula (B) are selected from the group which follows, where “Cp” represents cyclopentadienyl, i.e. C₅H₅⁻, “Ph” represents phenyl, “Cy” represents cyclohexyl and “dppe” represents 1,2-bis(diphenylphosphino)ethane: RuCl₂(PPh₃)₃; RuHCl(PPh₃)₃; RuH₂(PPh₃)₃; RuH₂(PPh₃)₄; RuH₄(PPh₃)₃; RuH(CH₃COO)(PPh₃)₃; RuH(C₂H₅COO)(PPh₃)₃; RuH(CH₃COO)₂(PPh₃)₂; RuH(NO)₂(PPh₃)₃; Ru(NO)₂(PPh₃)₂; RuCl(Cp)(PPh₃)₂; RuH(Cp)(PPh₃)₂; Ru(SnCl₃)(Cp)(PPh₃)₂; RuCl(μ⁵-C₉H₇)(PPh₃)₂; RuH(μ⁵-C₉H₇)(PPh)₂; Ru(SnCl₃)(μ⁵-C₉H₇)(PPh₃)₂; RuCl(μ⁵-C₁₃H₉)(PPh₃)₂; RuH(μ⁵-C₁₃H₉)(PPh₃)₂; Ru(SnCl₃)(μ⁵-C₁₃H₉)(PPh₃)₂; RuCl(μ⁵-C₉H₇)(dppe); RuHCl(CO)PCy₃); RuH(NO)(CO)(PCy₃)₃; RuHCl(CO)₂(PPh₃)₂; RuCl₂(CO)(dppe) RuHCl(CO)(PCy₃), RuHCl(CO)(dppe)₂, RuH(CH₃COO)(PPh₃)₃; RuH(CH₃COO)₂(PPh₃)₂; and RuH(CH₃COO)(PPh₃)₃.

Suitable catalysts are also those of the general formula (C)

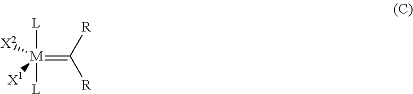

in which
M is osmium or ruthenium,
X¹ and X² are the same or different and are two ligands, preferably anionic ligands,
L are identical or different ligands, preferably uncharged electron donors,
R is the same or different and is hydrogen, alkyl, preferably C₁-C₃₀-alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₃₀-alkylsulphonyl, or alkylsulphinyl, preferably C₁-C₂₀-alkylsulphinyl, where all these radicals may each be substituted by one or more alkyl, halogen, alkoxy, aryl or heteroaryl radicals, or alternatively both R radicals, with incorporation of the common carbon atom to which they are bonded, are bridged to form a cyclic group which may be aliphatic or aromatic in nature, is optionally substituted and may contain one or more heteroatoms.

In one embodiment of the catalysts of the general formula (C), one R radical is hydrogen and the other R radical is C₁-C₂₀-alkyl, C₃-C₁₀-cycloalkyl, C₂-C₂₀-alkenyl, C₂-C₂₀-alkynyl, C₆-C₂₄-aryl, C₁-C₂₀-carboxylate. C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl or C₁-C₂₀-alkylsulphinyl, where all these radicals may each be substituted by one or more alkyl, halogen, alkoxy, aryl or heteroaryl radicals.

In the catalysts of the general formula (C), X¹ and X² are the same or different and are two ligands, preferably anionic ligands.

X¹ and X² may, for example, be hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl, C₁-C₂₀-alkylsulphinyl, mono- or dialkylamide, mono- or dialkylcarbamate, mono- or dialkylthiocarbamate, mono- or dialkyldithiocarbamate or mono- or dialkylsulphonamide radicals.

The aforementioned X¹ and X² radicals may also be substituted by one or more further radicals, for example by halogen, preferably fluorine, C₁-C₁₀-alkyl, C₁-C₁₀-alkoxy or C₆-C₂₄-aryl, where these radicals too may optionally in turn be substituted by one or more substituents selected from the group comprising halogen, preferably fluorine, C₁-C₅-alkyl, C₁-C₅-alkoxy and phenyl.

In a further embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a further embodiment, X¹ and X² are identical and are each halogen, especially chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃-C₆H₄—SO₃), mesylate (CH₃SO₃) or CFSO₃ (trifluoromethanesulphonate).

In the general formula (C), L are identical or different ligands and are preferably uncharged electron donors.

The two L ligands may, for example, each independently be a phosphine, sulphonated phosphine, phosphate, phosphinite, phosphonite, arsine, stibine, ether, amine, amide, sulphoxide, carboxyl, nitrosyl, pyridine, thioether, an imidazoline or an imidazolidine ligand.

Preferably, the two L ligands are each independently a C₆-C₂₄-aryl-, C₁-C₁₀-alkyl- or C₃-C₂₀-cycloalkylphosphine ligand, a sulphonated C₆-C₂₄-aryl- or sulphonated C₁-C₁₀-alkylphosphine ligand, a C₆-C₂₄-aryl- or C₁-C₁₀-alkylphosphinite ligand, a C₆-C₂₄-aryl- or C₁-C₁₀-alkylphosphonite ligand, a C₆-C₂₄-aryl- or C₁-C₁₀-alkylphosphite ligand, a C₆-C₂₄-aryl- or C₁-C₁₀-alkylarsine ligand, a C₆-C₂₄-aryl- or C₁-C₁₀-alkylamine ligand, a pyridine ligand, a C₆-C₂₄-aryl or C₁-C₁₀-alkyl sulphoxide ligand, a C₆-C₂₄-aryl or C₁-C₁₀-alkyl ether ligand or a C₆-C₂₄-aryl- or C₁-C₁₀-alkylamide ligand, all of which may each be substituted by a phenyl group which is in turn either unsubstituted or substituted by one or more halogen, C₁-C₅-alkyl or C₁-C₅-alkoxy radical(s).

The term “phosphine” includes, for example, PPh₃, P(p-Tol)₃, P(o-Tol)₃, PPh(CH₃)₂, P(CF₃)₃, P(p-FC₆H₄)₃, P(p-CFC₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃, where “Ph” represents phenyl and “Tol” represents tolyl.

The term “phosphinite” includes, for example, triphenylphosphinite, tricyclohexylphosphinite, triisopropylphosphinite and methyldiphenylphosphinite.

The term “phosphite” includes, for example, triphenylphosphite, tricyclohexylphosphite, tri-tert-butylphosphite, triisopropylphosphite and methyldiphenylphosphite.

The term “stibine” includes, for example, triphenylstibine, tricyclohexylstibine and trimethylstibine.

The term “sulphonate” includes, for example, trifluoromethanesulphonate, tosylate and mesylate.

The term “sulphoxide” includes, for example, (CH₃)₂S(═O) and (C₆H₅)₂S═O.

The term “thioether” includes, for example, CH₃SCH₃, C₆H₅SCH₃, CH₃OCH₂CH₂SCH₃ and tetrahydrothiophene.

The term “pyridine” shall be understood in the context of this application as an umbrella term for all pyridine-based ligands, as specified, for example, by Grubbs in WO-A-03/011455. These include pyridine, and pyridine having mono- or polysubstitution in the form of the picolines (α-, β-, and γ-picoline), lutidines (2,3-, 2,4-, 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidazole.

If one or both of the L ligands in formula (C) is an imidazoline and/or imidazolidine radical (also referred to collectively hereinafter as “Im” ligand(s)), the latter typically has a structure of the general formula (4a) or (4b)

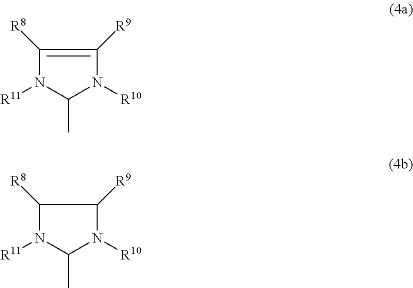

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulphonyl, C₁-C₂₀-alkylsulphonate, C₆-C_{2D}-arylsulphonate or C₁-C₂₀-alkylsulphinyl.

Optionally, one or more of the R⁸, R⁹. R¹⁰, R¹¹ radicals may each independently be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may in turn be substituted by one or more radicals, preferably selected from the group of halogen, especially fluorine, chlorine or bromine, C₁-C₅-alkyl, C₁-C₅-alkoxy and phenyl.

Merely for clarification, it should be added that the structures shown in the general formulae (4a) and (4b) in the context of this application are equivalent to the structures (4a′) and (4b′) frequently also encountered in the literature for this radical, which emphasize the carbene character of the radical. This also applies analogously to the corresponding preferred structures (5a)-(5f) shown below. These radicals are all referred to collectively hereinafter as “Im” radical.

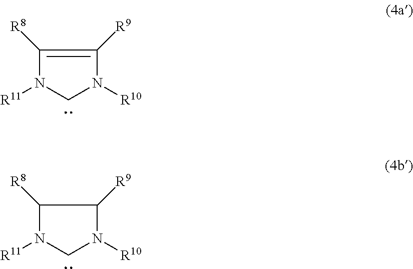

In a preferred embodiment of the catalysts of the general formula (C), R⁸ and R⁹ are each independently hydrogen, C₆-C₂₄-aryl, more preferably phenyl, straight-chain or branched C₁-C₁₀-alkyl, more preferably propyl or butyl, or form, with inclusion of the carbon atoms to which they are bonded, a cycloalkyl or aryl radical, where all the aforementioned radicals may optionally be substituted in turn by one or more further radicals selected from the group comprising straight-chain or branched C₁-C₁₀-alkyl, C₁-C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (C), the R¹⁰ and R¹¹ radicals are additionally the same or different and are each straight-chain or branched C₁-C₁₀-alkyl, more preferably methyl, isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen, especially fluorine, chlorine and bromine.

More particularly, the R¹⁰ and R¹¹ radicals may be the same or different and are each isopropyl, neopentyl, adamantyl, mesityl (2,4,6-trimethylphenyl), 2,6-difluorophenyl, 2,4,6-trifluorophenyl or 2,6-diisopropylphenyl.

Particularly preferred Im radicals have the structures (5a) to (5f) below, where each Ph is a phenyl radical, Bu is a butyl radical and each Mes is a 2,4,6-trimethylphenyl radical, or Mes alternatively in all cases is 2,6-diisopropylphenyl.

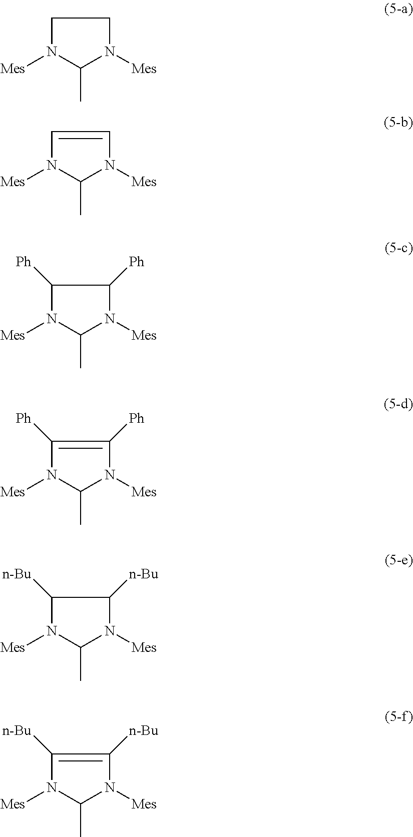

A wide variety of different representatives of the catalysts of the formula (C) is known in principle, for example from WO-A-96/04289 and WO-A-9706185.

As an alternative to the preferred Im radicals, one or both L ligands in the general formula (C) are preferably also identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

More preferably, in the general formula (C), one or both L ligands are a trialkylphosphine ligand in which at least one of the alkyl groups is a secondary alkyl group or a cycloalkyl group, preferably isopropyl, isobutyl, sec-butyl, neopentyl, cyclopentyl or cyclohexyl.

Particular preference is given to catalysts which are covered by the general formula (C) and have the structures (6) (Grubbs (I) catalyst) and (7) (Grubbs (II) catalyst), where Cy is cyclohexyl.

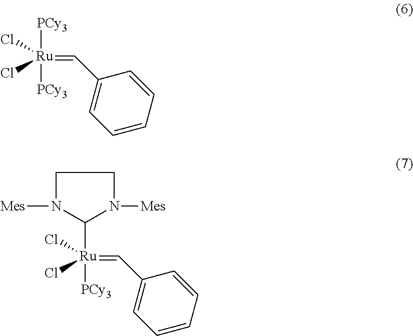

Suitable catalysts are also preferably those of the general formula (C1)

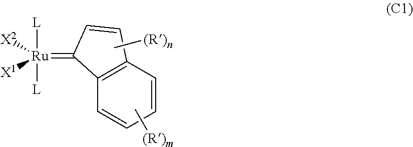

in which
X¹, X² and L may have the same general, preferred and particularly preferred definitions as in the general formula (C).
n is 0, 1 or 2.
m is 0, 1, 2, 3 or 4 and
R′ are the same or different and are each alkyl, cycloalkyl, alkenyl, alkynyl, aryl, alkoxy, alkenyloxy, alkynyloxy, aryloxy, alkoxycarbonyl, alkylamino, alkyithio, arylthio, alkylsulphonyl or alkylsulphinyl radicals, all of which may each be substituted by one or more alkyl, halogen, alkoxy, aryl or heteroaryl radicals.

An example of a preferred catalyst covered by the general formula (C1) which can be used is that of the formulae (8a) and (8b) below, where each Mes is 2,4,6-trimethylphenyl and Ph is phenyl.

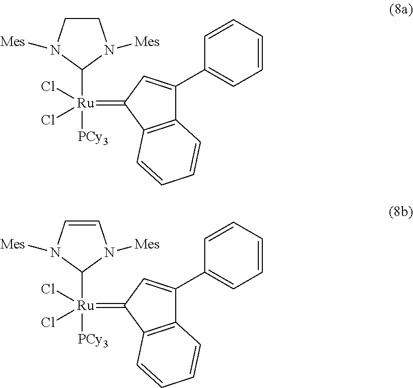

These catalysts are known, for example, from WO-A-2004/112951. Catalyst (8a) is also referred to as the Nolan catalyst.

Suitable catalysts are also preferably those of the general formula (D)

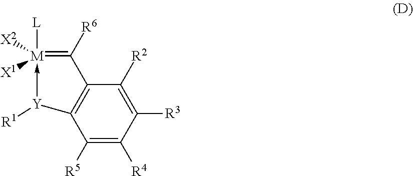

in which
M is ruthenium or osmium,
X¹ and X² are identical or different ligands, preferably anionic ligands,
Y is oxygen (O), sulphur (S), an N—R¹ radical or a P—R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴ and R⁵ are the same or different and are each hydrogen or organic or inorganic radicals,
R⁶ is hydrogen or an alkyl, alkenyl, alkynyl or aryl radical and
L is a ligand as defined for the formula (C).

The catalysts of the general formula (D) are known in principle and are described, for example, by Hoveyda et al. in US 2002/0107138 A1 and Angew. Chem. Int. Ed. 2003, 42, 4592, and by Grela in WO-A-2004035596, Eur. J. Org. Chem 2003, 963-966 and Angew. Chem. Int. Ed. 2002, 41, 4038, and also in J. Org. Chem. 2004, 69, 6894-96 and Chem. Eur. J 2004, 10, 777-784, and also in US 20071043180. The catalysts are commercially available or can be prepared according to the references cited.

In the catalysts of the general formula (D), L is a ligand which typically has an electron donor function and may assume the same general, preferred and particularly preferred definitions as L in the general formula (C). In addition, L in the general formula (D) is preferably a P(R⁷)₃, radical where R⁷ is independently C₁-C₆ alkyl, C₃-C₈-cycloalkyl or aryl, or else an optionally substituted imidazoline or imidazolidine radical (“Im”).

C₁-C₆-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl comprises cyclopropyl, cyclobutyl, cyclopentyl, cyclohexyl, cycloheptyl and cyclooctyl.

Aryl comprises an aromatic radical having 6 to 24 skeleton carbon atoms, preferably mono-, bi- or tricyclic carbocyclic aromatic radicals having 6 to 10 skeleton carbon atoms, especially phenyl, biphenyl, naphthyl, phenanthrenyl or anthracenyl.

The imidazoline or imidazolidine radical (Im) has the same general, preferred and particularly preferred structures as the catalysts of the general formula (C).

Particularly suitable catalysts for the general formula (D) are those in which the R¹⁰ and R¹¹ radicals are the same or different and are each straight-chain or branched C₁-C₁₀-alkyl, more preferably isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl or mesityl.

Particularly preferred imidazoline or imidazolidine radicals (Im) have the structures (5a-5f) already specified above, where each Mes is 2,4,6-trimethylphenyl.

In the catalysts of the general formula (D), X¹ and X² have the same general, preferred and particularly preferred definitions as in the catalysts of the general formula (C).

In the general formula (D), the R¹ radical is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals.

Typically, the R¹ radical is a C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radical, all of which may each be substituted by one or more alkyl, halogen, alkoxy, aryl or heteroaryl radicals.

Preferably, R¹ is a C₃-C₂₄-cycloalkyl radical, a C₆-C₂₄-aryl radical or a straight-chain or branched C₁-C₃₀-alkyl radical, where the latter may optionally be interrupted by one or more double or triple bonds or else one or more heteroatoms, preferably oxygen or nitrogen. More preferably, R¹ is a straight-chain or branched C₁-C₁₂-alkyl radical.

The C₃-C₂₀-cycloalkyl radical comprises, for example, cyclopropyl, cyclobutyl, cyclopentyl, cyclohexyl, cycloheptyl and cyclooctyl.

The C₁-C₁₂-alkyl radical may, for example, be methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, n-heptyl, n-octyl, n-decyl or n-dodecyl. More particularly, R¹ is methyl or isopropyl.

The C₆-C₂₄-aryl radical is an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

In the general formula (D), the R², R³, R⁴ and R⁵ radicals are the same or different and may each be hydrogen or organic or inorganic radicals.

In a suitable embodiment, R², R³, R⁴, R⁵ are the same or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each optionally be substituted by one or more alkyl, alkoxy, halogen, aryl or heteroaryl radicals.

Typically, R², R³, R⁴, R⁵ are the same or different and are each hydrogen, halogen, preferably chlorine or bromine, nitro, CF₃, C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radicals, all of which may each optionally be substituted by one or more C₁-C₃₀-alkyl, C₁-C₂₀-alkoxy, halogen, C₆-C₂₄-aryl or heteroaryl radicals.

In a particularly proven embodiment, R², R³, R⁴, R⁵ are the same or different and are each nitro, straight-chain or branched C₁-C₃₀-alkyl, C₅-C₂₀-cycloalkyl, straight-chain or branched C₁-C₂₀-alkoxy radicals or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or else one or more heteroatoms, preferably oxygen or nitrogen.

In addition, two or more of the R², R³, R⁴ or R⁵ radicals may also be bridged via aliphatic or aromatic structures. R³ and R⁴ may, for example, including the carbon atoms to which they are bonded in the phenyl ring of the formula (D), form a fused-on phenyl ring so as to result overall in a naphthyl structure.

In the general formula (D), the R⁶ radical is hydrogen, an alkyl, alkenyl, alkynyl or aryl radical, preferably hydrogen, a C₁-C₃₀-alkyl, a C₂-C₂₀-alkenyl, a C₂-C₂₀-alkynyl or a C₆-C₂₄-aryl radical. More preferably, R⁶ is hydrogen.

Other suitable catalysts are catalysts of the general formula (D1)

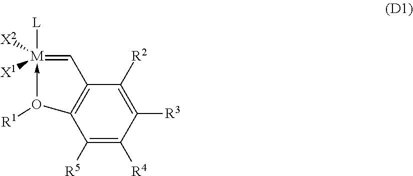

in which M, L, X¹, X², R¹, R², R³, R⁴ and R⁵ may each have the general, preferred and particularly preferred definitions given for the general formula (D).

The catalysts of the general formula (D1) are known in principle, for example, from US 2002/0107138 A1 (Hoveyda et al.) and can be obtained by preparation processes specified therein.

Particular suitable catalysts are those of the general formula (D1) where
M is ruthenium,
X¹ and X² are both halogen, especially both chlorine,
R¹ is a straight-chain or branched C₁-C₁₂ alkyl radical,
R², R³, R⁴, R⁵ each have the general and preferred definitions given for the general formula (D) and
L has the general and preferred definitions given for the general formula (D).

Especially suitable catalysts are those of the general formula (D1) where
M is ruthenium,
X¹ and X² are both chlorine,
R¹ is an isopropyl radical,
R², R³, R⁴, R⁵ are all hydrogen and
L is an optionally substituted imidazolidine radical of the formula (4a) or (4b),

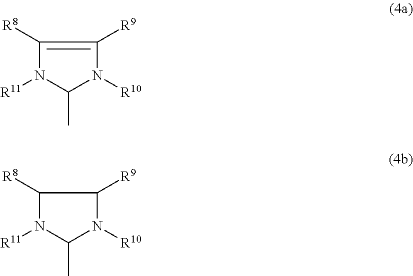

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₁-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, C₁-C₂₀-alkylsulphonyl, C₁-C₂₀-alkylsulphonate, C₆-C₂₄-arylsulphonate or C₁-C₂₀-alkylsulphinyl, where the aforementioned radicals may each be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents too may in turn be substituted by one or more radicals, preferably selected from the group of halogen, especially chlorine or bromine, C₁-C₅-alkyl, C₁-C₅-alkoxy and phenyl.

A very particularly suitable catalyst is one which is covered by the general structural formula (D1) and has the formula (9), where each Mes is 2,4,6-trimethylphenyl.

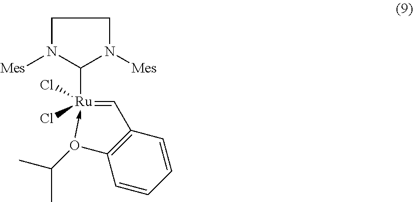

This catalyst (9) is also referred to in the literature as “Hoveyda catalyst”.

Further suitable catalysts are those which are covered by the general structural formula (D1) and have one of the following formulae (10), (11), (12), (13), (14), (15), (16) and (17), where each Mes is 2,4,6-trimethylphenyl.

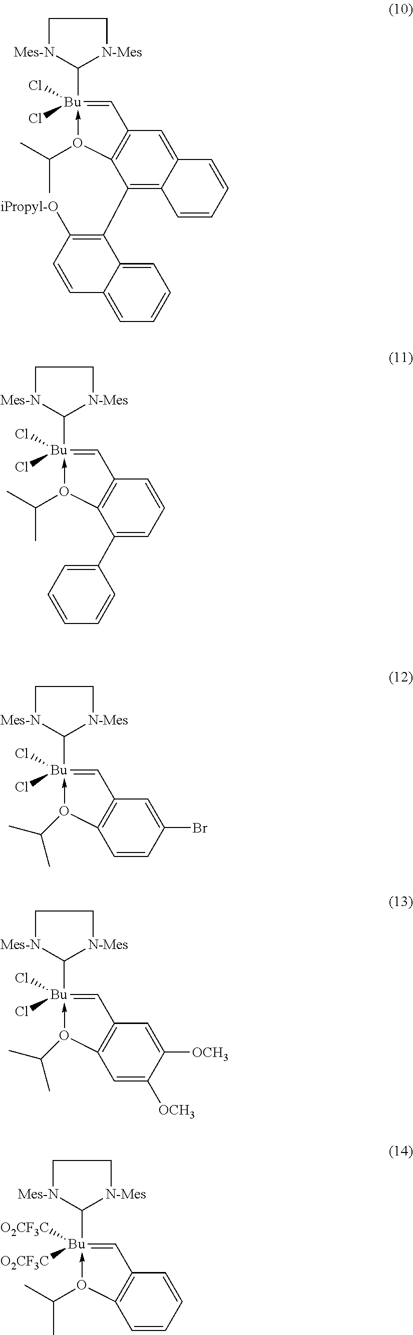

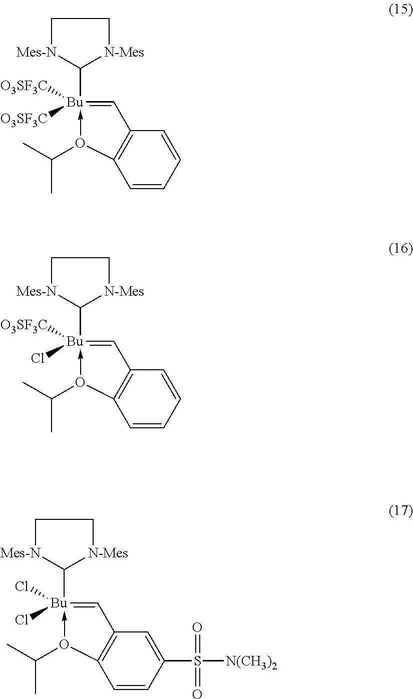

A further suitable catalyst is a catalyst of the general formula (D2)

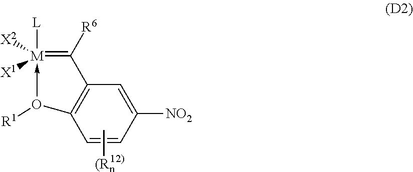

in which
M, L, X¹, X², R¹ and R⁶ each have the general and preferred definitions given for the formula (D),
R¹² are the same or different and have the general and preferred definitions given for the R², R³, R⁴ and R⁵ radicals in the formula (D), excluding hydrogen, and
n is 0, 1, 2 or 3.

The catalysts of the general formula (D2) are known in principle, for example, from WO-A-2004/035596 (Grela) and can be obtained by preparation processes specified therein.

Particular suitable catalysts are those of the general formula (D2) in which
M is ruthenium.
X¹ and X² are both halogen, especially both chlorine,
R¹ is a straight-chain or branched C₁-C₁₂ alkyl radical,
R¹² is as defined for the general formula (D2),
n is 0, 1, 2 or 3,
R⁶ is hydrogen and
L is as defined for the general formula (D).

Especially suitable catalysts are those of the general formula (D2) in which
M is ruthenium,
X¹ and X² are both chlorine,
R¹ is an isopropyl radical,
n is 0 and
L is an optionally substituted imidazolidine radical of the formula (4a) or (41) in which R¹, R⁹, R¹⁰, R¹¹ are the same or different and are each as defined for the especially preferred catalysts of the general formula (D1).

Particularly suitable catalysts are those of the structures (18) (“Grela catalyst”) and (19) below, where each Mes is 2,4,6-trimethylphenyl.

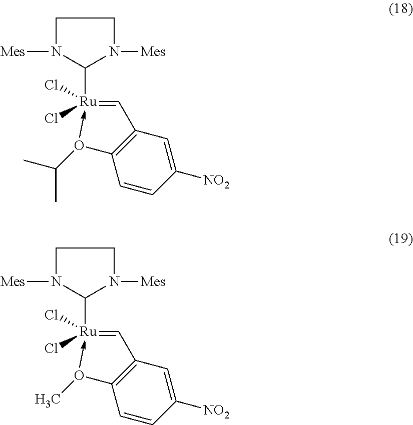

Another suitable catalyst is a dendritic catalyst of the general formula (D3)

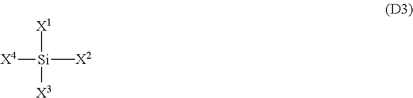

in which X¹, X², X³ and X⁴ each have a structure of the general formula (20) bonded to the silicon of the formula (D3) via the methylene group shown on the right and

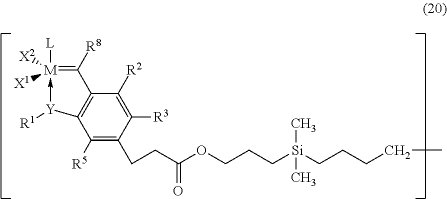

in which
M, L, X¹, X², R¹, R², R³, R⁵ and R⁶ may each have the general and preferred definitions given for the general formula (D).

The catalysts of the general formula (D3) are known from US 2002/0107138 A1 and can be prepared according to the details given therein.

Another suitable catalyst is a catalyst of the general formula (D4)

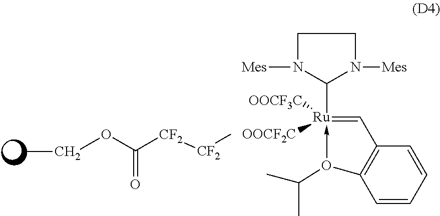

in which the symbol represents a support.

The support is preferably a poly(styrene-divinylbenzene) copolymer (PS-DVB).

The catalysts according to formula (D4) are known in principle from Chem. Eur. J. 2004 10, 777-784 and are obtainable by preparation methods described therein.

All the aforementioned catalysts of the (D), (D1), (D2), (D3) and (D4) type can either be used as such in the hydrogenation reaction or else they can be applied to a solid support and immobilized. Suitable solid phases or supports are those materials which are firstly inert with respect to the metathesis reaction mixture and secondly do not impair the activity of the catalyst. The catalyst can be immobilized using, for example, metals, glass, polymers, ceramic, organic polymer beads or else inorganic sol-gels, carbon black, silica, silicates, calcium carbonate and barium sulphate.

Other suitable catalysts are catalysts of the general formula (E)

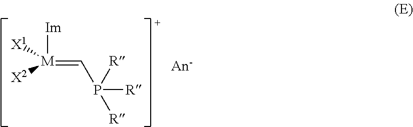

where
M is ruthenium or osmium,
X¹ and X² are the same or different and are each anionic ligands,
R″ are the same or different and are each organic radicals,
Im is an optionally substituted imidazoline or imidazolidine radical and
An is an anion.

The catalysts of the general formula (E) are known in principle (see, for example, Angew. Chem. Int. Ed. 2004, 43, 6161-6165).

X¹ and X² in the general formula (E) may have the same general, preferred and particularly preferred definitions as in the formulae (C) and (D).

The Im radical typically has a structure of the general formula (4a) or (4b) which has already been specified for the catalyst type of the formulae (C) and (D) and may also have any of the structures specified there as preferred, especially those of the formulae (5a)-(5f).

The R″ radicals in the general formula (E) are the same or different and are each a straight-chain or branched C₁-C₃₀-alkyl, C₅-C₂₀-cycloalkyl or aryl radical, where the C₁-C₃₀-alkyl radicals may optionally be interrupted by one or more double or triple bonds or else one or more heteroatoms, preferably oxygen or nitrogen.

Aryl comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The R″ radicals in the general formula (E) are preferably the same and are each phenyl, cyclohexyl, cyclopentyl, isopropyl, o-tolyl, o-xylyl or mesityl.

Other suitable catalysts are catalysts of the general formula (F)

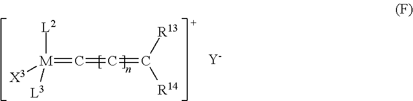

in which
M is ruthenium or osmium,
R¹³ and R¹⁴ are each independently hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₁-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
X³ is an anionic ligand,
L² is an uncharged π-bonded ligand, no matter whether mono- or polycyclic,
L³ is a ligand from the group of the phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines, stibines, ethers, amines, amides, imines, sulphoxides, thioethers and pyridines,
Y⁻ is a noncoordinating anion and
n is 0, 1, 2, 3, 4 or 5.

Other suitable catalysts are catalysts of the general formula (G)

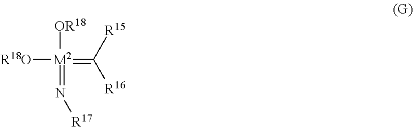

in which
M² is molybdenum,
R¹⁵ and R¹⁶ are the same or different and are each hydrogen, C₁-C₂₀-alkyl, C₂-C₂₀-alkenyl, C₂-C₂₀-alkynyl, C₆-C₂₄-aryl, C₁-C₃₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are the same or different and are each a substituted or halogen-substituted C₁-C₂₀-alkyl, C₆-C₂₄-aryl, C₆-C₃₀-aralkyl radical or silicon-containing analogues thereof.

Further suitable catalysts are catalysts of the general formula (H)

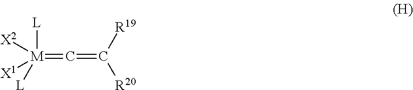

in which
M is ruthenium or osmium,
X¹ and X² are the same or different and are each anionic ligands which may assume all definitions of X¹ and X² given in the general formulae (C) and (D),
L are identical or different ligands which may assume all definitions of L given in the general formulae (C) and (D),
R¹⁹ and R²⁰ are the same or different and are each hydrogen or substituted or unsubstituted alkyl.

Further suitable catalysts are catalysts of the general formula (K), (N) or (Q)

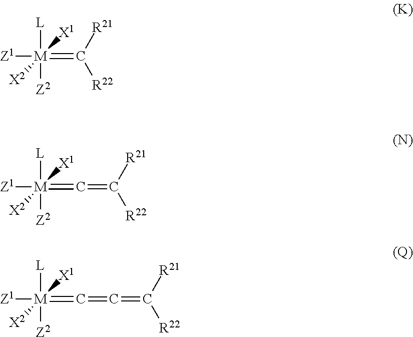

where
M is osmium or ruthenium.
X¹ and X² are the same or different and are two ligands, preferably anionic ligands,
L is a ligand, preferably an uncharged electron donor,
Z¹ and Z² are the same or different and are each uncharged electron donors,
R²¹ and R²² are each independently hydrogen, alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl, each of which is substituted by one or more radicals selected from alkyl, halogen, alkoxy, aryl and heteroaryl.

The catalysts of the general formulae (K), (N) and (Q) are known in principle, for example from WO 2003/011455 A1, WO 2003/087167 A2, Organometallics 2001, 20, 5314 and Angew. Chem. Int. Ed. 2002, 41, 4038. The catalysts are commercially available or else can be synthesized by the preparation methods specified in the aforementioned references.

In the catalysts of the general formulae (K), (N) and (Q), Z¹ and Z² are the same or different and are each uncharged electron donors. These ligands are typically weakly coordinating. They are typically optionally substituted heterocyclic groups. These may be five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals, each of which may again be substituted by one or more groups, preferably selected from the group consisting of halogen, especially chlorine or bromine, C₁-C₅-alkyl, C₁-C₅-alkoxy and phenyl.

Examples of Z¹ and Z² include nitrogen-containing heterocycles such as pyridines, pyridazines, bipyridines, pyrimidines, pyrazines, pyrazolidines, pyrrolidines, piperazines, indazoles, quinolines, purines, acridines, bisimidazoles, picolylimines, imidazolidines and pyrroles.

Z¹ and Z² may also be bridged to one another to form a cyclic structure. In this case, Z¹ and Z² are a single bidentate ligand.

In the catalysts of the general formulae (K), (N) and (Q), L may assume the same general, preferred and particularly preferred definitions as L in the general formulae (C) and (D).

In the catalysts of the general formulae (K), (N) and (Q), R²¹ and R²² are the same or different and are each alkyl, preferably C₁-C₃₀-alkyl, more preferably C₁-C₂₀-alkyl, cycloalkyl, preferably C₃-C₂₀-cycloalkyl, more preferably C₃-C₈-cycloalkyl, alkenyl, preferably C₁-C₂₀-alkenyl, more preferably C₂-C₁₆-alkenyl, alkynyl, preferably C₂-C₂₀-alkynyl, more preferably C₂-C₁₆-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the aforementioned substituents may be substituted by one or more alkyl, halogen, alkoxy, aryl or heteroaryl radicals.

In the catalysts of the general formulae (K), (N) and (Q), X¹ and X² are the same or different and may have the same general, preferred and particularly preferred definitions as specified above for X¹ and X² in the general formula (C).

Particularly suitable catalysts are those of the general formulae (K), (N) and (Q) in which
M is ruthenium,
X¹ and X² are both halogen, especially chlorine,
R¹ and R² are the same or different and are each five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals,
R²¹ and R²² are the same or different and are each C₁-C₃₀-alkyl, C₃-C₂₀-cycloalkyl, C₂-C₂₀-alkenyl, C₂-C₃₀-alkynyl, C₆-C₂₄-aryl, C₁-C₂₀-carboxylate, C₁-C₂₀-alkoxy. C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the general formula (4a) or (4b) already described above, especially of the formulae (5a) to (5f).

A very particularly suitable catalyst is one which is covered by the general formula (K) and has the structure (21)

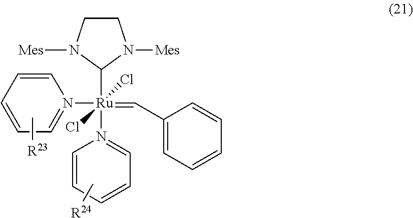

in which
R²³ and R²⁴ are the same or different and are each H, halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, dialkylamino, trialkylsilyl and trialkoxysilyl.

The aforementioned C₁-C₃₀-alkyl, C₁-C₂₀-heteroalkyl, C₁-C₁₀-haloalkyl, C₁-C₁₀-alkoxy, C₆-C₂₄-aryl radicals, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, trialkylsilyl and trialkoxysilyl, may again each be substituted by one or more halogen, preferably fluorine, chlorine or bromine, C₁-C₅-alkyl, C₁-C₅-alkoxy or phenyl radicals.

Very particular preference is given to a catalyst in which R²³ and R²⁴ are each hydrogen (“Grubbs III catalyst”).

Also very particularly suitable are catalysts of the structures (22a) or (22b) where R²³ and R²⁴ have the same definitions as in the formula (21), except for hydrogen.

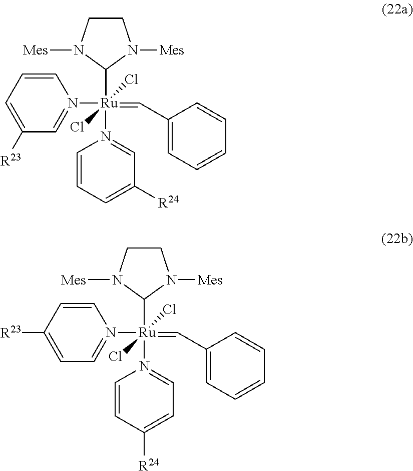

Suitable catalysts covered by the general formulae (K), (N) and (Q) have the structural formulae (23) to (34) below, where each Mes is 2,4,6-trimethylphenyl.

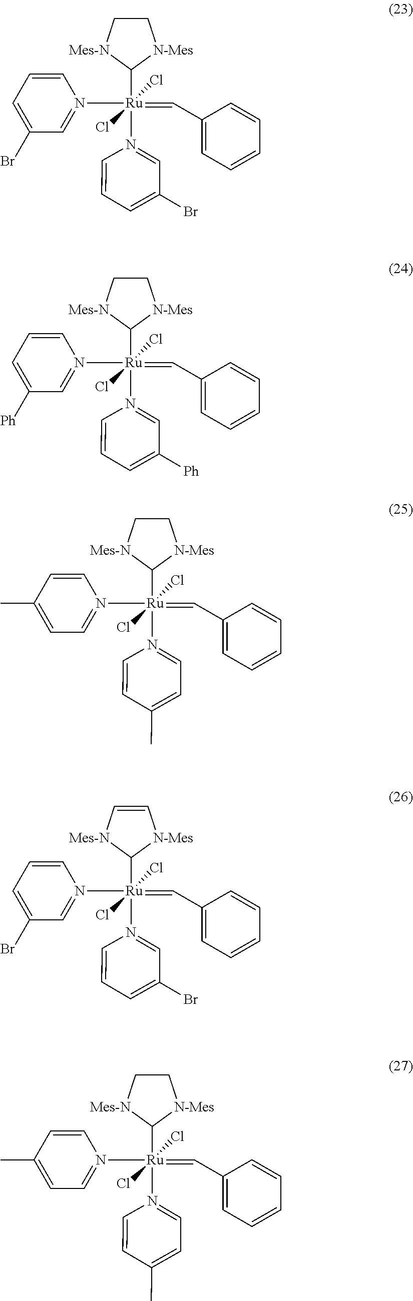

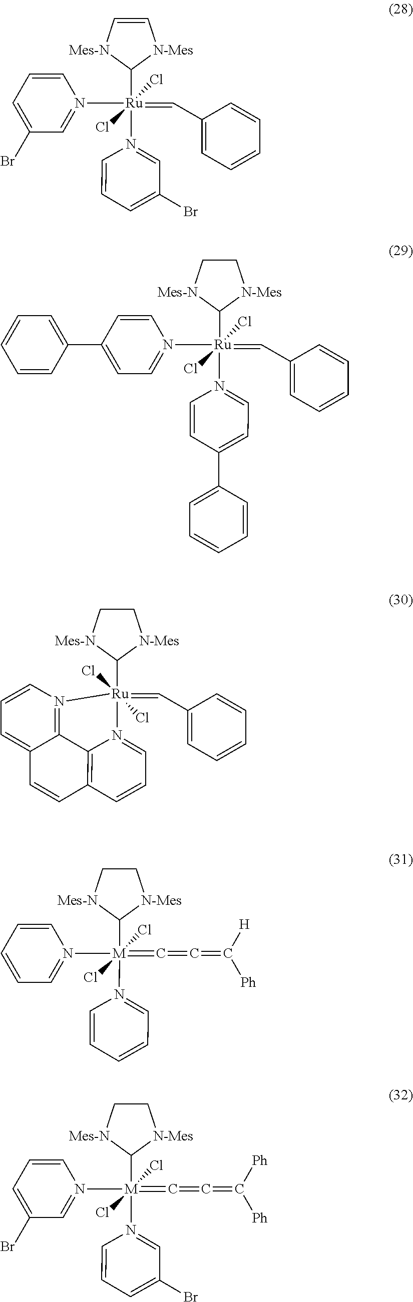

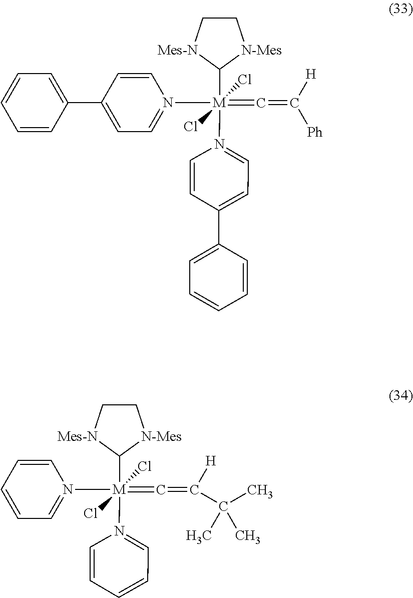

Also suitable are catalysts (R) having the general structural element (R1), where the carbon atom identified by “*” is bonded to the catalyst base skeleton via one or more double bonds, identified by “*” is bonded to the catalyst base skeleton via one or more double bonds.

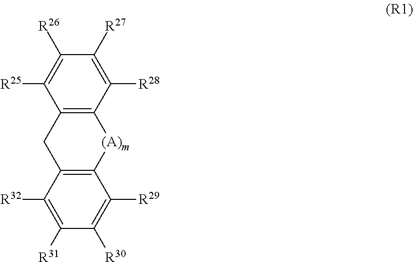

and in which
R²⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (−SO₃⁻), —OSO₃⁻, —PO₃⁻; or OPO₃⁻, or are each alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, are bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)—, in which R³³-R³⁹ are the same or different and may each have the same definitions as the R²⁵-R³² radicals.

The inventive catalysts have the structural element of the general formula (R1), where the carbon atom identified by “*” is bonded to the catalyst base skeleton via one or more double bonds. When the carbon atom identified by “*” is bonded to the catalyst base skeleton via two or more double bonds, these double bonds may be cumulated or conjugated.

Catalysts (R) of this kind are described in EP-A-2 027 920. The catalysts (R) with a structural element of the general formula (R1) include, for example, those of the following general formulae (R2a) and (R2b)

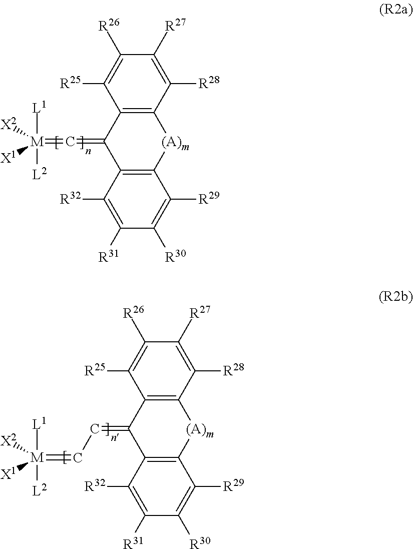

in which
M is ruthenium or osmium,
X¹ and X² are the same or different and are two ligands, preferably anionic ligands,
L¹ and L² are identical or different ligands, preferably uncharged electron donors, where L² may alternatively also be bridged to the R⁸ radical,
n is 0, 1, 2 or 3, preferably 0, 1 or 2,
n′ is 1 or 2, preferably 1, and
R²⁵-R³², and A each have the same definitions as in the general formula (R1).

In the catalysts of the general formula (R2a), the structural element of the general formula (R1) is bonded to the central metal of the complex catalyst via a double bond (n=0) or via 2, 3 or 4 cumulated double bonds (in the case that n=1, 2 or 3). In the inventive catalysts of the general formula (R2b), the structural element of the general formula (R1) is bonded to the metal of the complex catalyst via conjugated double bonds. In both cases, there is a double bond in the direction of the central metal of the complex catalyst on the carbon atom identified by “*” The catalysts of the general formula (R2a) and (R2b) thus include catalysts in which the following general structural elements (R3)-(R9)

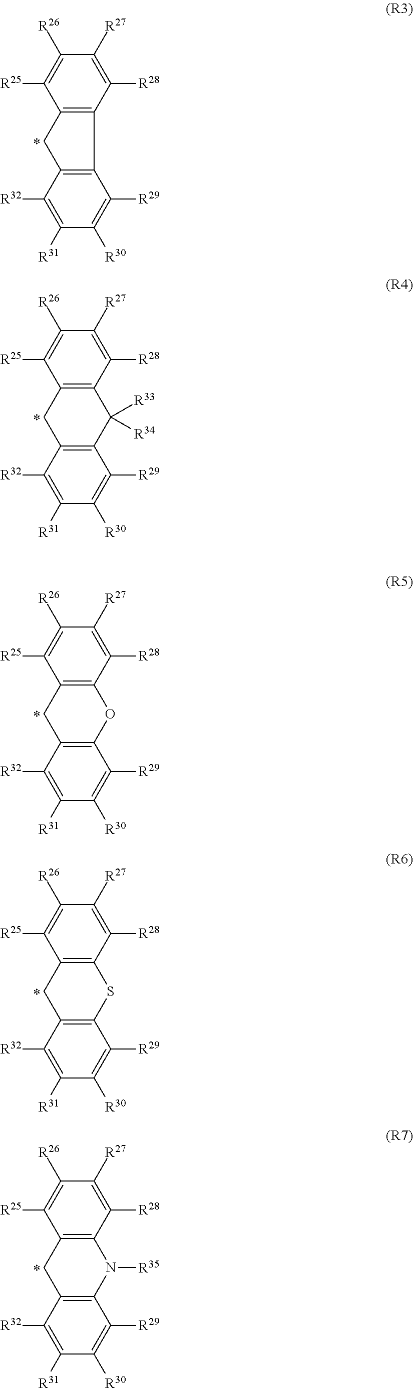

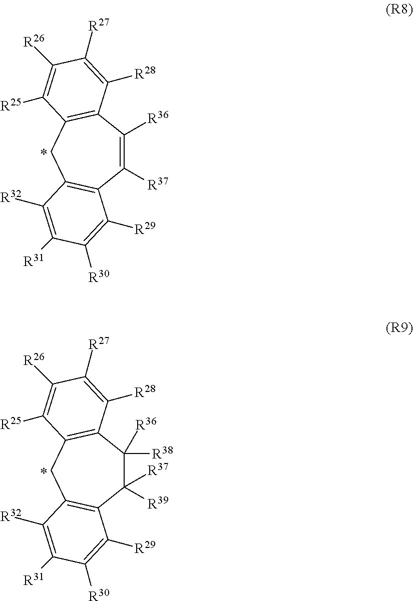

are bonded via the carbon atom identified by “*”, via one or more double bonds, to the catalyst base skeleton of the general formula (R10a) or (R10b)

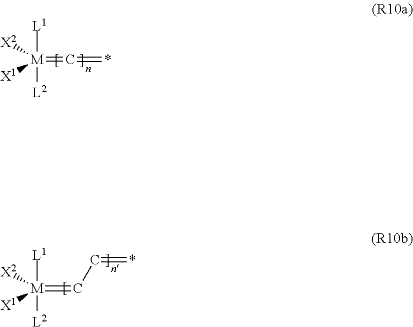

where X¹ and X², L¹ and L², n, n′ and R²⁵-R³⁹ are each as defined for the general formulae (R2a) and (R2b).

Typically, these ruthenium- or osmium-carbene catalysts are pentacoordinated.

In the structural element of the general formula (R1),
R¹⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are alkyl, preferably C₁-C₂₀-alkyl, especially C₁-C₆-alkyl, cycloalkyl, preferably C₃-C₂₀-cycloalkyl, especially C₃-C₈-cycloalkyl, alkenyl, preferably C₂-C₂₀-alkenyl, alkynyl, preferably C₂-C₂₀-alkynyl, aryl, preferably C₆-C₂₄-aryl, especially phenyl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino, preferably di(C₁-C₂₀-alkyl)amino, alkylsilyl, preferably C₁-C₁₀-alkylsilyl, or alkoxysilyl, preferably C₁-C₂₀-alkoxysilyl, radicals, where all these radicals may optionally each be substituted by one or more alkyl, halogen, alkoxy, aryl or heteroaryl radicals, or alternatively any two directly adjacent radicals from the group of R²⁵-R³², with inclusion of the ring carbon atoms to which they are bonded, may form a cyclic group by bridging, preferably an aromatic system, or alternatively R⁸ is optionally bridged with another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)—, or —C(R³⁶)(R³⁸)—C(R³⁷)(R³⁹)—, in which R³³-R³⁹ are the same or different and may each have the same preferred definitions as the R¹-R⁸ radicals.

C₁-C₆-Alkyl in the structural element of the general formula (R1) is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl in the structural element of the general formula (R1) is, for example, cyclopropyl, cyclobutyl, cyclopentyl, cyclohexyl, cycloheptyl and cyclooctyl.

C₆-C₂₄-Aryl in the structural element of the general formula (R1) comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The X¹ and X² radicals in the structural element of the general formula (R1) have the same general, preferred and particularly preferred definitions which are specified for catalysts of the general formula (C).

In the general formulae (R2a) and (R2b) and analogously (R10a) and (R10b), the L¹ and L² radicals are identical or different ligands, preferably uncharged electron donors and may have the same general, preferred and particularly preferred definitions which are specified for catalysts of the general formula (C).

Preference is given to catalysts of the general formula (R2a) or (R2b) with a general structural unit (N1) where
M is ruthenium,
X¹ and X² are both halogen,
n is 0, 1 or 2 in the general formula (R2a) or
n′ is 1 in the general formula (R2b)
L¹ and L² are the same or different and have the general or preferred definitions specified for the general formulae (R2a) and (R2b),
R²⁵-R³² are the same or different and have the general or preferred definitions specified for the general formulae (R2a) and (R2b),
m is either 0 or 1,
and, when m=1,
A is oxygen, sulphur, C(C₁-C₁₀-alkyl)₂, —C(C₁-C₁₀-alkyl)₂-C(C₁-C₁₀-alkyl)₂-, —C(C₁-C₁₀-alkyl)−C(C₁-C₁₀-alkyl)- or —N(C₁-C₁₀-alkyl).

Particular preference is given to catalysts of the formula (R2a) or (R2b) with a general structural unit (R1) where
M is ruthenium,
X¹ and X² are both chlorine,
n is 0, 1 or 2 in the general formula (R2a) or
n′ is 1 in the general formula (R2b)
L¹ is an imidazolidine radical of the formulae (5a) to (5f),
L² is a sulphonated phosphine, phosphate, phosphinite, phosphonite, arsine, stibine, ether, amine, amide, sulphoxide, carboxyl, nitrosyl, pyridine radical, an imidazoline or imidazolidine radical of the formulae (5a) to (5f) or a phosphine ligand, especially PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred definitions specified for the general formulae (R2a) and (R2b),
m is either 0 or 1,
and, when m=1,
A is oxygen, sulphur, C(C₁-C₁₀-alkyl)₂, —C(C₁-C₁₀-alkyl)₂-C(C₁-C₁₀-alkyl)₂-, —C(C₁-C₁₀-alkyl)=C(C₁-C₁₀-alkyl)- or —N(C₁-C₁₀-alkyl).

In the case that the R²⁵ radical is bridged with another ligand of the catalyst of the formula R, for example for the catalysts of the general formulae (R2a) and (R2b), this gives rise to the following structures of the general formulae (R13a) and (R13b)

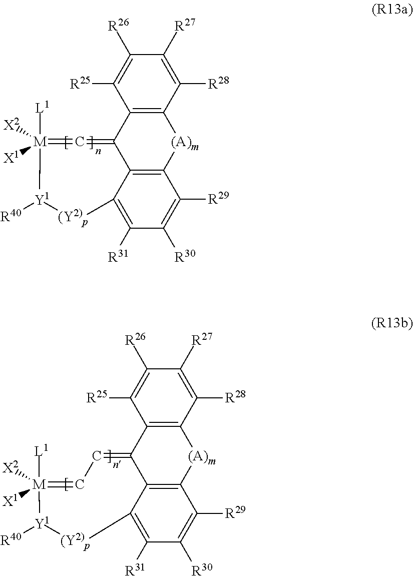

in which
Y¹ is oxygen, sulphur, an N—R⁴¹ radical or a P—R⁴¹ radical, where R″ is as defined below,
R⁴⁰ and R⁴¹ are the same or different and are each an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
p is 0 or 1 and
Y² when p=1 is —(CH₂)ᵣ— where r=1, 2 or 3, —C(═O)—CH₂—, —C(═O)—, —N═CH—, —N(H)—C(═O)—, or else alternatively the overall structural unit “—Y¹(R⁴⁰)—(Y²)ₚ—” is (—N(R⁴⁰)═CH—CH₂—), (—N(R⁴⁰,R⁴¹)═CH—CH₂—), and
   where M, X¹, X², L¹, R²⁵-R³², A, m and n have the same definitions as in the general formulae (R10a) and (R10b).

Examples of catalysts of the general formula (R) include the following structures (35) to (45):

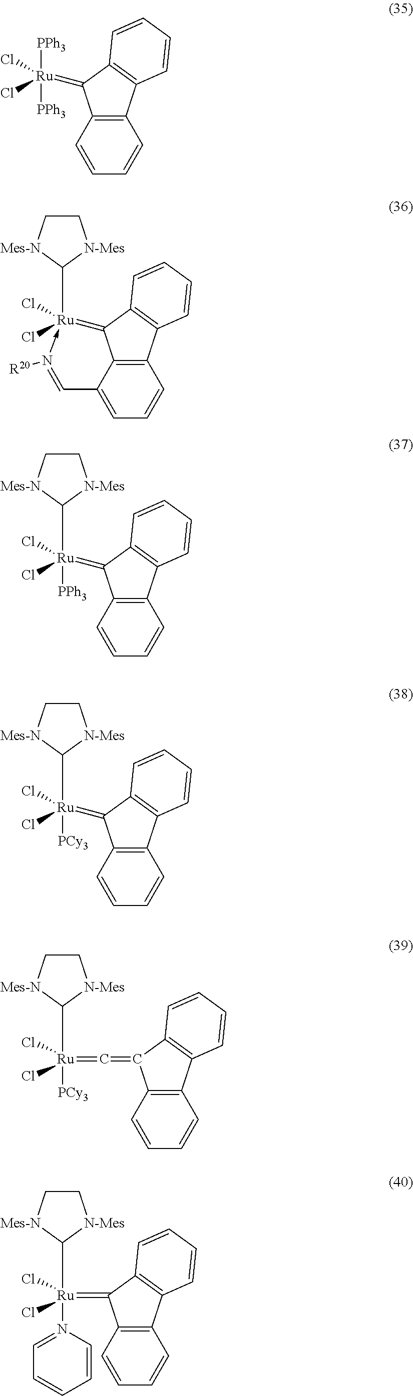

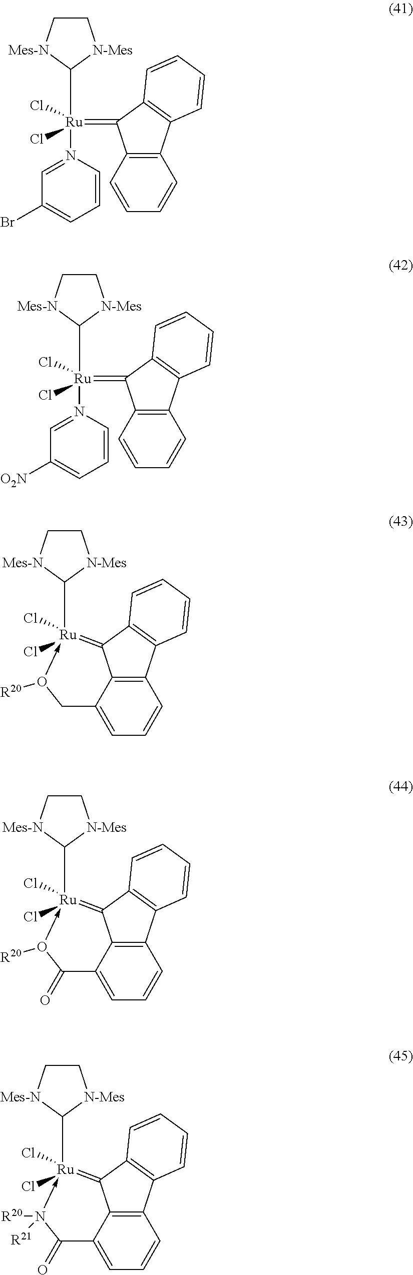

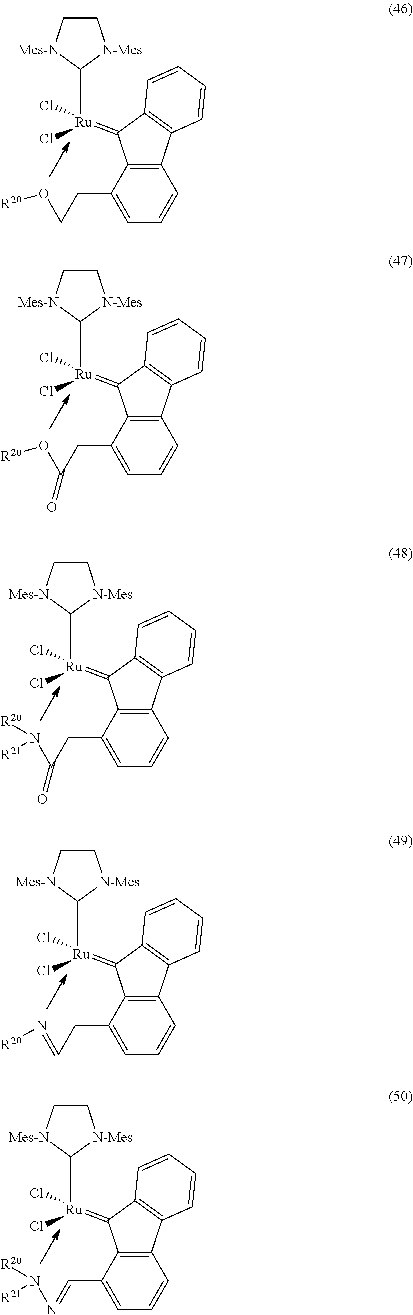

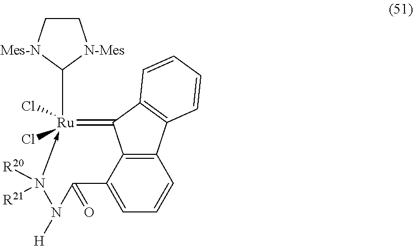

The preparation of catalysts of the general formula (R) is known from EP-A-2 027 920.

Additionally suitable are catalysts according to the general formula (T)

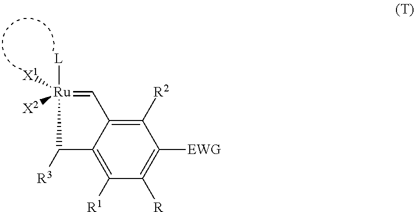

in which
X¹ and X² are the same or different and are each anionic ligands, or alternatively are joined to one another via carbon-carbon and/or carbon-heteroatom bonds,
Y is an uncharged two-electron donor selected from O, S, N and P,
R is H, halogen, alkyl, alkoxy, aryl, aryloxy, alkylcarbonyl, arylcarbonyl, alkoxycarbonyl, aryloxycarbonyl, heteroaryl, carboxyl (RCO₂⁻), cyano, nitro, amido, amino, aminosulphonyl, N-heteroarylsulphonyl, alkylsulphonyl, arylsulphonyl, alkylsulphinyl, arylsulphinyl, alkylthio, arylthio or sulphonamide,
R¹ and R² are each H, Br, I, alkyl, alkoxy, aryl, aryloxy, alkylcarbonyl, arylcarbonyl, alkoxycarbonyl, aryloxycarbonyl, carboxyl, amido, amino, heteroaryl, alkylthio, arylthio, or sulphonamido,
R³ is alkyl, aryl, heteroaryl, alkylcarbonyl, arylcarbonyl, thiocarbonyl, or aminocarbonyl,
EWG is an electron-withdrawing group selected from the group consisting of aminosulphonyl, amidosulphonyl, N-heteroarylsulphonyl, arylsulphonyl, arylsulphinyl, arylcarbonyl, alkylcarbonyl, aryloxycarbonyl, aminocarbonyl, amido, sulphonamido, chlorine, fluorine, H, or haloalkyl and
L is an electron-donating ligand joined to X¹ via carbon-carbon and/or carbon-heteroatom bonds.

These catalysts of the general formula (T) are known from US 2007/0043180 (Zannan).

Preference is given to catalysts of the general formula (T) in which X¹ and X² are selected from an ionic ligand in the form of halides, carboxylates and aryl oxides. More preferably, X¹ and X² are both halides, especially both chlorides. In the general formula (T), Y is preferably oxygen. R is preferably H, halogen, alkoxycarbonyl, aryloxycarbonyl, heteroaryl, carboxyl, amido, alkylsulphonyl, arylsulphonyl, alkylthio, arylthio or sulphonamido. More particularly, R is H, Cl, F or a C₁₄ alkoxycarbonyl group. R¹ and R² are the same or different and are preferably each H, alkoxy, aryl, aryloxy, alkoxycarbonyl, amido, alkylthio, arylthio or a sulphonamido group. More particularly, R¹ is H or an alkoxy group and R² is hydrogen. In the general formula (T), R³ is preferably an alkyl, aryl, heteroaryl, alkylcarbonyl or arylcarbonyl group. More preferably, R³ is isopropyl, sec-butyl and methoxyethyl. In the general formula (T), EWG is preferably an aminosulphonyl, amidosulphonyl, N-heteroarylsulphonyl, arylsulphonyl, aminocarbonyl, arylsulphonyl, alkylcarbonyl, aryloxycarbonyl, halogen or haloalkyl group. More preferably, EWG is a C₁₋₁₂ N-alkylaminosulphonyl, C₂₋₁₂ N-heteroarylsulphonyl, C₁₋₁₂ aminocarbonyl, C₆₋₁₂ arylsulphonyl, C₁₋₁₂ alkylcarbonyl, C₆₋₁₂ arylcarbonyl, C₆₋₁₂ aryloxycarbonyl, Cl, F or trifluoromethyl group. In the general formula (T), L is an electron-donating ligand selected from phosphines, amino, aryl oxides, carboxylates and heterocyclic carbene radicals which may be bonded to X¹ via carbon-carbon and/or carbon-heteroatom bonds.

A particularly suitable catalyst is one of the general formula (T) in which L is a heterocyclic carbene ligand or a phosphine (P(R⁸)₂(R⁹) having the following structures:

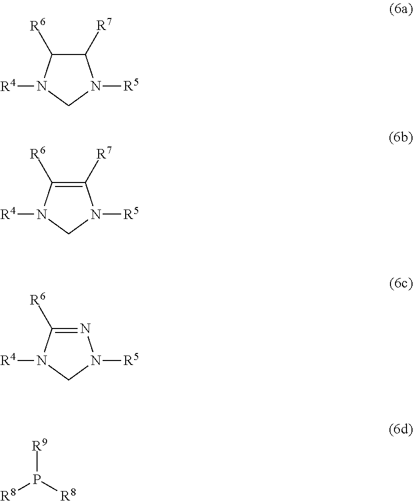

in which
R⁴ and R⁵ are the same or different and are each C₆₋₁₂ aryl and
R⁶ and R⁷ are the same or different and are each H, halogen, alkyl, alkoxy, aryl, aryloxy, alkylcarbonyl, arylcarbonyl, alkoxycarbonyl, aryloxycarbonyl, heteroaryl, carboxyl, cyano, nitro, amido, amino, alkylsulphonyl, arylsulphonyl, alkylsulphinyl, arylsulphinyl, alkylthio or sulphonamido and
R⁸ and R⁹ are the same or different and are each C₁₋₈ alkyl or C₆₋₁₂ aryl.

Additionally suitable are bimetallic complexes of the general formula (U)

M¹ₐM²_{b}Xₘ(L¹)ₙ (U)
in which
M¹ is rhodium (Rh) or ruthenium (Ru),
M² is ruthenium (Ru) or a lanthanide,
where, when M¹ is rhodium (Rh), M² is ruthenium (Ru) or a lanthanide and, when M¹ is ruthenium (Ru), M² is a lanthanide,
X are the same or different and are each H, Cl or Br.
L¹ is an organophosphine (PR¹R²R³), diphosphine (R¹R²P(CH₂)ₙPR³R⁴), organoarsine (AsR¹R²R³) or other organic compounds containing nitrogen, sulphur, oxygen atoms or mixtures thereof, where R¹, R², R³ and R⁴ are the same or different and are each C₁-C₆ alkyl, C₆-C₁₂ cycloalkyl, aryl, C₇-C₁₂ aralkyl or aryloxy groups,
1≦a≦4,
1≦b≦2,
3≦m≦6 and
6≦n≦15.

These catalysts of the general formula (U) are known in principle from U.S. Pat. No. 6,084,033.

Particularly suitable catalysts are those of the general formula (U) in which M¹ is rhodium and M² is ruthenium. Other particularly suitable catalysts are those of the general formula (U) in which M² is a lanthanide, especially Ce or La. In particularly suitable catalysts of the general formula (U), X are the same or different and are each H or Cl. Particularly suitable catalysts of the general formula (U) are those in which L¹ is selected from trimethylphosphine, triethylphosphine, triphenylphosphine, triphenoxyphosphine, tri(p-methoxyphenyl)phosphine, diphenylethylphosphine, 1,4-di(diphenylphosphano)butane, 1,2-di(diphenylphosphano)ethane, triphenylarsine, dibutylphenylarsine, diphenylethylarsine, triphenylamine, triethylamine, N,N-dimethylaniline, diphenyl thioether, dipropyl thioether, N,N′-tetramethykthylenediamine, acetylacetone, diphenyl ketones and mixtures thereof.

Further catalysts which can be used are described in the following documents: U.S. Pat. No. 3,700,637. DE-A-25 39 132, EP-A 134 023, DE-A 35 41 689, DE 3540918, EP-A-0 298 386, DE-A 3529252, DE-A 3433 392, U.S. Pat. No. 4,464,515, U.S. Pat. No. 4,503,196 and EP-A-1 720 920.

### Amount of Hydrogenation Catalyst:

For the hydrogenation of the nitrile rubber, the hydrogenation catalyst can be used within a wide range of amounts. Typically, the catalyst is used in an amount of 0.001 to 1.0% by weight, preferably from 0.01 to 0.5% by weight, especially 0.05 to 0.3% by weight, based on the nitrile rubber to be hydrogenated.

### Other Hydrogenation Conditions:

The performance of the hydrogenation is sufficiently well known to those skilled in the art, for example from U.S. Pat. No. 6,683,136A.

### Solvent:

The hydrogenation is typically effected in a solvent, preferably an organic solvent. Suitable organic solvents are, for example, acetone, methyl ethyl ketone, ethyl acetate, tetrahydrofuran, 1,3-dioxane, benzene, toluene, methylene chloride, chloroform, monochlorobenzene and dichlorobenzene. Monochlorobenzene has been found to be particularly useful, since it is a good solvent both for nitrile rubbers having different nitrile contents and for the corresponding resulting hydrogenated nitrile rubbers.

### Nitrile Rubber Concentration:

For the hydrogenation, the nitrile rubber is typically dissolved in at least one solvent. The concentration of the nitrile rubber in the hydrogenation is generally in the range of 1-30% by weight, preferably in the range of 5-25% by weight, more preferably in the range of 7-20% by weight.

The pressure in the hydrogenation is typically within the range from 0.1 bar to 250 bar, preferably from 5 bar to 200 bar, more preferably from 50 bar to 150 bar. The temperature is typically within the range from 0° C. to 180° C., preferably from 20° C. to 160° C., more preferably from 50° C. to 150° C. The reaction time is generally 2 to 10 h.

In the course of the hydrogenation, the double bonds present in the nitrile rubber used are hydrogenated to an extent of preferably greater than 94.5-100%, more preferably 95-100%, even more preferably 96-100%, especially 97-100% and especially preferred 98-100%. Hydrogenated nitrile rubbers having a residual content of double bonds (“RDB”) in the range from 0 to 0.9% are also obtainable. The hydrogenation is monitored online by determining the hydrogen absorption or by Raman spectroscopy (EP-A-0 897 933) or IR spectroscopy (U.S. Pat. No. 6,522,408). A suitable IR method for offline determination of the hydrogenation level is additionally described by D. Brück in Kautschuke+Gummi, Kunststoffe, Vol. 42. (1989), No. 2, p. 107-110 (part 1) and in Kautschuke+Gummi, Kunststoffe, Vol. 42. (1989), No. 3, p. 194-197.

On attainment of the hydrogenation level, the reactor is decompressed. Residual amounts of hydrogen are typically removed by nitrogen purging.

Before the removal of the solvent and isolation of the hydrogenated nitrile rubber from the organic phase, the hydrogenation catalyst can be, but need not be, removed. A preferred process for rhodium recovery is described, for example, in U.S. Pat. No. 4,985,540.

### Cocatalysts:

The hydrogenation can be effected with addition of a phosphine or diphosphine as a cocatalyst. The latter are typically used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Suitable phosphine cocatalysts are those of the general formula (1-a)

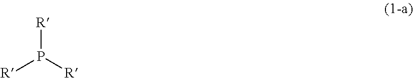

where
R are the same or different and are each alkyl, alkenyl, alkadienyl, alkoxy, aryl, heteroaryl, cycloalkyl, cycloalkenyl, cycloalkadienyl, halogen or trimethylsilyl,
   and suitable diphosphine cocatalysts are those of the general formula (1-b)

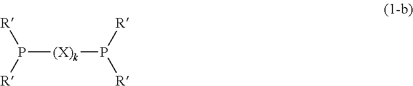

in which
R are the same or different and have the same definitions as in the general formula (1-a),
k is 0 or 1 and
X is a straight-chain or branched alkanediyl, alkenediyl or alkynediyl group.

The R′ radicals in both of these formulae (1-a) and (1-b) may be unsubstituted or mono- or polysubstituted.

Such phosphines or diphosphines of the general formulae (1-a) and (1-b) are preparable by methods known to those skilled in the art or else are commercially available.

Alkyl radicals in the R′ radicals of the phosphines or diphosphines of the general formulae (1-a) and (1-b) are typically understood to mean straight-chain or branched C₁-C₃₀-alkyl radicals, preferably C₁-C₂₄-alkyl radicals, more preferably C₁-C₁₈-alkyl radicals. C₁-C₁₈-alkyl comprises, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, 1,1-dimethylpropy 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, n-nonyl, n-decyl, n-undecyl, n-dodecyl, n-tridecyl, n-tetradecyl, n-hexadecyl and n-octadecyl.

Alkenyl radicals in the R′ radicals of the phosphines or diphosphines of the general formulae (1a) and (1-b) are typically understood to mean C₂-C₃₀-alkenyl radicals, preferably C₂-C₂₀-alkenyl radicals. More preferably, an alkenyl radical is a vinyl radical or an allyl radical.

Alkadienyl radicals in the R′ radicals of the phosphines or diphosphines of the general formulae (1-a) and (1-b) are typically understood to mean C₁-C₃₀-alkadienyl radicals, preferably C₁-C₁₀-alkadienyl radicals. More preferably, an alkadienyl radical is butadienyl or pentadienyl.

Alkoxy radicals in the R radicals of the phosphines or diphosphines of the general formulae (1-a) and (1-b) are typically understood to mean C₁-C₂-alkoxy radicals, preferably C₁-C₁₀-alkoxy radicals, more preferably methoxy, ethoxy, n-propoxy, isopropoxy, n-butoxy, sec-butoxy, tert-butoxy, n-pentoxy and n-hexoxy.

Aryl radicals in the R′ radicals of the phosphines or diphosphines of the general formulae (1-a) and (1-b) are typically understood to mean C₅-C₂₄-aryl radicals, preferably C₆-C₁₄-aryl radicals, more preferably C₆-C₁₂-aryl radicals. Examples of C₅-C₂₄-aryl are phenyl, o-, p- or m-tolyl, naphthyl, phenanthrenyl, anthracenyl and fluorenyl.

Heteroaryl radicals in the R″ radicals of the phosphines or diphosphines of the general formulae (1-a) and (1-b) have the same definition as given above for aryl radicals, except that one or more of the skeleton carbon atoms are replaced by a heteroatom selected from the group of nitrogen, sulphur and oxygen. Examples of such heteroaryl radicals are pyridinyl, oxazolyl, benzofuranyl, dibenzofuranyl and quinolinyl.

All the aforementioned alkyl, alkenyl, alkadienyl and alkoxy radicals may be unsubstituted or mono- or polysubstituted, for example by C₅-C₂₄-aryl radicals, preferably phenyl (in the case of alkyl radicals, this results, for example, in arylalkyl, preferably a phenylalkyl radical), halogen, preferably fluorine, chlorine or bromine, CN, OH, NH₂ or NR″₂ radicals where R″ in turn is C₁-C₃₀-alkyl or C₅-C₂₄-aryl.

Both the aryl radicals and the heteroaryl radicals are either unsubstituted or mono- or polysubstituted, for example by straight-chain or branched C₁-C₃₀-alkyl (resulting in what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or N(R″)₂ radicals, where R″ in turn is straight-chain or branched C₁-C₃₀-alkyl or C₅-C₂₄-aryl, or by further C₅-C₂₄-aryl or -heteroaryl radicals, which results in bisaryl radicals, preferably biphenyl or binaphthyl, heteroarylaryl radicals, arylheteroaryl radicals or bisheteroaryl radicals. These C₅-C₂₄-aryl or -heteroaryl substituents too are again either unsubstituted or mono- or polysubstituted by all the aforementioned substituents.

Cycloalkyl radicals in the R′ radicals of the phosphines or diphosphines of the general formulae (1-a) and (1-b) are typically understood to mean a C₃-C₂₀-cycloalkyl radical, preferably a C₃-C₈-cycloalkyl radical, more preferably cyclopentyl and cyclohexyl.

Cycloalkenyl radicals in the R′ radicals of the phosphines or diphosphines of the general formulae (1-a) and (1-b) are the same or different, have one C═C double bond in the ring skeleton and are typically C₅-C₈ cycloalkenyl, preferably cyclopentenyl and cyclohexenyl.

Cycloalkadienyl radicals in the R′ radicals of the phosphines or diphosphines of the general formulae (1-a) and (1-b) are the same or different, have two C═C double bonds in the ring skeleton and are typically C₅-C₈ cycloalkadienyl, preferably cyclopentadienyl or cyclohexadienyl.

The aforementioned cycloalkyl, cycloalkenyl and cycloalkadienyl radicals too are either unsubstituted or mono- or polysubstituted, for example by straight-chain or branched C₁-C₃₀-alkyl (the result is then what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or NR″₂ radicals, where R″ in turn is straight-chain or branched C₁-C₃₀-alkyl or C₅-C₂₄-aryl, or substituted by C₅-C₂₄-aryl or -heteroaryl radicals, which are in turn either unsubstituted or mono- or polysubstituted by all the aforementioned substituents.

The halogen radicals in the R′ radicals of the phosphines or diphosphines of the general formulae (1-a) and (1-b) are the same or different and are each fluorine, chlorine or bromine.

Particularly preferred phosphines of the general formula (1-a) are trialkyl-, tricycloalkyl-, triaryl-, trialkaryl-, triaralkyl-, diarylmonoalkyl-, diarylmonocycloalkyl-, dialkylmonoaryl-, dialkylmonocycloalkyl- or dicycloalkylmonoarylphosphines, where all the aforementioned radicals in turn are either unsubstituted or mono- or polysubstituted by the aforementioned substituents.

Especially preferred phosphines are those of the general formula (1-a) in which the R radicals are the same or different and are each phenyl, cyclohexyl, cyclohexenyl, cyclopentyl, cyclopentadienyl, phenylsulphonate or cyclohexylsulphonate.

Most preferably, phosphines of the general formula (1-a) used are PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄SO₃Na)₃, P(CH₂C₆H₄—SO₃Na)₃, P(iso-Pr)₃, P(CHCH₃(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃, P(CH₂OH)₃, P(m-CH₃OC₆H₄)₃, P(C₆F₅)₃, P[(CH₃)₃Si]₃, P[(CH₃O)₃C₆H₂]₃, where Ph is phenyl, Tol is tolyl, biph is biphenyl, Bu is butyl and Pr is propyl. Triphenylphosphine is especially preferred.

In the diphosphines of the general formula (1-b), k is 0 or 1, preferably 1,

X in the general formula (1-b) is a straight-chain or branched alkanediyl, alkenediyl or alkynediyl group, preferably a straight-chain or branched C₁-C₂₀-alkanediyl, C₂-C₂₀-alkenediyl or C₂-C₂₀-alkynediyl group, more preferably a straight-chain or branched C₁-C₈-alkanediyl, C₂-C₆-alkenediyl or C₂-C₆-alkynediyl group.

C₁-C₈-Alkanediyl is a straight-chain or branched alkanediyl radical having 1 to 8 carbon atoms. Particular preference is given to a straight-chain or branched alkanediyl radical having 1 to 6 carbon atoms, especially having 2 to 4 carbon atoms. Preference is given to methylene, ethylene, propylene, propane-1,2-diyl, propane-2,2-diyl, butane-1,3-diyl, butane-2,4-diyl, pentane-2,4-diyl and 2-methylpentane-2,4-diyl.

C₂-C₆-Alkenediyl is a straight-chain or branched alkenediyl radical having 2 to 6 carbon atoms. Preference is given to a straight-chain or branched alkenediyl radical having 2 to 4, more preferably 2 or 3, carbon atoms. Preferred examples include: vinylene, allylene, prop-1-ene-1,2-diyl and but-2-ene-1,4-diyl.

C₂-C₆-Alkynediyl is a straight-chain or branched alkynediyl radical having 2 to 6 carbon atoms. Preference is given to a straight-chain or branched alkynediyl radical having 2 to 4, more preferably 2 or 3, carbon atoms. Preferred examples include: ethynediyl and propynediyl.

Particularly preferred diphosphines of the general formula (1-b) are Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₃PCH═CHP(C₆H₅)₂, (C₆F₅)₂P(CH₂)₂P(C₆F₅)₂, (C₆H₅)₂P(CH₂)₂P(C₆H₅)₂, (C₆H₅)₃P(CH₂)₃P(C₆H₅)₂, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂ and (C₆H₅)₂PCH(CH₃)CH₂P(C₆H₅)₂.

Particular diphosphines likewise usable in accordance with the invention are also published in Chem. Eur. J. 2008, 14, 9491-494. Examples include:

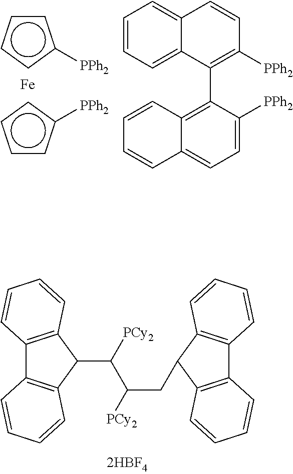

If the hydrogenation in the process according to the invention is effected with addition of a phosphine or diphosphine, these are typically used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Based on 1 equivalent of the hydrogenation catalyst, the phosphine or diphosphine, in a tried and trusted manner, is used in an amount in the range from 0.1 to 10 equivalents, preferably in the range from 0.2 to 5 equivalents and more preferably in the range from 0.3 to 3 equivalents.

The weight ratio of the added phosphine or diphosphine to the hydrogenation catalyst is typically (1-100):1, preferably (3-30), especially (5-15):1.

It is also possible to subject the nitrile rubber to a metathesis reaction before the hydrogenation, in order to lower the molecular weight of the nitrile rubber. The metathesis of nitrile rubbers is sufficiently well known to those skilled in the art. If a metathesis is effected, it is also possible to conduct the subsequent hydrogenation in situ, i.e. in the same reaction mixture in which the metathesis degradation has also been effected beforehand and without the need to isolate the degraded nitrile rubber. The hydrogenation catalyst is simply added to the reaction vessel.

After the hydrogenation, the solvent is removed either by a dry workup, preferably via a roller drying process or a screw process, or by a wet workup, preferably via a steam distillation, more preferably via a steam distillation with subsequent drying of the isolated rubber crumbs by means of a fluidized bed dryer or in an expeller-expander dryer.

Dry workup processes are, for example, the roller drying process described in DE-A-4032598 and the screw processes described in WO-A-2011/023763 and in EP-A-2368917.

A wet workup by means of a steam distillation is also suitable for the removal of the solvent used in the hydrogenation when the subsequent drying of the isolated water-moist rubber crumbs is effected in a fluidized bed dryer or in an expeller-expander dryer. Drying methods of this kind are sufficiently well known to those skilled in the art.

Each of these workup processes is conducted such that the substituted phenol of the general formula (I) present in the hydrogenated nitrile rubber, in a tried and trusted manner, is removed to an extent of 20-98% by weight, based on the amount of the substituted phenol of the general formula (I), from the nitrile rubber used for hydrogenation.

Fluidized bed drying is particularly suitable; preference is given to continuous performance of the fluidized bed drying. This is accomplished by means of an air flow having a temperature of 100 to 180° C., especially 110° C. to 150° C., through crumbs of the hydrogenated nitrile rubber having water contents of 5 to 50% by weight. The residence time is 1 to 15 min, and it is also possible to work with a temperature profile in the fluidized bed drying operation.

This affords a hydrogenated nitrile rubber having a Mooney viscosity (ML 1+4 @ 100° C.), measured to ASTM Standard D 1646, in the range of 1-50. This corresponds roughly to a weight-average molecular weight M_{w} in the range of 2000-400 000 g/mol. Preferably, the Mooney viscosity (ML 1+4 0 100° C.) is in the range from 5 to 30. This corresponds roughly to a weight-average molecular weight M_{w} in the range of about 20 000-200 000. The hydrogenated nitrile rubbers obtained also have a polydispersity PDI=M_{w}/Mₙ, where M_{w} is the weight-average and Mₙ the number-average molecular weight, in the range of 1-5 and preferably in the range of 1.5-3.

### Vulcanizable Mixtures:

The invention further provides vulcanizable mixtures comprising at least one inventive hydrogenated nitrile rubber and at least one crosslinking system. These vulcanizable mixtures may preferably also comprise one or more further typical rubber additives.

These vulcanizable mixtures are produced by mixing at least one inventive hydrogenated nitrile rubber (i) with at least one crosslinking system (ii) and optionally one or more further additives.

The crosslinking system comprises at least one crosslinker and optionally one or more crosslinking accelerators.

Typically, the inventive hydrogenated nitrile rubber is first mixed with all the additives selected, and the crosslinking system composed of at least one crosslinker and optionally a crosslinking accelerator is the last to be mixed in.

Useful crosslinkers include, for example, peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

It may be advantageous to use, as well as these peroxidic crosslinkers, also further additions which can help to increase the crosslinking yield: Suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc diacrylate, zinc dimethacrylate, 1,2-polybutadiene or N,N′-m-phenylenedimaleimide.

The total amount of the crosslinker(s) is typically in the range from 1 to 20 phr, preferably in the range from 1.5 to 15 phr and more preferably in the range from 2 to 10 phr, based on the unhydrogenated or fully or partly hydrogenated nitrile rubber.

The crosslinkers used may also be sulphur in elemental soluble or insoluble form, or sulphur donors.

Useful sulphur donors include, for example, dimorpholyl disulphide (DTDM), 2-morpholinodithiobenzothiazole (MBSS), caprolactam disulphide, dipentamethylenethiuram tetrasulphide (DPTT) and tetramethylthiuram disulphide (TMTD).

It is also possible to use further additions which can help to increase the crosslinking yield in the sulphur vulcanization of the inventive unhydrogenated or fully or partly hydrogenated nitrile rubbers. In principle, the crosslinking can also be effected with sulphur or sulphur donors alone.

Conversely, crosslinking of the inventive unhydrogenated or fully or partly hydrogenated nitrile rubber can also be effected only in the presence of the abovementioned additions, i.e. without addition of elemental sulphur or sulphur donors.

Suitable additions which can help to increase the crosslinking yield are, for example, dithiocarbamates, thiurams, thiazoles, sulphenamides, xanthogenates, guanidine derivatives, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams used may be, for example, tetramethylthiuram disulphide (TMTD), tetramethylthiuram monosulphide (TMTM), dimethyldiphenylthiuram disulphide, tetrabenzylthiuram disulphide, dipentamethylenethiuram tetrasulphide or tetraethylthiuram disulphide (TETD).

Thiazoles used may be, for example, 2-mercaptobenzothiazole (MBT), dibenzothiazyl disulphide (MBTS), zinc mercaptobenzothiazole (ZMBT) or copper 2-mercaptobenzothiazole.

Sulphenamide derivatives used may be, for example, N-cyclohexyl-2-benzothiazylsulphenamide (CBS), N-tert-butyl-2-benzothiazylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-butylsulphenamide or oxydiethylenethiocarbamyl-N-oxyethylenesulphenamide.

Xanthogenates used may be, for example, sodium dibutylxanthogenate, zinc isopropyldibutylxanthogenate or zinc dibutylxanthogenate.

Guanidine derivatives used may be, for example, diphenylguanidine (DPG), di-o-tolylguanidine (DOTG) or o-tolylbiguanide (OTBG).

Dithiophosphates used may be, for example, zinc di(C₂-C₁₆)alkyldithiophosphates, copper di(C₂-C₁₆)alkyldithiophosphates and dithiophosphoryl polysulphide.

A caprolactam used may be, for example, dithiobiscaprolactam.

Thiourea derivatives used may be, for example, N,N′-diphenylthiourea (DPTU), diethylthiourea (DETU) and ethylenethiourea (ETU).

Equally suitable as additions are, for example, zinc diaminodiisocyanate, hexamethylenetetramine, 1,3-bis(citraconimidomethyl)benzene and cyclic disulphanes.

The additions and crosslinking agents mentioned can be used either individually or in mixtures. Preference is given to using the following substances for the crosslinking of the nitrile rubbers: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and aforementioned additions can each be used in amounts of about 0.05 to 10 phr, preferably 0.1 to 8 phr, especially 0.5 to 5 phr (single dose, based in each case on the active substance).

In the case of sulphur crosslinking, it is possible, in addition to the crosslinking agents and abovementioned additions, also to use further inorganic or organic substances as well, such as zinc oxide, zinc carbonate, lead oxide, magnesium oxide, saturated or unsaturated organic fatty acids and zinc salts thereof, polyalcohols, amino alcohols, for example triethanolamine, and amines, for example dibutylamine, dicyclohexylamine, cyclohexylethylamine and polyether amines.

If the inventive hydrogenated nitrile rubbers are those including repeat units of one or more termonomers containing carboxyl groups, crosslinking can also be effected via the use of a polyamine crosslinker, preferably in the presence of a crosslinking accelerator. The polyamine crosslinker is not restricted, provided that it is either (1) a compound that contains two or more amino groups (optionally also in salt form) or (2) a species that forms a compound that comprises two or more amino groups in situ during the crosslinking reaction. Preference is given to using an aliphatic or aromatic hydrocarbon compound in which at least two hydrogen atoms are replaced either by amino groups or else by hydrazide structures (the latter being a “—C(═O)NHNH₂” structure).

Examples of such polyamine crosslinkers (ii) are:
aliphatic polyamines, preferably hexamethylenediamine, hexamethylenediamine carbamate, tetramethylenepentamine, hexamethylenediamine-cinnamaldehyde adduct or hexamethylenediamine dibenzoate;
aromatic polyamines, preferably 2,2-bis(4-(4-aminophenoxy)phenyl)propane, 4,4′-methylenedianiline, m-phenylenediamine, p-phenylenediamine or 4,4′-methylenebis(o-chloroaniline);
compounds having at least two hydrazide structures, preferably isophthalic dihydrazide, adipic dihydrazide or sebacic dihydrazide.

Particular preference is given to hexamethylenediamine and hexamethylenediamine carbamate.

The amount of the polyamine crosslinker in the vulcanizable mixture is typically in the range from 0.2 to 20 parts by weight, preferably in the range from 1 to 15 parts by weight and more preferably in the range from 1.5 to 10 parts by weight, based on 100 parts by weight of the hydrogenated nitrile rubber.

Crosslinking accelerators used in combination with the polyamine crosslinker may be any known to those skilled in the art, preferably a basic crosslinking accelerator. Usable examples include tetramethylguanidine, tetraethylguanidine, diphenylguanidine, di-o-tolylguanidine (DOTG), o-tolylbiguanidine and di-o-tolylguanidine salt of dicatecholboric acid. Additionally usable are aldehyde amine crosslinking accelerators, for example n-butylaldehydeaniline. Any crosslinking accelerator used is more preferably at least one bi- or polycyclic aminic base. These are known to those skilled in the art. The following are especially suitable: 1,8-diazabicyclo[5.4.0]undec-7-ene (DBU), 1,5-diazabicyclo[4.3.0]-5-nonene (DBN), 1,4-diazabicyclo[2.2.2]octane (DABCO), 1,5,7-triazabicyclo[4.4.0]dec-5-ene (TBD), 7-methyl-1,5,7-triazabicyclo[4.4.0]dec-5-ene (MTBD).

The amount of the crosslinking accelerator in this case is typically within a range from 0.5 to 10 parts by weight, preferably 1 to 7.5 parts by weight, especially 2 to 5 parts by weight, based on 100 parts by weight of the hydrogenated nitrite rubber.

The vulcanizable mixture based on the inventive hydrogenated nitrile rubber may in principle also contain scorch retardants, which differ between vulcanization with sulphur and with peroxides: In the case of vulcanization with sulphur, the following are used: cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

In the case of vulcanization with peroxides, scorch is retarded using compounds as specified in WO-A-97/01597 and U.S. Pat. No. 4,857,571. Preference is given to sterically hindered p-dialkylaminophenols, especially Ethanox 703 (Sartomer).

The further customary rubber additives include, for example, the typical substances known to those skilled in the art, such as fillers, filler activators, antiozonants, ageing stabilizers, antioxidants, processing aids, extender oils, plasticizers, reinforcing materials and mould release agents.

Fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes. Teflon (the latter preferably in powder form), or silicates. The fillers are typically used in amounts in the range from 5 to 350 parts by weight, preferably from 5 to 300 parts by weight, based on 100 parts by weight of the hydrogenated nitrile rubber.

Useful filler activators include organic silanes in particular, for example bis(triethoxysilylpropyl tetrasulphide), bis(triethoxysilylpropyl disulphide), vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically in the range from 0 to 10 phr, based on 100 phr of the nitrile rubber.

Examples of useful mould release agents include saturated or partly unsaturated fatty acids and oleic acids and derivatives thereof (fatty acid esters, fatty acid salts, fatty alcohols, fatty acid amides), which are preferably used as a mixture constituent, and also products applicable to the mould surface, for example products based on low molecular weight silicone compounds, products based on fluoropolymers and products based on phenol resins. The amount of mould release agents is typically in the range from 0 to 10 phr and preferably 0.5 to 5 phr, based on 100 phr of the nitrile rubber.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The mixing of the components for the purpose of producing the vulcanizable mixtures is typically effected either in an internal mixer or on a roller. Internal mixers used are typically those having what is called an intermeshing rotor geometry. At the starting point, the internal mixer is charged with the inventive nitrile rubber. This is typically in bale form and in that case is first comminuted. After a suitable period, which can be fixed by the person skilled in the art without difficulty, the additives are added, and typically, at the end, the crosslinking system. The mixing is effected under temperature control, with the proviso that the mixture remains at a temperature in the range from 100 to 150° C. for a suitable time. After a suitable mixing period, the internal mixer is vented and the shaft is cleaned. After a further period, the internal mixer is emptied to obtain the vulcanizable mixture. All the aforementioned periods are typically in the region of a few minutes and can be fixed by the person skilled in the art without difficulty as a function of the mixture to be produced. If rollers are used as mixing units, it is possible to proceed in an analogous manner and sequence in the metered addition.

The invention further provides a process for producing vulcanizates based on the inventive hydrogenated nitrile rubbers, characterized in that the vulcanizable mixtures comprising the inventive hydrogenated nitrile rubber are subjected to vulcanization. Typically, the vulcanization is effected at temperatures in the range from 100° C. to 200° C., preferably at temperatures of 120° C. to 190° C. and most preferably of 130° C. to 180° C.

The vulcanization is preferably effected in a shaping process.

For this purpose, the vulcanizable mixture is processed further by means of extruders, injection moulding systems, rollers or calenders. The preformed mass thus obtainable is typically then vulcanized to completion in presses, autoclaves, hot air systems, or in what are called automatic mat vulcanization systems, and useful temperatures have been found to be in the range from 120° C. to 200° C., preferably 140° C. to 190° C. The vulcanization time is typically 1 minute to 24 hours and preferably 2 minutes to 1 hour. Depending on the shape and size of the vulcanizates, a second vulcanization by reheating may be necessary to achieve complete vulcanization.

The invention accordingly provides the vulcanizates thus obtainable, preferably in the form of a moulding, based on the inventive hydrogenated nitrile rubbers. These vulcanizates may take the form of a drive belt, of roller coverings, of a seal, of a cap, of a stopper, of a hose, of floor covering, of sealing mats or sheets, profiles or membranes. Specifically, the vulcanizate may be an O-ring seal, a flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or parts thereof, or a pump membrane.

Surprisingly, the present invention makes it possible to obtain vulcanizates having the desired profile of properties.

### EXAMPLES

### I Analytical Methods

The methods described hereinafter were employed in the case of the examples specifically included in this application, but are equally valid as a disclosure of the appropriate methods for the general description of this application.

The quantitative determination of 2,6-d-tert-butyl-p-cresol (Vulkanox® KB) in the nitrile rubber or in the hydrogenated nitrile rubber is effected by gas chromatography using an internal standard (naphthalene). For the determination, 3 to 5 g of polymer with an accuracy of 0.01 g are dissolved in 40 ml of a toluene/THF mixture (volume ratio 1:1) with stirring in a sealable Erlenmeyer flask. 20.0 mg of naphthalene (dissolved in 5 ml of toluene) are added to the solution as an internal standard and distributed homogeneously by stirring. The polymer is precipitated by adding 80 ml of methanol. The serum is analysed by gas chromatography (Agilent Technologies in Waldbronn, Germany, instrument: 6890) with the following instrument settings:

Capillary column: HP-5, length: 30 m; internal diameter 0.32 mm; film thickness: 0.25 μm
Injection volume: 1 μl
Injection temperature: 320° C.
Oven temperature programme: 100° C., heating rate: 10° C./min>300° C.
Detector temperature: 300° C.

Under these conditions, a retention time of 3.4 min is found for 2,6-di-tert-butyl-p-cresol, and a retention time of 6.44 min for naphthalene.

In independent measurements, under the same conditions, the response ratio of 2,6-di-tert-butyl-p-cresol relative to naphthalene is determined as the basis for the calculation of the content of 2,6-di-tert-butyl-p-cresol.

The quantitative determination of 2,2-methylenebis(4-methyl-6-tert-butylphenol) (Vulkanox® BKF) in nitrile rubber is effected by gas chromatography using an internal standard (n-docosane). For the determination, 3 to 5 g of polymer with an accuracy of 0.01 g are dissolved in 40 ml of a toluene/THF mixture (volume ratio 1:1) with stirring in a sealable Erlenmeyer flask. 50.0 mg of n-docosane (dissolved in 5 ml of toluene) are added to the solution as an internal standard and distributed homogeneously by stirring. The polymer is precipitated by adding 80 ml of methanol. The serum is analysed by gas chromatography (Agilent Technologies in Waldbronn, Germany, instrument: 6890) with the following instrument settings:

Capillary column: HP-5, length: 30 m; internal diameter 0.32 mm; film thickness: 0.25 μm
Injection volume: 1 μl
Injection temperature: 320° C.
Oven temperature programme: 240° C., 10 min., heating rate: 20° C./min>300° C.
Detector temperature: 300° C.

Under these conditions, a retention time of 5.96 min is found for 2,2-methylenebis(4-methyl-6-tert-butylphenol), and a retention time of 3.70 min for n-docosane.

In independent measurements, under the same conditions, the response ratio of 2,2-methylenebis(4-methyl-6-tert-butylphenol) relative to n-docosane is determined as the basis for the calculation of the content of 2,2-methylenebis(4-methyl-6-tert-butylphenol).

The volatile fractions were determined to ISO 248, 4th edition, in the version of 15.06.2005.

The chlorobenzene contents of the hydrogenated nitrile rubber were determined after drying, by cutting 2.5 g of the hydrogenated nitrile rubber into maize kernel-sized pieces and weighing them accurately to ±1 mg into a sealable 100 ml glass vessel. The hydrogenated nitrile rubber is dissolved completely in 25 ml of acetone while shaking (about 2-3 h). A defined amount of 1,2-dichlorobenzene as an internal standard (0.25 mg dissolved in 2 ml of acetone) is added to and mixed with this solution. The polymer is coagulated by adding 40 ml of methanol. Thereafter, the vessel is made up to 100 ml with methanol.

The chlorobenzene is determined by gas chromatography (HP 5890 II) by means of a quartz capillary column and flame ionization detection. The quartz capillary column is characterized by the following features: length: 25 m; diameter: 0.32 mm, surface coverage: polydimethylsiloxane, layer thickness: 1.05 micrometres. For the determination, 5 ml of the polymer-free solution am injected into the gas chromatograph (injector temperature: 270° C.). The carrier gas used is hydrogen at a flow rate of 2 ml/min. The column temperature is increased from start temperature 60° C. at 10° C./min to 100° C. and then at 25° C./min to 310° C. The column is kept at 310° C. for 8 min. Under these conditions, retention times of 2.364 min and 5.294 min respectively are found for chlorobenzene and 1,2-dichlorobenzene. To calculate the chlorobenzene content, the area ratios of defined amounts of chlorobenzene and 1,2-dichlorobenzene are determined in independent measurements.

For determination of the gel content, 250 mg of the hydrogenated nitrile rubber were dissolved in 25 ml of methyl ethyl ketone at 25° C. while stirring for 24 h. The insoluble fraction was removed by ultracentrifugation at 20 000 rpm at 25° C., dried and determined gravimetrically. The gel content is reported in % by weight based on the starting weight. In the products produced in accordance with the invention, it is <2.5% by weight.

For the determination of the calcium content, 0.5 g of the nitrile rubbers were digested by dry ashing at 550° C. in a platinum crucible with subsequent dissolution of the ash in hydrochloric acid. After suitable dilution of the digestion solution with deionized water, the calcium content was determined by ICP-OES (inductively coupled plasma-optical emission spectroscopy) at a wavelength of 317.933 nm against calibration solutions adjusted with an acid matrix. According to the concentration of the elements in the digestion solution and/or sensitivity of the measuring instrument used, the concentrations of the sample solutions for each of the wavelengths used were fitted to the linear range of the calibration (B. Welz “Atomic Absorption Spectrometry”, 2nd Ed., Verlag Chemie, Weinheim 1985) The chlorine content of the inventive nitrile rubbers is determined based on DIN EN 14582, Method A, as follows: The nitrile rubber sample is digested in a Parr pressure vessel in a melt of sodium peroxide and potassium nitrate. Sulphite solution is added to the resultant melt, which is acidified with sulphuric acid.

In the solution obtained, the chloride formed is determined by a potentiometric titration with silver nitrate solution and calculated as chlorine.

The Mooney viscosities of the unvulcanized nitrile rubbers or of the unvulcanized hydrogenated nitrile rubbers were determined in a shearing disc viscometer to DIN 5352313 or ASTM D 1646 at 100° C. The Mooney viscosities of the dried, unaged nitrile rubbers or of the unaged hydrogenated nitrile rubbers are referred to hereinafter as MV 0.

To determine the storage stability of the unvulcanized nitrile rubbers or of the unvulcanized hydrogenated nitrile rubbers, milled sheets are stored in an air circulation drying cabinet, with an unchanged oxygen content compared to standard air in this air circulation drying cabinet, and then the Mooney viscosities are determined. The milled sheets of the unvulcanized nitrile rubbers or of the unvulcanized hydrogenated nitrile rubbers are obtained by rolling out 100 g of the corresponding rubber at room temperature on a roll mill (Schwabenthan Polymix 110) at a gap width of 0.8-1.0 mm (rotation speeds: 25 min⁻¹/30 min⁻¹). Rectangular sections (40-50 g) are cut out of the sheets and stored in an air circulation drying cabinet on aluminium dishes (10 cm/15 cm) with the base covered with Teflon film. The Mooney values determined after storage at 100° C. for 48 hours are referred to as MV 1. The Mooney values determined after storage at 100° C. for 72 hours are referred to as MV 2. The storage stabilities (SS) were determined as the difference between the Mooney values after and before hot air storage:

SS 1(48 h/100° C.)=MV 1−MV 0

SS 2(72 h/100° C.)=MV 2−MV 0

The storage stability of nitrile rubber (SS 1) is typically adequate provided that the Mooney viscosity changes by not more than 5 Mooney units in the course of storage at 100° C. for 48 hours (SS 1=MV 1−MV 0).

The storage stability of hydrogenated nitrile rubber (SS 2) is adequate provided that the Mooney viscosity changes by not more than 5 Mooney units in the course of storage at 100° C. for 72 hours (SS 2=MV 2−MV 0).

### II Example Series

A tabular overview of the examples conducted is given in Table 1. The thermal drying of the nitrile rubber and of the hydrogenated nitrile rubber was conducted in a vacuum drying cabinet, abbreviated hereinafter to “VDC”, and/or by fluidized bed drying, abbreviated hereinafter to “FB”. In Table 1, the experiments that afford inventive hydrogenated nitrile rubbers are marked “*”. In the “Molecular weight regulator” column, “LXS” represents a tert-dodecyl mercaptan (“TDM”) from Lanxess Deutschland GmbH and “CP” a tert-dodecyl mercaptan from Chevron Phillips.

The way in which Table 1 should be read is elucidated hereinafter using one case:

The nitrile rubber which has been produced via an emulsion polymerization in Example 1.6 (see Table 4) and provided with the ageing stabilizer specified is used firstly, in Example 2.6, to conduct drying of the substituted phenol-containing NBR in a vacuum drying cabinet (see Table 5) and then to hydrogenate the substituted phenol-containing NBR obtained and to dry it either, according to Example 4.5, in a vacuum drying cabinet or, according to example 5.6*, by fluidized bed drying (see Table 8).

TABLE 1
Overview of the experiments conducted

| Details of emulsion polymerization (see also Table 4) | | | | | | | Phenol- | |
|---|---|---|---|---|---|---|---|---|
| Latex | | | | | Phenol- | | containing | |
| | Molecular | | | | containing NBR | | HNBR | |
| | weight | Phenol addition | | | Method of | | Method of | |
| NBR | regulator | | Amount | Salt | drying | | drying | |
| production | TDM | Vulkanox ® | [% by | for | VDC | FB | VDC | FB |
| Example | type | type | wt.] | coagulation | Example | Example | Example | Example |
| 1.1 | LXS | KB | 0.25 | NaCl | 2.1 | — | — | — |
| 1.2 | LXS | KB | 0.40 | NaCl | 2.2 | — | — | — |
| 1.3 | LXS | KB | 0.45 | NaCl | 2.3 | — | — | — |
| 1.4 | LXS | KB | 0.5 | NaCl | 2.4 | — | — | — |
| 1.5 | LXS | KB | 0.6 | NaCl | 2.5 | — | 4.5 | 5.5* |
| 1.6 | LXS | KB | 0.7 | NaCl | 2.6 | — | 4.6 | 5.6* |
| 1.7 | LXS | KB | 0.8 | NaCl | 2.7 | 3.7 | — | 5.7* |
| 1.8 | LXS | KB | 0.90 | NaCl | 2.8 | — | — | 5.8* |
| 1.9 | LXS | KB | 1.20 | NaCl | 2.9 | 3.9 | — | — |
| 1.10 | CP | KB | 0.25 | MgCl₂ | 2.10 | — | — | — |
| 1.11 | CP | KB | 0.40 | MgCl₂ | 2.11 | — | — | — |
| 1.12 | CP | KB | 0.45 | MgCl₂ | 2.12 | — | 4.12 | 6.12* |
| 1.13 | CP | KB | 0.5 | MgCl₂ | 2.13 | — | — | — |
| 1.14 | CP | KB | 0.6 | MgCl₂ | 2.14 | — | — | — |
| 1.15 | CP | KB | 0.7 | MgCl₂ | 2.15 | — | — | — |
| 1.16 | CP | KB | 0.8 | MgCl₂ | 2.16 | 3.16 | — | 6.16* |
| 1.17 | CP | KB | 0.9 | MgCl₂ | 2.17 | — | 4.17 | — |
| 1.18 | CP | KB | 1.20 | MgCl₂ | 2.18 | 3.18 | 4.18 | — |
| 1.19 | CP | KB | 1.75 | MgCl₂ | 2.19 | — | — | — |
| 1.20 | CP | BKF | 0.8 | MgCl₂ | 2.20 | 3.20 | — | — |
| 1.21 | CP | BKF | 1.2 | MgCl₂ | 2.21 | 3.21 | — | — |

### II.1 Production of the NBR Latices A and B

On the basis of the formulations specified in Table 2 below, two NBR latices (A and B) were produced by emulsion polymerization. The two production formulations differ only in respect of the tert-dodecyl mercaptan used (Lanxess Deutschland GmbH or Chevron Phillips). All the feedstocks are specified in parts by weight based on 100 parts by weight of the monomer mixture.

TABLE 2
Feedstocks for the production of the NBR latices A and B

| | A | B |
|---|---|---|
| Batch/latex | Parts by wt. | Parts by wt. |
| butadiene | 56 | 56 |
| acrylonitrile | 44 | 44 |
| Total amount of water | 200 | 200 |
| Erkantol ® BXG¹⁾ | 2.8 | 2.8 |
| Baykanol ® PQ²⁾ | 0.84 | 0.84 |
| K salt of coconut fatty acid | 0.56 | 0.56 |
| KOH | 0.05 | 0.05 |
| t-DDM⁶⁾ | 0.44/0.44 | — |
| t-DDM⁷⁾ | — | 0.33/0.33 |
| potassium peroxodisulphate³⁾ | 0.27 | 0.27 |
| tris(α-hydroxyethyl)amine ⁴⁾ | 0.15 | 0.15 |
| Na dithionite ⁵⁾ | 1.19 | 1.19 |
| diethylhydroxylamine | 0.5 | 0.5 |
| potassium hydroxide | 1.28 | 1.28 |

¹⁾sodium salt of a mixture of mono- and disulphonated naphthalenesulphonic acids with isobutylene oligomer substituents, Erkantol ® BXG)
²⁾sodium salt of methylene bis(naphthalenesulphonate) (Baykanol ® PQ, Lanxess Deutschland GmbH)
³⁾Aldrich catalogue number: 21,622-4
⁴⁾ Aldrich catalogue number: T5,830-0
⁵⁾ Aldrich catalogue number: 15,795-3
⁶⁾tert-dodecyl mercaptan: C₁₂ mercaptan mixture (Sulfole ® 120; Chevron Phillips Chemical Co.)
⁷⁾tert-dodecyl mercaptan: C₁₂ mercaptan mixture from Lanxess Deutschland GmbH

Table 2 gives two numerical values for tert-dodecyl mercaptan. This means that the total amount of tert-dodecyl mercaptan was added in two portions. The first portion of tert-dodecyl mercaptan was initially charged before commencement of polymerization, while the remaining amount was metered in at a polymerization conversion of 15%.

The NBR latices A and B were each produced batchwise in a 2 m³ stirred autoclave. In each of the batches, 350 kg of the monomer mixture and a total amount of water of 700 kg were used. The autoclave was initially charged with the emulsifiers Erkantol® BXG (9.8 kg), Baykanol® PQ (2.94 kg) and the potassium salt of coconut fatty acid (1.96 kg) in 600 kg of this amount of water together with 180 g of potassium hydroxide, and purged with a nitrogen stream. After the nitrogen purging had ended, the destabilized monomers (196 kg of butadiene and 154 kg of acrylonitrile) and portions of the tert-dodecyl mercaptan (1.54 kg in batch A and 1.16 kg in batch B) were added to the reactor. Thereafter, the reactor was closed. The remaining amount of water (100 kg) was used for the production of the aqueous solutions of tris(α-hydroxyethyl)amine, potassium peroxodisulphate and the stopper solutions. By addition of aqueous solutions of 950 g of potassium peroxodisulphate (corresponding to the 0.27 part by weight according to Table 1) and 530 g of tris(α-hydroxyethyl)amine (corresponding to the 0.15 part by weight according to Table 1), the polymerization was started at 20° C. and kept at this temperature over the entire duration. The course of the polymerization was monitored in each case by gravimetric determinations of conversion. At polymerization conversions of 15%, according to Table 1, a further 1.54 kg of tert-dodecyl mercaptan from Lanxess (batch A) or a further 1.16 kg of tert-dodecyl mercaptan from Chevron Phillips (batch B), corresponding to 0.44 and 0.33 part by weight respectively, were metered in. After a polymerization time of 7 h, the polymerization was stopped by adding an aqueous solution of sodium dithionite/N,N-diethylhydroxylamine (DEHA) and potassium hydroxide. The polymerization conversions were 75% (latex A) and 76% (latex B). Unconverted monomers and other volatile constituents were removed by means of steam distillation.

The characteristic data for the latices obtained in this way are summarized in Table 3 below.

TABLE 3
Characteristic data for the NBR latices A and B

| Latex | A | B |
|---|---|---|
| Solids content [% by wt.] | 23.5 | 21.5 |
| pH | 10.8 | 11.0 |
| Acrylonitrile content [% by wt.] | 38.8 | 38.6% |

### II.2 Workup of the NBR Latices A and B

Before the coagulation, the NBR latices A and B were admixed with different amounts of 4-methyl-2,6-test-butylphenol (Vulkanox® KB from Lanxess Deutschland GmbH; inventive structure) or 2,2-methylenebis(4-methyl-6-tert-butylphenol) (Vulkanox® BKF from Lanxess Deutschland GmbH, noninventive phenolic ageing stabilizer) in accordance with Table 3. For this purpose, 50% dispersions of Vulkanox® KB or Vulkanox® BKF in water were used.

The aqueous dispersions of Vulkanox® KB or of Vulkanox® BKF were based on the following formulation, prepared at 95 to 98° C. with the aid of an Ultraturrax:

| | |
|---|---|
| 360 g | deionized water (DW water) |
| 40 g | alkylphenol polyglycol ether (NP ® 10 emulsifier from Lanxess |
| | Deutschland GmbH) |
| 400 g | Vulkanox ® KB or Vulkanox ® BKF from Lanxess Deutschland |
| | GmbH |

The additions of Vulkanox® KB or of Vulkanox® BKF were based on the solids present in the latex and are reported in % by weight.

Before the coagulation of the latices containing Vulkanox® KB or Vulkanox® BKF, the solids content of the latices was adjusted to 20% by weight in each case by addition of the appropriate amount of deionized water.

For the coagulation of the NBR latices, aqueous solutions of sodium chloride and magnesium chloride were used. The aqueous sodium chloride solution was a 20% solution, and normal service water (not deionized and hence containing calcium ions) was used for the production. The aqueous magnesium chloride solution was a 26% solution, and normal service water (not deionized and hence containing calcium ions) was used for the production.

The concentrations of the salt solutions and the amounts of salts used for the precipitation were each calculated without water of crystallization and are based on the solids present in the latex.

The ageing stabilizers used for the stabilization of the nitrile rubbers, and the amounts thereof, the salts used for latex coagulation, the concentration of the salt solutions, the amounts of salts used based on the NBR rubber, the coagulation temperature, the washing temperature and the duration of the washing are summarized in tabular form in Table 4.

TABLE 4
Additions of Vulkanox ® KB or BKF and workup of the NBR latices A and B (“SW”
means service water)

| | | | | | | Amount | | | | |
|---|---|---|---|---|---|---|---|---|---|---|
| | | | | | Concentration | of salt | | | | |
| | | | | | of the | based | | | | |
| | | Vulkanox ® | | | salt | on | | Wash conditions | | |
| | | | Amount | Salt | solution | NBR | Coagulation | Type | | |
| Polymerization | | | [% by | for | [% by | [% by | temperature | of | T | Time |
| Example | Latex | Type | wt.] | coagulation | wt.] | wt.] | [° C.] | water | [° C.] | [h] |
| 1.1 | A | KB | 0.25 | NaCl | 20 | 13.2 | 60 | SW | 60 | 8.0 |
| 1.2 | A | KB | 0.40 | NaCl | 20 | 13.2 | 60 | SW | 60 | 8.0 |
| 1.3 | A | KB | 0.45 | NaCl | 20 | 13.2 | 60 | SW | 60 | 8.0 |
| 1.4 | A | KB | 0.5 | NaCl | 20 | 13.2 | 60 | SW | 60 | 8.0 |
| 1.5 | A | KB | 0.6 | NaCl | 20 | 13.2 | 60 | SW | 60 | 8.0 |
| 1.6 | A | KB | 0.7 | NaCl | 20 | 13.2 | 60 | SW | 60 | 8.0 |
| 1.7 | A | KB | 0.8 | NaCl | 20 | 13.2 | 60 | SW | 60 | 8.0 |
| 1.8 | A | KB | 0.90 | NaCl | 20 | 13.2 | 60 | SW | 60 | 8.0 |
| 1.9 | A | KB | 1.20 | NaCl | 20 | 13.2 | 60 | SW | 60 | 8.0 |
| 1.10 | B | KB | 0.25 | MgCl₂ | 26 | 2.37 | 60 | SW | 60 | 5.0 |
| 1.11 | B | KB | 0.40 | MgCl₂ | 26 | 2.37 | 60 | SW | 60 | 8.0 |
| 1.12 | B | KB | 0.45 | MgCl₂ | 26 | 2.37 | 60 | SW | 60 | 5.0 |
| 1.13 | B | KB | 0.5 | MgCl₂ | 26 | 2.37 | 60 | SW | 60 | 5.0 |
| 1.14 | B | KB | 0.6 | MgCl₂ | 26 | 2.37 | 60 | SW | 60 | 5.0 |
| 1.15 | B | KB | 0.7 | MgCl₂ | 26 | 2.37 | 60 | SW | 60 | 5.0 |
| 1.16 | B | KB | 0.8 | MgCl₂ | 26 | 2.37 | 60 | SW | 60 | 8.0 |
| 1.17 | B | KB | 0.9 | MgCl₂ | 26 | 2.37 | 60 | SW | 60 | 5.0 |
| 1.18 | B | KB | 1.20 | MgCl₂ | 26 | 2.37 | 60 | SW | 60 | 8.0 |
| 1.19 | B | KB | 1.75 | MgCl₂ | 26 | 2.37 | 60 | SW | 60 | 8.0 |
| 1.20 | B | BKF | 0.8 | MgCl₂ | 26 | 2.37 | 60 | SW | 60 | 8.0 |
| 1.21 | B | BKF | 1.2 | MgCl₂ | 26 | 2.37 | 60 | SW | 60 | 8.0 |

The workup of the NBR latices was effected batchwise in a stirrable, open vessel of capacity 200 l, which had an inlet and outlet. The outlet could be shut off by means of a screen (mesh size 2 mm) via two lateral rails, such that the rubber crumbs obtained in the latex coagulation were not washed out in the washing operation.

For the coagulation, an amount of latex that was calculated such that 25 kg of solids were obtained in each case at 100% yield was used. The latex was initially charged in the coagulation vessel, heated to 60° C. and coagulated by gradual addition of aqueous salt solution while stirring. On completion of the latex coagulation, the rubber crumbs were washed by dilution washing without prior removal of the serum. For the crumb washing, normal calcium ion-containing tap water (“SW”) heated to 60° C. was used, with constant throughput of wash water (200 l/h).

After the washing had ended, the rubber crumbs were removed with a screen, and subjected to preliminary dewatering to residual moisture contents of 15 to 25% by weight in a welding screw. The subsequent thermal drying of the nitrile rubbers summarized in Table 5 was effected batchwise in a vacuum drying cabinet at 70° C. to a residual moisture content of <1.0% by weight.

The nitrile rubbers obtained in this way were characterized analytically by determining the contents of 4-methyl-2,6-tert-butylphenol, 2,2-methylenebis(4-methyl-6-tert-butylphenol), calcium and chlorine, and by their storage stability (SS 1) (Table 5).

Table 5 shows that the amounts of 4-methyl-2,6-tert-butylphenol and 2,2-methylenebis(4-methyl-6-tert-butylphenol) added to the latices, in the case of drying in a vacuum drying cabinet, are recovered with a recovery rate of 92 to 103% in the worked-up and dried nitrile rubber; thus, under the selected drying conditions, less than 10% of the amounts of 4-methyl-2,6-tert-butylphenol and 2,2-methylenebis(4-methyl-6-tert-butylphenol) used is lost.

TABLE 5
Properties of the unvulcanized nitrile rubbers (drying in a VDC)

| | | Addition of | | | Vulkanox ® type | | | | | | |
|---|---|---|---|---|---|---|---|---|---|---|---|
| | | Vulkanox ® | | | in the NBR | | | | | | |
| Stab. | | | Amount | Salt | Content | | Ca | Chlorine | ML1 + 4@100° C. | | |
| NBR | NBR | | % by | for | % by | Recovery | Content | content | MV 0 | MV 1 | SS 1 |
| Example | latex | Type | wt. | coagulation | wt. | rate % | ppm | ppm | MU | MU | MU |
| 2.1 | A | KB | 0.25 | NaCl | 0.25 | 100 | 500 | 360 | 48 | 69 | 21 |
| 2.2 | A | KB | 0.40 | NaCl | 0.39 | 98 | — | — | 48 | 65 | 17 |
| 2.3 | A | KB | 0.45 | NaCl | 0.43 | 96 | 595 | 590 | 47 | 57 | 10 |
| 2.4 | A | KB | 0.5 | NaCl | 0.49 | 98 | — | — | 46 | 52 | 6 |
| 2.5 | A | KB | 0.6 | NaCl | 0.57 | 95 | 490 | 440 | 45 | 58 | 3 |
| 2.6 | A | KB | 0.7 | NaCl | 0.66 | 94 | — | — | 46 | 48 | 2 |
| 2.7 | A | KB | 0.8 | NaCl | 0.76 | 95 | — | — | 46 | 47 | 1 |
| 2.8 | A | KB | 0.90 | NaCl | 0.91 | 101 | 540 | 450 | 47 | 48 | 1 |
| 2.9 | A | KB | 1.20 | NaCl | 1.16 | 97 | 370 | 390 | 46 | 48 | 2 |
| 2.10 | B | KB | 0.25 | MgCl₂ | 0.23 | 92 | 320 | 265 | 48 | 70 | 22 |
| 2.11 | B | KB | 0.40 | MgCl₂ | 0.40 | 100 | 285 | 195 | 48 | 56 | 8 |
| 2.12 | B | KB | 0.45 | MgCl₂ | 0.45 | 100 | 325 | 215 | 49 | 55 | 6 |
| 2.13 | B | KB | 0.5 | MgCl₂ | 0.5 | 100 | — | — | 49 | 52 | 3 |
| 2.14 | B | KB | 0.6 | MgCl₂ | 0.57 | 95 | 380 | 210 | 48 | 48 | 0 |
| 2.15 | B | KB | 0.7 | MgCl₂ | 0.66 | 94 | — | — | — | — | — |
| 2.16 | B | KB | 0.8 | MgCl₂ | 0.82 | 103 | 320 | 185 | 46 | 48 | 2 |
| 2.17 | B | KB | 0.9 | MgCl₂ | 0.90 | 100 | 360 | 285 | 47 | 48 | 1 |
| 2.18 | B | KB | 1.20 | MgCl₂ | 1.20 | 100 | 310 | 230 | 46 | 48 | 2 |
| 2.19 | B | KB | 1.50 | MgCl₂ | 1.49 | 99 | 370 | 215 | 45 | 46 | 2 |
| 2.20 | B | BKF | 0.8 | MgCl₂ | 0.80 | 100 | 355 | 190 | 46 | 47 | 1 |
| 2.21 | B | BKF | 1.2 | MgCl₂ | 1.19 | 99 | 375 | 215 | 46 | 46 | 0 |

In Table 5, it is also shown that the nitrile rubber has an adequate storage stability SS 1 (increase in the Mooney viscosity after storage at 100° C. for 48 hours<5 Mooney units) when the 4-methyl-2,6-tert-butylphenol content detectable analytically in the nitrile rubber is in the range from 0.5 to 1.49% by weight.

In a further experiment series, selected nitrile rubbers, after mechanical dewatering and comminution, were dried thermally to residual moisture contents <1% by weight by means of fluidized bed drying. For this purpose, a fluidized bed dryer (TG 200 high-speed dryer) from Kurt Retsch (Haan/Düsseldorf), which was equipped with a drying vessel of capacity 6 l, was used. For the drying operation, 0.5 kg of the moist nitrile rubber was used in each case. The flow rate of the hot air was kept constant at 100 m³/h in all the experiments. The temperature and the residence times in the fluidized bed drying were varied (Table 6).

TABLE 6
Properties of the nitrile rubbers A (fluidized bed drying)

| | | | | Conditions in the | | | | | | | |
|---|---|---|---|---|---|---|---|---|---|---|---|
| | | | | fluidized bed drying | | | | | | | |
| | | | | Residual | | | | | | | |
| | | Addition of | | moisture | | | Phenol | | | | |
| | | Vulkanox ® | | content | | | in NBR | | | | |
| | | type | | (before | | | content | | ML1 + 4@100° C. | | |
| | NBR | | Amount | drying) | T | Time | % by | Recovery | MV 0 | MV 1 | SS 1 |
| Example | Latex | Type | % by wt. | % by wt. | ° C. | min | wt. | rate % | MU | MU | MU |
| 3.7 | A | KB | 0.80 | 15 | 125 | 7 | 0.40 | 50 | 46 | 60 | 14 |
| 3.9 | A | KB | 1.20 | 25 | 130 | 5 | 0.54 | 45 | 46 | 47 | 1 |
| 3.16 | B | KB | 0.80 | 18 | 125 | 6 | 0.42 | 53 | 46 | 52 | 7 |
| 3.18 | B | KB | 1.20 | 23 | 110 | 10 | 0.50 | 42 | 47 | 48 | 1 |
| 3.20 | B | BKF | 0.80 | 21 | 120 | 5 | 0.79 | 99 | 48 | 49 | 1 |
| 3.21 | B | BKF | 1.20 | 23 | 130 | 5 | 1.19 | 99 | 46 | 46 | 0 |

Table 6 shows that drying over the fluidized bed, when 4-methyl-2,6-tert-butylphenol is used as an inventive phenolic ageing stabilizer, causes a reduction to 42 to 53%, meaning that 47 to 58% of the amounts of 4-methyl-2,6-tert-butylphenol used is lost when fluidized bed drying is employed under the selected conditions. The loss of 2,2-methylenebis(4-methyl-6-tert-butylphenol) under the same workup and drying conditions is only about 1% by weight.

### II.3 Production of Hydrogenated Nitrile Rubbers

### II.3.1 Hydrogenation

An overview of the production conditions for the nitrile rubbers used for the hydrogenation and of the designation of the noninventive and inventive hydrogenated nitrile rubbers obtained after the hydrogenation is given by Table 1. For the hydrogenation, exclusively nitrile rubbers which have been dried thermally in a vacuum drying cabinet were used.

The hydrogenations were conducted at a hydrogen pressure of 190 bar at a temperature of 120° C. to 130° C. and solids concentrations of 17.5% by weight, using 0.15% by weight of tris(triphenylphosphine)rhodium(l) chloride (Evonik-Degussa) based on 100 g of nitrile rubber (phr) as catalyst and 0.2 phr triphenylphosphine (Merck Schuchardt OHG; Cat. No. 8.08270) as cocatalyst in all the hydrogenations.

In each of the hydrogenations, 5.25 kg of nitrile rubber were dissolved in 24.25 kg of chlorobenzene in a 40 l autoclave. Before the hydrogenation, the polymer solution was successively contacted once with nitrogen (20 bar) and twice with hydrogen (20 bar) while stirring, and then decompressed. The reaction mixture was heated to 120° C. and contacted with 190 bar hydrogen. In the next step, 10.5 g of triphenylphospine cocatalyst were metered in as a solution in 250 g of chlorobenzene. The hydrogenation was started by adding 7.875 g of tris(tripbheylphosphine)rhodium(I) chloride, dissolved in 250 g of chlorobenzene. With declining reaction, the internal temperature was increased gradually to 130° C. The course of the hydrogenation was effected online by determining the hydrogen absorption. The hydrogenation was stopped at hydrogenation levels of 99.4±0.2%, by cooling the reaction mixture. Subsequently, the batches were decompressed. Residual amounts of hydrogen were removed by passing nitrogen through. The exact hydrogenation levels were determined after the hydrogenation had ended by the methods described in Kautschuk+Gummi. Kunststoffe, vol. 42 (1989), no. 2, 107-110 and Kautschuk+Gummi. Kunststoffe, vol. 42 (1989), no. 3, 194-197.

A removal of rhodium was effected according to U.S. Pat. No. 4,985,540 in Examples 6.12* and 6.16*. For this purpose, the polymer solutions were diluted to a solids concentration of 5.0% before the recovery of rhodium.

II.3.2 Isolation of the Hydrogenated Nitrile Rubbers from the Chlorobenzene Solution

The isolation of the hydrogenated nitrile rubbers from chlorobenzene solution was effected batchwise at atmospheric pressure by steam distillation. For this purpose, a stirrable 20 l glass flange vessel with jacket heating was used. Steam was fed in via a base valve. In addition, the 20 l flange vessel had devices for continuous metered addition of an HNBR solution in chlorobenzene, of a 2% aqueous solution of a water-soluble polymer containing carboxyl groups (Orotan®, from Rohm and Haas), of a 2% aqueous calcium chloride solution and of dilute sodium hydroxide solution (0.5%).

In the examples where no removal of rhodium was effected, the chlorobenzene solutions of the hydrogenated nitrile rubbers were diluted to a solids concentration of 10% by weight. The concentration of the chlorobenzene solutions of the products 6.12* and 6.16* (with removal of rhodium) was 5% by weight. In all the examples, the chlorobenzene solutions were heated to 95-100° C. before being fed into the 20 l flange vessel.

By adding the sodium hydroxide solution, the pH of the aqueous phase was kept within a pH range from 7.7 to 8.3 over the entire distillation process.

The 20 l flange vessel was initially charged with 8 l of deionized water and heated to 98-100° C. by jacket heating, before steam was introduced. Then the metered addition of the chlorobenzene solution of the hydrogenated nitrile rubber (0.5 kg of HNBR solids/h) and of the aqueous solution of Orotan® and calcium chloride was commenced at a stirrer speed of 2000 rpm. The rates of metered addition of Orotan® and calcium chloride were adjusted such that 0.3 part by weight of Orotan® and 0.15 part by weight of calcium chloride, based in each case on 100 parts by weight of the amount of hydrogenated nitrile rubber present in the stripping vessel, were present at any time. The steam distillation was effected at atmospheric pressure at 98-100° C. The vapours of chlorobenzene and steam distilled off were condensed and collected.

The metered addition of HNBR solution was ended as soon as 1.5 kg of HNBR were present in the stripping vessel in each case. Thereafter, the steam distillation was continued for another 0.5 h. The hydrogenated nitrile rubber was present in the aqueous dispersion in the form of rubber crumbs in the diameter range of 3 to 10 mm. After the flange vessel had been opened, the rubber crumbs were removed by means of a screen. The remaining water was removed by drip-drying and by squeezing.

The noninventive thermal drying of the hydrogenated nitrile rubbers was effected in a vacuum drying cabinet at 70° C. with introduction of air at 23′C to constant weight.

The thermal drying of the hydrogenated nitril rubbers was effected by fluidized bed drying under the conditions specified in Table 8.

Using the dried HNBR samples, the contents of volatile fractions, the content of 2,6-di-tert-butyl-p-cresol, the chlorobenzene content, the gel content and the storage stability were determined, and the loss of 2,6-di-tert-butyl-p-cresol was calculated.

### II.3.3 Properties of the Unvulcanized Hydrogenated Nitrile Rubbers (HNBR)

The properties of the noninventive unvulcanized hydrogenated nitrile rubbers are summarized in Table 7.

TABLE 7
Characteristic properties of the noninventive unvulcanized hydrogenated nitrile
rubbers

| | | Example | | | | |
|---|---|---|---|---|---|---|
| | | 4.5 | 4.6 | 4.12 | 4.17 | 4.18 |
| NBR used for hydrogenation from Example | | 2.5 | 2.6 | 2.12 | 2.17 | 2.18 |
| 2,6-Di-tert-butyl-p-cresol in NBR | % by wt. | 0.57 | 0.66 | 0.45 | 0.90 | 1.20 |
| 2,6-Di-tert-butyl-p-cresol in HNBR | % by wt. | 0.55 | 0.65 | 0.45 | 0.85 | 1.15 |
| Recovery rate of | % | 96 | 98 | 100 | 94 | 96 |
| di-tert-butyl-p-cresol in HNBR | | | | | | |
| Loss of 2,6-di-tert-butyl-p-cresol | % | 4 | 2 | 0 | 6 | 4 |
| Chlorobenzene content | ppm | 106 | <50 | 94 | <50 | 63 |
| Volatile fractions | % by wt. | 0.3 | 0.1 | 0.2 | 0.2 | 0.3 |
| Gel content in MEK | % by wt. | 1.20 | 0.81 | 0.73 | 0.84 | 1.16 |
| MV 0 | MU | 84 | 83 | 84 | 83 | 83 |
| MV 2 | MU | 84 | 84 | 87 | 84 | 84 |
| Storage stability SS 2 (MV 2 − MV 0) | MU | 0 | +1 | +3 | +1 | +1 |

In Table 7, it is shown that the losses of 2,6-di-tert-butyl-p-cresol in the case of drying in a vacuum drying cabinet are between 0 and 6%. The noninventive hydrogenated nitrile rubbers obtained in this way had adequate storage stability in the case of 2,6-di-tert-butyl-p-cresol contents in the range of 0.45 to 1.15% by weight after storage at 100° C. for 3 days (SS 2). The contents of volatile fractions are in the range from 0.1 to 0.3% by weight, chlorobenzene contents are in the range of <50 to 106 ppm, and the gel contents in the range of 0.73-1.20% by weight.

The inventive drying of the hydrogenated nitrile rubbers was effected in a fluidized bed dryer (TG 200 high-speed dryer) from Kurt Retsch (Haan/Düsseldorf). The vessel had a capacity of 6 l, which was charged in each case with 0.5 kg of the rubber crumbs. The flow rate of the hot air was kept constant at 100 m³/h in all the experiments. The temperature and the residence times in the fluidized bed drying were varied (Table 8).

The rubber crumbs worked up by fluidized bed drying in accordance with the invention have the properties summarized in Table 8.

TABLE 8
Conditions in the fluidized bed drying and properties of the inventive unvulcanized
hydrogenated nitrile rubbers obtained therein (indicated in each case by “*”)

| | | Examples | | | | | |
|---|---|---|---|---|---|---|---|
| | | 5.5* | 5.6* | 5.7* | 5.8* | 6.12* | 6.16* |
| Drying temperature in fluidized bed | ° C. | 120 | 110 | 130 | 140 | 120 | 150 |
| Residence time | min. | 4 | 12 | 3 | 8 | 3 | 3 |
| NBR used for hydrogenation from | | 2.5 | 2.6 | 2.7 | 2.8 | 2.12 | 2.16 |
| Example | | | | | | | |
| 2,6-Di-tert-butyl-p-cresol in NBR | % by wt. | 0.57 | 0.66 | 0.76 | 0.91 | 0.45 | 0.82 |
| 2,6-Di-tert-butyl-p-cresol in HNBR | % by wt. | 0.31 | 0.24 | 0.40 | 0.23 | 0.31 | 0.16 |
| Recovery rate of | % | 54 | 36 | 53 | 25 | 69 | 20 |
| di-tert-butyl-p-cresol in HNBR | | | | | | | |
| Loss of di-tert-butyl-p-cresol | % | 46 | 64 | 47 | 75 | 31 | 80 |
| Chlorobenzene content | ppm | <50 | <50 | <50 | <50 | 175 | <50 |
| Volatile fractions | % by wt. | 0.1 | 0.1 | 0.3 | 0.2 | 0.1 | 0.2 |
| Gel content in MEK | % by wt. | 1.47 | 0.90 | 0.80 | 0.78 | 0.96 | 0.96 |
| MV 0 | MU | 84 | 84 | 84 | 85 | 84 | 85 |
| MV 2 | MU | 85 | 86 | 85 | 86 | 86 | 87 |
| Storage stability SS 2 (MV 2 − MV 0) | MU | +1 | +3 | +1 | +1 | +2 | +2 |

Table 8 shows that, in the case of fluidized bed drying of hydrogenated nitrile rubber, the recovery rates for 2,6-di-tert-butyl-p-cresol are in the range of 20-69%; correspondingly, the losses of 2,6-di-tert-butyl-p-cresol were 31-80%. The inventive hydrogenated nitrile rubbers obtained had 2,6-di-tert-butyl-p-cresol contents in the range of 0.16 to 0.4% by weight. The contents of volatile fractions are in the range from 0.1 to 0.3% by weight, chlorobenzene contents are in the range of <50 to 175 ppm, and the gel contents in the range of 0.78 to 1.47% by weight. The inventive hydrogenated nitrile rubbers are storage-stable after storage at 100° C. for 3 days (SS 2).

### II.4 Production, Composition and Characterization of Vulcanizable Mixtures Based on Hydrogenated Nitrile Rubbers (HNBR)

To assess the vulcanizate properties of the hydrogenated nitrile rubbers, rubber mixtures having the composition specified in Table 9 were produced in an internal mixer of capacity 1.5 l (GK 1,5 from Werner & Pfleiderer, Stuttgart) which had been preheated to 50° C. and had intermeshing kneading elements (PS 5A paddle geometry). The mixture constituents were added in accordance with the sequence specified in Table 9 (except for component 8, “Peroxide”). The peroxide was mixed in in a 2nd mixing step on a cooled roller at a milled sheet temperature <50° C.

TABLE 9
Composition or the vulcanizable mixtures

| | | Amount |
|---|---|---|
| | Commercial product | [parts by |
| Mixture constituent | (manufacturer) | wt.] |
| Hydrogenated nitrile rubber | | 100 |
| zinc oxide | Zinc oxide active | 2.0 |
| | (Lanxess Deutschland GmbH) | |
| magnesium oxide | Maglite ® DE (Merck & Co. Inc. USA) | 2.0 |
| octylated diphenylamine | OCD stabilizer | 1.0 |
| | (Lanxess Deutschland GmbH) | |
| zinc salt of 2-mercaptobenzimidazole | Vulkanox ® ZMB-2 | 0.4 |
| | (Lanxess Deutschland GmbH) | |
| carbon black | Corax ® N 550 (Degussa) | 45.0 |
| triallyl isocyanurate | Kettlitz TAIC 50 | 3.0 |
| | (Kettlitz Chemie GmbH & Co. KG) | |
| bis(tert-butylperoxyisopropyl)benzene | Perkadox ® 14-40 K-PD | 7 |
| (40%) | (Akzo-Nobel Chemicals GmbH) | |

To assess the processing characteristics of the rubber mixtures, the Mooney viscosities at 100° C. (ML1+4/100° C.) and at 120° C. (ML1+4/120° C.) were determined on the unvulcanized rubber mixtures to ASTM D11646 (Tables 10, 11 and 12).

### Vulcanization and Vulcanizate Properties:

The specimens needed for the vulcanizate characterization were obtained by press vulcanization of the mixtures at 180° C./18 min. under a hydraulic pressure of 120 bar. Before being characterized, the specimens after the vulcanization were stored under air in a heated cabinet at 150° C. for 17 h.

Using the vulcanizates, the following properties were determined on the basis of the following standards:
DIN 53505: Shore A hardness at 23° C. and 70° C.
DIN 53504: Stress values at 50% elongation (σ₅₀), 100% elongation (σ₁₀₀), 200% elongation (σ₂₀₀) and 300% elongation (σ₃₀₀); tensile stress and elongation at break (ε_{b})
DIN 53512: Resilience at 23° C. and 70° C.
DIN 53517: Compression Set (CS); determination at 23° C. after storage of a cylindrical specimen compressed by 25% (original dimensions: height: 6.3 mm; diameter: 13 mm) at 70 h/23° C. or 70 h/150° C.

TABLE 10
Vulcanizate properties of the noninventive hydrogenated nitrile rubbers

| | | Noninventive examples | | | | |
|---|---|---|---|---|---|---|
| | | 4.5 | 4.6 | 4.12 | 4.17 | 4.18 |
| 2,6-Di-tert-butyl-p-cresol in HNBR | % by wt. | 0.55 | 0.65 | 0.45 | 0.85 | 1.15 |

Unvulcanized rubber mixtures

| | | | | | | |
|---|---|---|---|---|---|---|
| Compound viscosity (ML1 + 4/100° C.) | MU | 117 | 120 | 119 | 121 | 120 |
| Compound viscosity (ML1 + 4/120° C.) | MU | 84 | 87 | 85 | 87 | 86 |

Vulcanizate properties

| | | | | | | |
|---|---|---|---|---|---|---|
| Shore A hardness (23° C.) | | 72 | 72 | 73 | 70 | 69 |
| Shore A hardness (70° C.) | | 70 | 69 | 71 | 70 | 68 |
| Resilience at 23° C. | % | 28 | 27 | 27 | 27 | 26 |
| Resilience at 70° C. | % | 53 | 54 | 53 | 53 | 52 |
| σ₅₀ | MPa | 2.3 | 2.2 | 2.4 | 2.2 | 2.5 |
| σ₁₀₀ | MPa | 5.7 | 5.3 | 6.0 | 5.2 | 4.6 |
| σ₂₀₀ | MPa | 16.8 | 15.6 | 17.5 | 14.8 | 12.5 |
| σ₃₀₀ | MPa | 25.5 | 23.7 | 26.1 | 22.8 | 20 |
| Tensile strength | MPa | 28.0 | 27.9 | 29.1 | 28.0 | 28.1 |
| Elongation at break ε_{b} | % | 345 | 380 | 355 | 420 | 500 |
| Compression set (70 h/150° C.) | % | 37.6 | 41.2 | 36 | 44.5 | 53.5 |

Table 10 shows that the vulcanizates of the noninventive hydrogenated nitrile rubbers having 2,6-di-tert-butyl-p-cresol contents in the range of 0.45-1.15% by weight have a low level of the modulus values (σ₂₀₀≦17.5 MPa and σ₃₀₀≦26.1 MPa) and poorer compression set values>35%. In addition, Table 10 shows that both the modulus level and compression set deteriorate with increasing 2,6-di-tert-butyl-p-cresol content.

TABLE 11
Vulcanizate properties of the inventive hydrogenated nitrile rubbers (indicated by
“*”)

| | | Inventive examples | | | | | |
|---|---|---|---|---|---|---|---|
| | | 5.5* | 5.6* | 5.7* | 5.8* | 6.12* | 6.16* |
| 2,6-Di-tert-butyl-p-cresol in HNBR | % by | 0.31 | 0.24 | 0.40 | 0.23 | 0.31 | 0.16 |
| | wt. | | | | | | |

Unvulcanized rubber mixtures

| | | | | | | | |
|---|---|---|---|---|---|---|---|
| Compound viscosity (ML1 + 4/100° C.) | MU | 118 | 121 | 119 | 121 | 121 | 120 |
| Compound viscosity (ML1 + 4/120° C.) | MU | 85 | 87 | 86 | 87 | 87 | 86 |

Vulcanizate properties

| | | | | | | | |
|---|---|---|---|---|---|---|---|
| Shore A hardness (23° C.) | | 72 | 72 | 73 | 72 | 72 | 73 |
| Shore A hardness (70° C.) | | 69 | 69 | 69 | 69 | 69 | 70 |
| Resilience at 23° C. | % | 28 | 28 | 27 | 28 | 28 | 28 |
| Resilience at 70° C. | % | 54 | 55 | 53 | 55 | 55 | 53 |
| σ₅₀ | MPa | 2.2 | 2.1 | 2.1 | 2.3 | 2.4 | 2.3 |
| σ₁₀₀ | MPa | 5.8 | 5.7 | 5.7 | 5.9 | 6.1 | 5.8 |
| σ₂₀₀ | MPa | 18.9 | 18.9 | 18.0 | 19.8 | 19.0 | 19.7 |
| σ₃₀₀ | MPa | 28.6 | 27.9 | 27 | 28.8 | 27.9 | 28.8 |
| Tensile strength | MPa | 29.4 | 29.5 | 29.2 | 30.1 | 29.3 | 29.4 |
| Elongation at break ε_{b} | % | 315 | 335 | 340 | 325 | 330 | 310 |
| Compression set (70 h/150° C.) | % | 31.7 | 30.7 | 34 | 29.5 | 30.8 | 28.5 |

Table 11 shows that, on the basis of the inventive hydrogenated nitrile rubbers having 2,6-di-tert-butyl-p-cresol contents in the range of 0.16-0.40% by weight, vulcanizates having better properties than the noninventive examples of Table 10 are obtained. Specifically, the following were found: σ₂₀₀>18.0 MPa and σ₃₀₀>27.0 MPa, and lower, better compression set values≦34%.

In the series below (Table 12), Vulkanox® KB was added to the hydrogenated nitrile rubber 5.5* produced in accordance with the invention prior to vulcanization, in the mixture production, in amounts of 0.5 and 1.0 phr, and the influence of these additions on the vulcanizate properties was determined. The conditions in the mixture production, in the vulcanization and vulcanizate testing were identical to the conditions described above.

In the experiments in Table 12, it is shown that addition of 2,6-di-tert-butyl-p-cresol worsens the vulcanizate properties (modulus level and compression set) of hydrogenated nitrile rubber.

TABLE 12
Influence of Vulkanox ® KB additions on the vulcanizate properties of
hydrogenated nitrile rubber

| Examples | | 6.5* | 6.6 | 6.7 |
|---|---|---|---|---|
| Addition of 2,6-di-tert-butyl-p-cresol | % by wt. | 0 | 0.5 | 1.0 |

Vulcanizate properties

| | | | | |
|---|---|---|---|---|
| Shore A hardness (23° C.) | | 72 | 71 | 70 |
| Shore A hardness (70° C.) | | 69 | 69 | 67 |
| Resilience at 23° C. | % | 28 | 34 | 34 |
| Resilience at 70° C. | % | 54 | 55 | 55 |
| σ ₅₀ | MPa | 2.2 | 2.2 | 2.0 |
| σ ₁₀₀ | MPa | 5.8 | 5.3 | 4.7 |
| σ ₂₀₀ | MPa | 18.9 | 18.0 | 16.2 |
| σ ₃₀₀ | MPa | 28.6 | 27.6 | 25.3 |
| Tensile strength | MPa | 29.4 | 28.7 | 29.1 |
| Elongation at break ε_{b} | % | 315 | 331 | 364 |
| Compression set (70 h/150° C.) | % | 31.7 | 36.2 | 40.6 |

1. Hydrogenated nitrile rubber comprising 0.01 wt % to less than 0.45 wt % of at least one substituted phenol of the general formula (I) based in each case on the hydrogenated nitrile rubber, 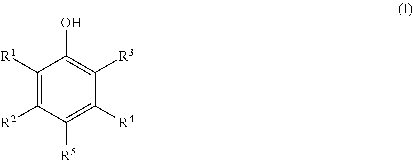
in which
R¹, R², R³, R⁴ and R⁵ are the same or different and are each hydrogen, hydroxyl, a linear, branched, cyclic or aromatic hydrocarbyl radical having 1 to 8 carbon atoms and additionally one, two or three heteroatoms, where at least one of the R¹, R², R³, R⁴ and R⁵ radicals is not hydrogen.

2. The hydrogenated nitrile rubber according to claim 1, wherein:
R¹, R², R³, R⁴ and R⁵ are the same or different and are each hydrogen, hydroxyl, a linear or branched C₁-C₈ alkyl radical, a linear or branched C₁-C₈ alkoxy radical, a C₃-C₈ cycloalkyl radical, or a phenyl radical, where at least one of the R¹, R², R³, R⁴ and R⁵ radicals is not hydrogen.

3. The hydrogenated nitrile rubber according to claim 2, wherein:
two or three of the R¹, R², R³, R⁴ and R⁵ radicals are hydrogen; and
the other two or three of the R¹, R², R³, R⁴ and R⁵ radicals are the same or different and are each hydroxyl, a linear or branched C₁-C₈ alkyl radical, a linear or branched C₁-C₈ alkoxy radical, a C₃-C₈ cycloalkyl radical, or a phenyl radical.

4. The hydrogenated nitrile rubber according to claim 1, wherein at least one substituted phenol of the general formula (I) is selected from the group consisting of the following compounds:

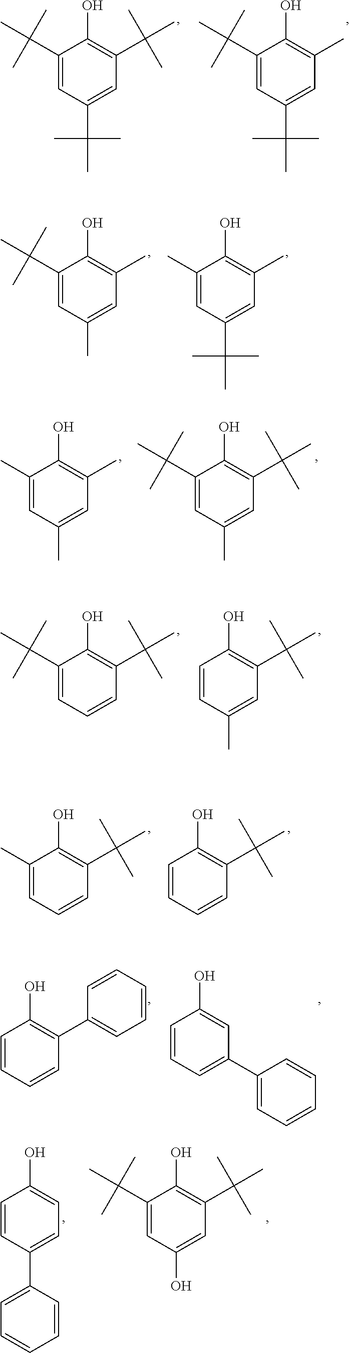

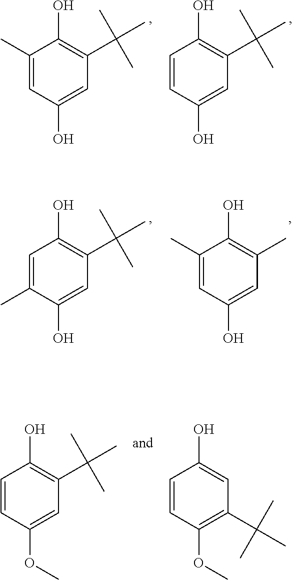

5. The hydrogenated nitrile rubber according to claim 1, wherein the nitrile rubber has repeat units derived from at least acrylonitrile and 1,3-butadiene.

6. The hydrogenated nitrile rubber according to claim 1, wherein the storage stability SS2 of the hydrogenated nitrile rubber as defined by
SS2(72 h/100° C.)=MV2−MV0
where
MV0 is the Mooney viscosity ML 1+40@ 100° C. determined to ASTM D 1646 for the hydrogenated nitrile rubber, and
MV2 is the Mooney viscosity ML 1+40@ 100° C. determined to ASTM D 1646 for the same hydrogenated nitrile rubber after storage at 100° C. for 72 hours has a value of less than 5.

7. The hydrogenated nitrile rubber according to claim 1, wherein the nitrite rubber has a hydrogenation degree greater than 94.5 to 100%.

8. The hydrogenated nitrile rubber according to claim 1, wherein the hydrogenation degree of the hydrogenated nitrile rubber is greater than or equal to 99.1%.

9. Process for producing hydrogenated nitrile rubber according to claim 1, the process comprising:
subjecting nitrile rubbers containing at least one substituted phenol of the general formula (I) to a hydrogenation in solution,
removing the solvent, and
isolating and dewatering the hydrogenated nitrile rubber to adjust the content of substituted phenol of the general formula (I) to the amount of 0.01% by weight to less than 0.45% by weight.

10. The process according to claim 9, wherein the hydrogenation is done in the presence of a hydrogenation catalyst selected from the group consisting of tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylphosphine) or the corresponding compounds in which triphenylphosphine has been replaced wholly or partly by tricyclohexylphosphine.

11. The process according to claim 9, wherein removing the solvent comprise a dry workup via a roller drying process or a screw process, or by a wet workup via a steam distillation or steam distillation with subsequent drying of the isolated rubber crumbs by means of a fluidized bed dryer or in an expeller-expander dryer.

12. The Process according to claim 11, wherein the workup processes are each conducted such that the substituted phenol of the general formula (I) is removed to an extent of 20-98% by weight, based on the amount of the substituted phenol of the general formula (I), from the nitrile rubber used for hydrogenation.

13. The process according to claim 11, further comprising operating the fluidized bed dryer continuously by contacting crumbs of the hydrogenated nitrile rubber having water contents of 5 to 50% by weight with an air flow having a temperature of 100 to 180° C.

14. Vulcanizable mixtures comprising at least one hydrogenated nitrile rubber according to claim 1 and at least one crosslinking system comprising at least one crosslinker and optionally one or more crosslinking accelerators.

15. A process for producing vulcanizates, the process comprising vulcanizing a vulcanizable mixture according to claim 14 in the course of a shaping process at a temperature of 100° C. to 200° C.

16. Vulcanizates obtained by the process according to claim 15.

17. The hydrogenated nitrile rubber according to claim 1, wherein:
the amount of the at least one substituted phenol is 0.1% by weight to 0.41% by weight based in each case on the hydrogenated nitrile rubber, and
two or three of the R¹, R², R³, R⁴ and R⁵ radicals are hydrogen; and
the other two or three of the R¹, R², R³, R⁴ and R⁵ radicals are the same or different and are each hydroxyl, methyl, ethyl, propyl, n-butyl, t-butyl, methoxy, ethoxy, propoxy, cyclopentyl, cyclohexyl, or a phenyl radical.

18. The hydrogenated nitrile rubber according to claim 17, wherein the nitrile rubber has repeat units derived from at least acrylonitrile and 1,3-butadiene.

19. The hydrogenated nitrile rubber according to claim 18, wherein:
the nitrile rubber has repeat units derived from acrylonitrile, 1,3-butadiene, and one or more α,β-unsaturated mono- or dicarboxylic acid(s), or esters or amides thereof; and
the amount of the at least one substituted phenol is 0.15% by weight to 0.4% by weight based in each case on the hydrogenated nitrile rubber.

20. The hydrogenated nitrile rubber according to claim 19, wherein:
the nitrile rubber has repeat units derived from acrylonitrile and 1,3-butadiene, or derived from acrylonitrile, 1,3-butadiene and one or more alkyl esters of an α,β-unsaturated carboxylic acid selected from the group of methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate and lauryl (meth)acrylate;
the nitrile rubber has a storage stability SS2 of less than 5 as defined by
SS2(72 h/100° C.)=MV2−MV0
where
MV0 is the Mooney viscosity ML 1+40@ 100° C. determined to ASTM D 1646 for the hydrogenated nitrile rubber, and
MV2 is the Mooney viscosity ML 1+4@ 100° C. determined to ASTM D 1646 for the same hydrogenated nitrile rubber after storage at 100° C. for 72 hours; and
the nitrile rubber has a hydrogenation degree of 96 to 100%.
